(19) United States
(12) Patent Application Publication
(10) Pub. No.: US 2008/0313560 A1
(43) Pub. Date: Dec. 18, 2008

(54) Financial Decision Systems

(76) Inventor: Pankaj B. Dalal, South Ozone Park, NY (US)

Correspondence Address: Stoneman Volk Patent Group, 3770 NORTH 7TH STREET, Suite 100, PHOENIX, AZ, 85014, US

(21) Appl. No.: 12/189,761

(22) Filed: Aug. 11, 2008

Related U.S. Application Data
(63) Continuation-in-part of application No. 11/523,368, filed on Sep. 18, 2006.
(60) Provisional application No. 60/954,978, filed on Aug. 9, 2007.
(60) Provisional application No. 60/717,962, filed on Sep. 16, 2005.
(60) Provisional application No. 60/730,121, filed on Oct. 24, 2005.

(51) Int. Cl. G06F 3/048

(52) U.S. Cl. 715/781; 715/764

(57) ABSTRACT

The financial decision system provides for real-time calculation of buying pressure and selling pressure for any tradable instrument market. Additionally, it provides real-time visual simultaneous plots and charts of buying pressure and selling pressure. Further, the system automatically presents buy and sell indicators and expert commentary based on automatically detected market trend changes. The system automatically analyzes market trends and changes in multiple timeframes simultaneously to identify, in real time, multiple confirmations of suggested trading actions, such as buying or selling. The system also encompasses training materials and methods necessary for teaching concepts and methods of usage to improve the likelihood of success for new users.

### CROSS-REFERENCE(S) TO RELATED APPLICATION(S)

The present application is related to and claims priority from prior provisional application Ser. No. 60/954,978, filed Aug. 9, 2007, entitled “Financial Decision Systems”; and is a continuation-in-part of related application Ser. No. 11/523,368, filed Sep. 18, 2006, entitled “Financial Decision Systems”, which claims priority from prior provisional patent application Ser. No. 60/717,962, filed Sep. 16, 2005, entitled “Financial Decision Systems”, and 60/730,121, filed Oct. 24, 2005, entitled “Financial Decision Systems”; and is related to prior PCT International Application No. PCT/US2006/036281, filed Aug. 16, 2006, entitled “Financial Decision Systems”; the contents of all of which are incorporated herein by this reference and are not admitted to be prior art with respect to the present invention by the mention in this cross-reference section.

### BACKGROUND

This invention relates to providing a system for improved decision making for buying and selling in financial markets. More particularly this invention relates to providing a system for providing improved reliability for early confirmation of changes in market trends for stocks, commodities, indexes, currencies, futures, exchange traded funds, mutual funds, bonds, financial market derivatives, or any financial instruments with data that may be plotted, collectively referred to as Market Vehicles.

Technical analysis, which involves the evaluation of stocks based on historical market statistics and chart patterns, has become extremely popular in recent years. During the 1990's, a wide variety of tools became available to day traders and other types of retail traders. In summary, the objective of these tools is to provide the earliest possible identification of changes in market direction, up or down. These market analysis tools are often based on various statistical methods, such as J. Welles Wilder's directional movement index (DMI), critical path method, real time swing bar methods, etc. These methods and others provide a wealth of information to the trader, but they tend to be complicated and, in some cases, not completely real time in their displays and calculations. Additionally, market forces such as buying pressure and selling pressure are not completely evaluated or displayed meaningfully to the trader.

Additionally, the existing tools do not automatically provide the ability to evaluate market trends across more than one timeframe simultaneously. Thus, traders must manually evaluate different timeframes to confirm indications of changes in direction or continuation of a current trend.

Thus, it is highly desirable to provide a system for providing improved visual presentation of market trends and trend changes and automatic evaluation of market trends and trend changes over multiple timeframes. It is also highly desirable to provide training in decision-making for traders using real-time market analysis software.

### OBJECTS AND FEATURES OF THE INVENTION

A primary object and feature of the present invention is to provide a system for real time calculation of buying pressure and selling pressure for any tradable instrument market.

It is a further object and feature of the present invention is to provide such a system for real time visual simultaneous presentation of buying pressure and selling pressure.

Another object and feature of the present invention is to provide such a system for automatic presentation of buy and sell indicators and expert commentary based on automatically detected market trend changes.

Yet another object and feature of the present invention is to provide such a system, preferably including training systems for traders to make better actual trading decisions, for automatic analysis of market trends and market changes in multiple timeframes to identify, in real time, multiple confirmations of suggested trading actions, such as buying or selling.

A further primary object and feature of the present invention is to provide such a system that is efficient, inexpensive, and handy. Other objects and features of this invention will become apparent with reference to the following descriptions.

It is noted that the within figures showing screens, training charts, etc., preferably use color specifically to greatly assist speed and accuracy of visualization and learning; and the original within figures, including all the priority documents, are in specific colors. Applicant, in this filing, has converted those color screen shots and figures into black and white images. Although applicant has tried to point out in specification words and reference numbers the location and use of such colors, it is noted that corresponding priority application(s) in the United States in such original colors will be available for public view and specification assistance.

### SUMMARY OF THE INVENTION

In accordance with a preferred embodiment hereof, this invention provides a computing system communicatively coupled with at least one market data feed, such computing system comprising: at least one processor to process such at least one market data feed; at least one set of instructions, responsive to user input, to instruct such at least one processor to output at least one market indicator; at least one storage memory to store such at least one set of instructions; at least one display to display such output; wherein, when such at least one set of instructions instructs such at least one processor, at least one market chart and at least one commentary window are displayed on such at least one display. Moreover, it provides such a computing system wherein such at least one commentary window comprises at least one concise market trend indication system. Additionally, it provides such a computing system wherein such at least one commentary window comprises at least one buy or sell indicator. Also, it provides such a computing system wherein such at least one commentary window comprises at least one bullish or bearish bias indicator. In addition, it provides such a computing system wherein such at least one commentary window comprises at least one short term market trend indicator. And, it provides such a computing system wherein such at least one commentary window comprises at least one table of market data comprising time frame, status, number of bars, and close at cross. Further, it provides such a computing system wherein such at least one commentary window comprises at least one concise summary of at least one predicted market trend. Even further, it provides such a computing system wherein such at least one concise summary of at least one predicted market trend comprises at least two time frames and notice as to whether or not an alignment is forming. Moreover, it provides such a computing system wherein such at least one concise summary further comprises at least one confirming or non-confirming indication of a bearish or bullish cross.

In accordance with another preferred embodiment hereof, this invention provides a computing system communicatively coupled with at least one market data feed, such computing system comprising: at least one processor to process such at least one market data feed; at least one set of instructions, responsive to user input, to instruct such at least one processor to output at least one market indicator; at least one storage memory to store such at least one set of instructions; at least one display to display such output; wherein, when such at least one set of instructions instructs such at least one processor, at least one market indicator displayed on such at least one display. Additionally, it provides such a computing system wherein such at least one market indicator is at least one pivot line. Also, it provides such a computing system wherein such at least one pivot line is at least one plot of pivot points; wherein such pivot points are calculated using an average of at least one pivot point within at least one timeframe. In addition, it provides such a computing system wherein such at least one timeframe is evenly divisible by at least one time interval. And, it provides such a computing system wherein such at least one time interval is about five minutes. Further, it provides such a computing system wherein, when such at least one set of instructions instructs such at least one processor, at least one resistance point and at least one support point are calculated using at least one pivot point. Even further, it provides such a computing system wherein such at least one display comprises display of pivot lines of multiple time intervals. Moreover, it provides such a computing system wherein such at least one display comprises display of at least one alert when pivot lines interact. Additionally, it provides such a computing system wherein such at least one set of instructions computes and displays at least one “look yesterday” indicator comprising a plot of the prior day's open, high, low, and close prices. Also, it provides such a computing system wherein such at least one market indicator comprises at least one plot of modified parabolic stop-and-reversal; wherein at least one point for such at least one plot of modified parabolic stop-and-reversal is calculated wherein the “step” of such stop-and-reversal is selected based on the market vehicle being traded. In addition, it provides such a computing system wherein such at least one market indicator comprises at least one vertical line extending from an about top portion of at least one market chart to a bottom portion of such a chart; and wherein such at least one vertical line is drawn at a buy indicator or sell indicator. And, it provides such a computing system further comprising at least one further set of instruction providing instructions to configure such at least display and such at least one indicator.

In accordance with another preferred embodiment hereof, this invention provides a computing system communicatively coupled with at least one market data feed, such computing system comprising: at least one processor to process such at least one market data feed; at least one set of instructions, responsive to user input, to instruct such at least one processor to output at least one market indicator; at least one storage memory to store such at least one set of instructions; at least one display to display such output; wherein, when such at least one set of instructions instructs such at least one processor, at least exportable file, comprising cells, is available to be exported so that a user may visualize market conditions. Further, it provides such a computing system, wherein such at least one exportable file comprises at least one data-filled table of market conditions displaying alignment data.

In accordance with another preferred embodiment hereof, this invention provides a computing system communicatively coupled with at least one market data feed, such computing system comprising: at least one processor to process such at least one market data feed; at least one set of instructions, responsive to user input, to instruct such at least one processor to output at least one market indicator; at least one storage memory to store such at least one set of instructions; at least one display to display such output; wherein, when such at least one set of instructions instructs such at least one processor, the following occur at least one upper parabolic SAR is calculated and counted for at least one time frame; at least one lower parabolic SAR is calculated and counted for at least one time frame; at least one upper parabolic SAR is compared with at least one lower parabolic SAR; wherein, the relationship among the at least one upper parabolic SAR and the at least one lower parabolic SAR is displayed to assist market trend prediction.

### BRIEF DESCRIPTION OF THE DRAWINGS

FIG. 1 shows an illustration of V-TWO Indicator display concepts according to a preferred embodiment of the present invention.

FIG. 2 shows an example of V-TWO Indicator display with an illustration of values for V1 and V2 according to a preferred embodiment of the present invention.

FIG. 3 shows an example of use of V-TWO Indicator display in conjunction with a traditional candle chart according to a preferred embodiment of the present invention.

FIG. 4 shows an illustration of the characteristics of V1 and V2 in varying situations according to a preferred embodiment of the present invention.

FIG. 5 shows the relation between V1 and V2 at the conversion of bearish waves to bullish waves at a new cross according to a preferred embodiment of the present invention.

FIG. 6 shows the relation between V1 and V2 at the conversion of bullish waves to bearish waves at a new cross according to a preferred embodiment of the present invention.

FIG. 7 shows the relation between V1 and V2 before the conversion of bearish waves to bullish waves at the new cross according to a preferred embodiment of the present invention.

FIG. 8 shows the relation between V1 and V2 before the conversion of bullish waves to bearish waves at the new cross according to a preferred embodiment of the present invention.

FIG. 9 shows an example of V-FOUR Indicator display with an illustration of values for V1, V2, V3, and V4 according to a preferred embodiment of the present invention.

FIG. 10 shows an example of V-FOUR Indicator display with an illustration of values for V1, V2, V3 and V4 according to a preferred embodiment of the present invention.

FIG. 11 shows the relation between V3 and V4 at the conversion of bearish waves to bullish waves at a new cross according to a preferred embodiment of the present invention.

FIG. 12 shows the relation between V3 and V4 at the conversion of bullish waves to bearish waves at a new cross according to a preferred embodiment of the present invention.

FIG. 13 shows the relation between V3 and V4 before the conversion of bearish waves to bullish waves at a new cross according to a preferred embodiment of the present invention.

FIG. 14 shows the relation between V3 and V4 before the conversion of bullish waves to bearish waves at a new cross according to a preferred embodiment of the present invention.

FIG. 15 shows a table illustrating a basis for V1, V2, V3, and V4 and volatility according to a preferred embodiment of the present invention.

FIG. 16 shows a display illustrating the use of interjection techniques according to a preferred embodiment of the present invention.

FIG. 17A shows a display illustrating the use of symbols generated from a V-FOUR Indicator on a traditional candle chart according to a preferred embodiment of the present invention.

FIG. 17B shows a table illustrating the concept of history of alignment and positions from a new cross according to a preferred embodiment of the present invention.

FIG. 18 shows a display of V-FOUR Indicator and alignment areas on a traditional candle chart according to a preferred embodiment of the present invention.

FIG. 19 shows a display of V-FOUR Indicator and alignment areas on a traditional candle chart with multiple early warnings of a bearish alignment and related expert commentary according to a preferred embodiment of the present invention.

FIG. 20A shows a display of V-FOUR Indicator and alignment areas on a traditional candle chart with multiple early warnings of a bullish alignment and related expert commentary according to a preferred embodiment of the present invention.

FIG. 20B shows a display of V-FOUR Indicator and alignment areas on a traditional candle chart with location of crosses for many timeframes and related expert commentary according to a preferred embodiment of the present invention.

FIG. 21 shows a display illustrating multiple timeframe alignments and relevant symbols applied to a traditional candle chart according to a preferred embodiment of the present invention.

FIG. 22 shows a display illustrating multiple timeframe alignments and relevant symbols applied to a traditional bar chart according to a preferred embodiment of the present invention.

FIG. 23 shows a display illustrating multiple timeframe alignments and relevant symbols applied to a traditional bar chart with expert commentary according to a preferred embodiment of the present invention.

FIG. 24 shows a display illustrating multiple timeframe alignments and generated expert commentary according to a preferred embodiment of the present invention.

FIG. 25 shows a display illustrating unique selection of sell signals and alignments according to a preferred embodiment of the present invention.

FIG. 26A shows a display illustrating unique selection of buy signals and alignments according to a preferred embodiment of the present invention.

FIG. 26B shows a display illustrating a market summary presentation of generated symbols for currency pairs at selected timeframes according to a preferred embodiment of the present invention.

FIG. 27 shows a display illustrating the theory of V3 and V4 dots in relation to V1 and V2 plot lines according to a preferred embodiment of the present invention.

FIG. 28 shows a display illustrating the theory of V3 and V4 dots in relation to V1 and V2 plot lines and its use with other applications according to a preferred embodiment of the present invention.

FIG. 29 shows a display illustrating the theory of golden bars in conjunction with V-TWO plot according to a preferred embodiment of the present invention.

FIG. 30 shows a display illustrating the theory of golden bars in conjunction with V-TWO plot according to a preferred embodiment of the present invention.

FIG. 31 shows a display illustrating indicators provided by the use of the theory of golden bars in conjunction with V-TWO Indicator according to a preferred embodiment of the present invention.

FIG. 32A shows a display illustrating indicators provided by the use of the theory of golden bars in conjunction with V-TWO Indicator according to a preferred embodiment of the present invention.

FIG. 32B shows a display illustrating the use of power swing bars indicators in conjunction with V-TWO Indicator according to a preferred embodiment of the present invention.

FIG. 32C shows a display illustrating the use of pivot theory indicators in conjunction with V-FOUR Indicator according to a preferred embodiment of the present invention.

FIG. 33 shows a display illustrating the use of pivot theory indicators in conjunction with V-FOUR Indicator according to a preferred embodiment of the present invention.

FIG. 34 shows a chart illustrating the FX volatility theory for selected currency pairs according to a preferred embodiment of the present invention.

FIG. 35 shows a display illustrating the FX volatility theory according to a preferred embodiment of the present invention.

FIG. 36 shows a display illustrating the FX volatility theory in conjunction with V-FOUR Indicator with alignment according to a preferred embodiment of the present invention.

FIG. 37 shows a display illustrating the FX volatility theory in conjunction with V-TWO Indicator according to a preferred embodiment of the present invention.

FIG. 38 shows a display illustrating day trader heaven, or FX All Target theory according to a preferred embodiment of the present invention.

FIG. 39 shows a display illustrating day trader heaven, or FX All Target theory with three different timeframe displays according to a preferred embodiment of the present invention.

FIG. 40 shows a table illustrating expert commentary generated for three consecutive alignments according to a preferred embodiment of the present invention.

FIG. 41 shows an example of multiple charts presented simultaneously according to a preferred embodiment of the present invention.

FIG. 42 shows an example of the use of Golden and Turquoise bars on a candlestick chart according to a preferred embodiment of the present invention.

FIG. 43 shows an example of the initial presentation screen for trader training according to a preferred embodiment of the present invention.

FIG. 44 shows an example of an initial set up screen for starting the preferred computer real-time analysis system within a charting system such as MetaStock® according to a preferred embodiment of the present invention.

FIG. 45 shows an example of a set up screen for selecting a market for use with the preferred computer real-time analysis system within a charting system such as MetaStock® according to a preferred embodiment of the present invention.

FIG. 46 shows an example of a set up screen for selecting a currency pair for analysis by the preferred computer real-time analysis system within a charting system such as MetaStock® according to a preferred embodiment of the present invention.

FIG. 47 shows an example of an analysis screen presenting FX Indicator, Traditional Candle Chart and Volatility Indicator provided by the preferred computer real-time analysis system according to a preferred embodiment of the present invention.

FIG. 48 shows an example of a first analysis screen demonstrating market changes indicators when using FX Indicator, Traditional Candle Chart and Volatility Indicator provided by the preferred computer real-time analysis system according to a preferred embodiment of the present invention.

FIG. 49 shows an example of a second analysis screen demonstrating market changes indicators when using FX Indicator, Traditional Candle Chart and Volatility Indicator provided by the preferred computer real-time analysis system according to a preferred embodiment of the present invention.

FIG. 50 shows an example of a third analysis screen demonstrating market changes indicators when using FX Indicator, Traditional Candle Chart and Volatility Indicator provided by the preferred computer real-time analysis system according to a preferred embodiment of the present invention.

FIG. 51 shows an example of an analysis screen demonstrating market changes indicators when using V-TWO Indicator superimposed on a Traditional Candle Chart and Alignment and Commentary provided by the preferred computer real-time analysis system according to a preferred embodiment of the present invention.

FIG. 52 shows an example of an analysis screen demonstrating market change indicators when using FX Indicator, a Traditional Candle Chart with Golden Bar and Volatility Indicator provided by the preferred computer real-time analysis system according to a preferred embodiment of the present invention.

FIG. 53 shows an example of an enlarged view of an analysis screen demonstrating market change indicators when using FX Indicator, a Traditional Candle Chart with Golden Bar and Volatility Indicator provided by the preferred computer real-time analysis system according to a preferred embodiment of the present invention.

FIG. 54 shows an example of an analysis screen demonstrating market change indicators when using a Traditional Candle Chart with Golden Bar provided by the preferred computer real-time analysis system according to a preferred embodiment of the present invention.

FIG. 55 shows an example of an enlarged view of an analysis screen demonstrating market change indicators when using FX Indicator Bar provided by the preferred computer real-time analysis system according to a preferred embodiment of the present invention.

FIG. 56 shows an example of an enlarged view of an analysis screen demonstrating market change indicators when using a using Volatility Indicator provided by the preferred computer real-time analysis system according to a preferred embodiment of the present invention.

FIG. 57 shows an example of an enlarged view of an analysis screen demonstrating market change indicators when using V-TWO Indicator superimposed on a Traditional Candle Chart provided by the preferred computer real-time analysis system according to a preferred embodiment of the present invention.

FIG. 58 shows an example of an analysis screen demonstrating market change indicators when using a using V-TWO Indicator superimposed on a Traditional Candle Chart with Golden Bar Indicators provided by the preferred computer real-time analysis system according to a preferred embodiment of the present invention.

FIG. 59 shows an example of an analysis screen demonstrating market change indicators when using a using Daily Pivot Indicators and V-TWO Indicators superimposed on a Traditional Candle Chart with Golden Bar Indicators provided by the preferred computer real-time analysis system according to a preferred embodiment of the present invention.

FIG. 60 shows an example of an analysis screen demonstrating market change indicators when using a using 60 Minute Pivot Indicators and V-TWO Indicators superimposed on a Traditional Candle Chart with Golden Bar Indicators provided by the preferred computer real-time analysis system according to a preferred embodiment of the present invention.

FIG. 61 shows an example of a fourth analysis screen demonstrating market changes indicators when using FX Indicator, Traditional Candle Chart and Volatility Indicator suggesting a selling decision alignment provided by the preferred computer real-time analysis system according to a preferred embodiment of the present invention.

FIG. 62 shows an example of a fifth analysis screen demonstrating market changes indicators when using FX Indicator, Traditional Candle Chart and Volatility Indicator suggesting a selling decision alignment and natural and synthetic crosses provided by the preferred computer real-time analysis system according to a preferred embodiment of the present invention.

FIG. 63 shows an example of an FX All Target analysis screen demonstrating market changes indicators when using FX Indicator, Traditional Candle Chart and Volatility Indicator and Day Trader Heaven Indicators provided by the preferred computer real-time analysis system according to a preferred embodiment of the present invention.

FIG. 64 shows a schematic diagram illustrating an overall arrangement of financial decision system components according to a preferred embodiment of the present invention.

FIG. 65 shows a schematic diagram illustrating functions provided by the plug-in for financial analysis software shown in FIG. 64.

FIG. 66 shows a screenshot illustrating an expert commentary window of the financial decision system according to another preferred embodiment of the present invention.

FIGS. 67A, 67B, and 67C shows screenshots, illustrating pivot point plots, according to a preferred embodiment of the present invention.

FIG. 68 shows a table illustrating a preferred calculation method of calculation pivot points according to a preferred embodiment of the present invention.

FIG. 69 shows a portion of a plot illustrating interaction between pivot point plots of different time frames according to a preferred embodiment of the present invention.

FIG. 70 shows a portion of a plot illustrating interaction between pivot point plots of different time frames, and further illustrating a “stair step” feature of such interaction according to a preferred embodiment of the present invention.

FIG. 71 illustrates portions of plots illustrating interaction between pivot point plots and another indicator, and further illustrating a “transfer station” feature of such interaction according to a preferred embodiment of the present invention.

FIGS. 72, 73, 74, and 75 show screenshots, illustrating the SAR Count concept, according to a preferred embodiment of the present invention.

FIGS. 76, 77, and 78 shows screenshots, illustrating the vertical line indicator, according to a preferred embodiment of the present invention.

FIGS. 79 and 80 show screenshots, illustrating the super long term trade concept, according to a preferred embodiment of the present invention.

FIGS. 81A, 81B, and 81C show screenshots, illustrating an alignment table, according to a preferred embodiment of the present invention.

FIGS. 82, 83, 84, and 85 show screenshots, illustrating the look yesterday indicator, according to a preferred embodiment of the present invention.

### DETAILED DESCRIPTION OF THE BEST MODES AND PREFERRED EMBODIMENTS OF THE INVENTION

### Multiple Timeframe Alignment Concepts

For stocks, commodities, indexes, currencies, futures, exchange traded funds, mutual funds, bonds, financial market derivatives, or any financial instruments with data that may be plotted, (referred to collectively as tradable instruments or “Market Vehicles”) price movement and price changes create internal (embedded) trends as well as external trends which may be identified as bullish or bearish trends. A trend may be evaluated on a variety of historical timeframes from one tick (one transaction), to one minute to any multiple of minutes (for example: five minutes, 60 minutes, 400 minutes, daily, weekly, yearly, etc.). Evaluation of the open, close, high and low prices of a trend for each of the various historical timeframes will produce a set trend lines, or waves, relative to each timeframe evaluated. Each wave will indicate either a bearish trend, in which prices are falling, or a bullish trend, in which prices are rising. Trending agreement, between waves in multiple timeframes, some or all bullish (buying pressure) or some or all bearish (selling pressure), can be recognized as either buying or selling opportunities. Preferably, agreement, hereinafter referred to as alignment, occurring at a transition point (reversal of the relationship between buying pressure and selling pressure) represents a significant buying or selling opportunity (at least herein embodying from such first determining compared to at least one prior timeframe such “greater-lesser relationship” second determining, identifying any reversal of such “greater-lesser relationship” between such first determining and such second determining; at least herein embodying notifying such at least one trader of such any reversal; and at least herein embodying wherein such notifying may be used to assist such decision making by such least one trader). The transition point, hereinafter referred to as a New Cross, is point at which the prevailing trend, either bearish or bullish, of open, close, high or low prices for a Market Vehicle reverses direction.

According to a preferred embodiment of the present invention an alignment represents multiple confirmations of true reversals at the beginning of either a new embedded trend or an external trend. Preferably, alignment can be done either for all bullish or all bearish waves for two or more timeframes from one minute to one year or any multiple of minutes in between. Preferably, the grouping identifies the trend and the number of smaller to bigger timeframes in alignment. The more waves of different timeframes in alignment preferably signifies the strength of the trend, which can be interpreted as buying pressure for bullish waves and selling pressure for bearish waves. Preferably, increasing numbers of timeframes in alignment indicates a stronger trend or more pressure or more strength of a wave. Decreasing numbers of timeframes in alignment indicates less strong waves and therefore less pressure. Preferably, longer timeframes in alignment indicate a better possibility of the trend's real direction than only shorter timeframes in alignment. However, examination of the sequence of several of such alignments can preferably indicate movement of smaller bullish or bearish waves to bigger waves. Identification of more than two sequential alignment patterns preferably gives further confirmation of direction of either bullish or bearish waves. Knowing this, traders can stay in trades until these sequences weaken or are broken with opposite types of waves. Existence of opposite types of waves can preferably indicate exits in trading. This allows traders to stay in or exit trades with confidence while avoiding “noise” or false signals.

Preferably, any bullish or bearish bias is based on preceding price actions and future confirmation. Bullish to bearish wave formation begins after advancement of bullish waves for certain timeframes from previous transition or reversal points (New Crosses). The bullish waves start weakening and at an indecision point in the market, they have equilibrium with bearish waves. In real market conditions, such as uncertain times, indecision exists and at those times bullish and bearish waves balance. Preferably, the increasing intensity of bearish waves is signified by alignment of additional bearish waves created by selling pressure. Preferably, a new reversal point is confirmed (New Cross, new buy or sell signal) verifying that several waves for varying timeframes are in alignment. Preferably, some event interjections (see explanation below) of external values to the algorithms (bearish and bullish) may be required to create New Crosses. Preferably, after a bullish to bearish indecision point, further bearish waves are required for bearish confirmation.

### Basis of Algorithm

Variables such as open, close, high, low prices of a particular Market Vehicle, received as a real-time data feed for the Market Vehicle, may be evaluated for any particular timeframe (from one minute to one year (at least herein embodying receiving historical time-relevant trading data relating to such at least one tradable instrument). Preferably, the results of that evaluation permit plotting, in real time, at least one buying pressure line (typically green) and at least one selling pressure line (typically red) against X and Y axis (at least herein embodying utilizing at least one computer-based program for performing required computations in substantially real-time; and at least herein embodying utilizing such at least one computer-based program for communication with such at least one trader in substantially real-time). Preferably, two separate algorithms are used to determine the lines to be plotted:
V1: Selling pressure real time plot as a red line (at least herein embodying calculating, as at least one first calculation, at least one first time-relevant value representing historical collective desire to sell such at least one tradable instrument using such historical time-relevant trading data for at least one plurality of timeframes); and
V2: Buying pressure real time plot as a green line (at least herein embodying calculating, as at least one second calculation, at least one second time-relevant value representing historical collective desire to buy such at least one tradable instrument using such historical time-relevant trading data for such at least one plurality of timeframes).

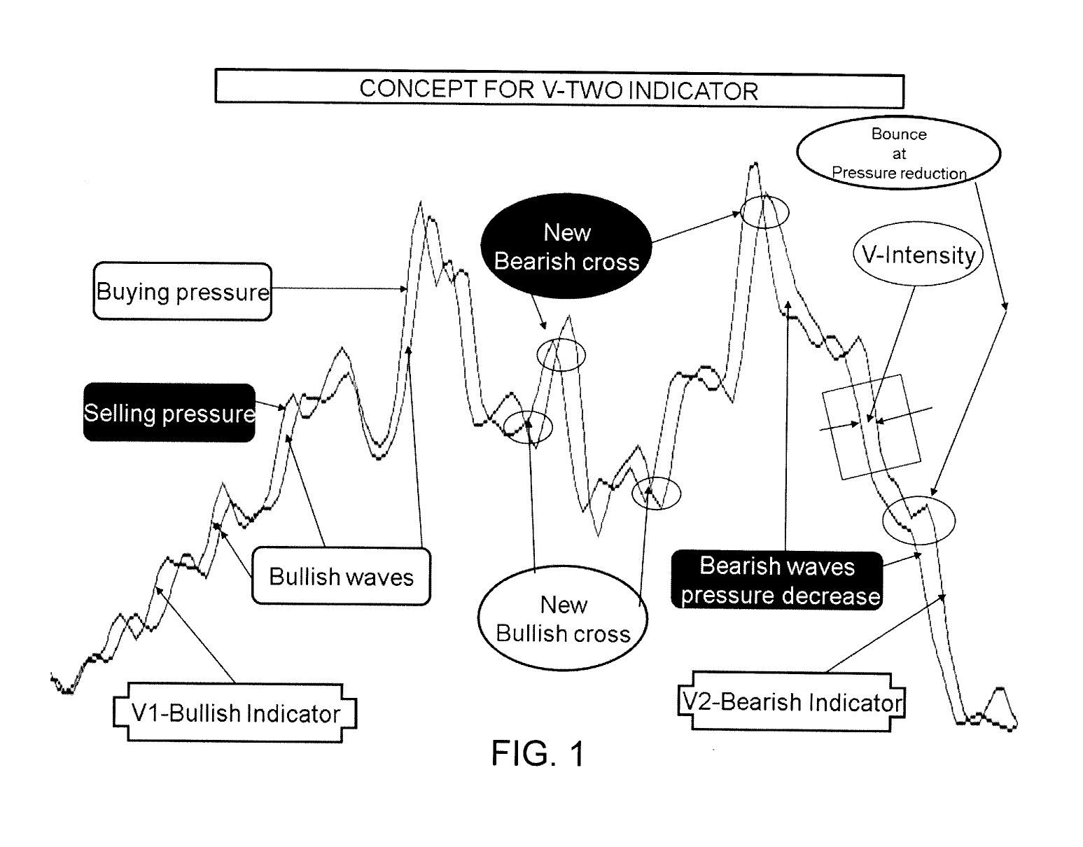

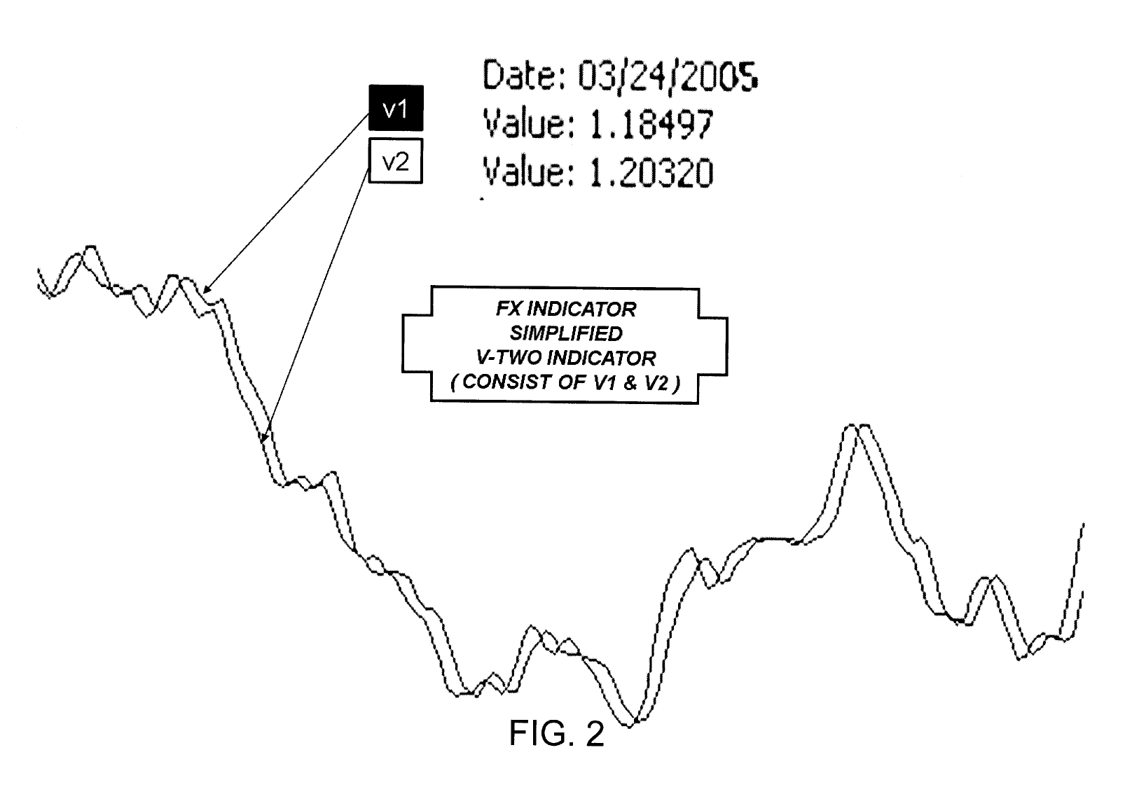

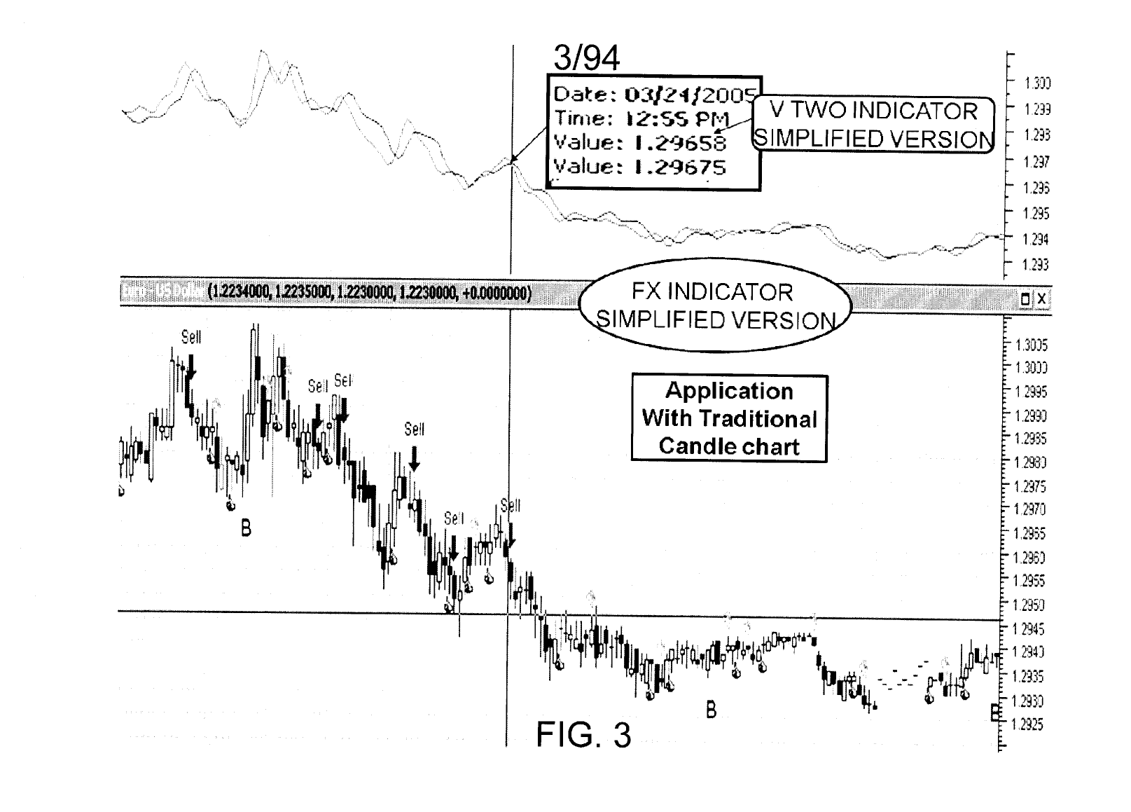

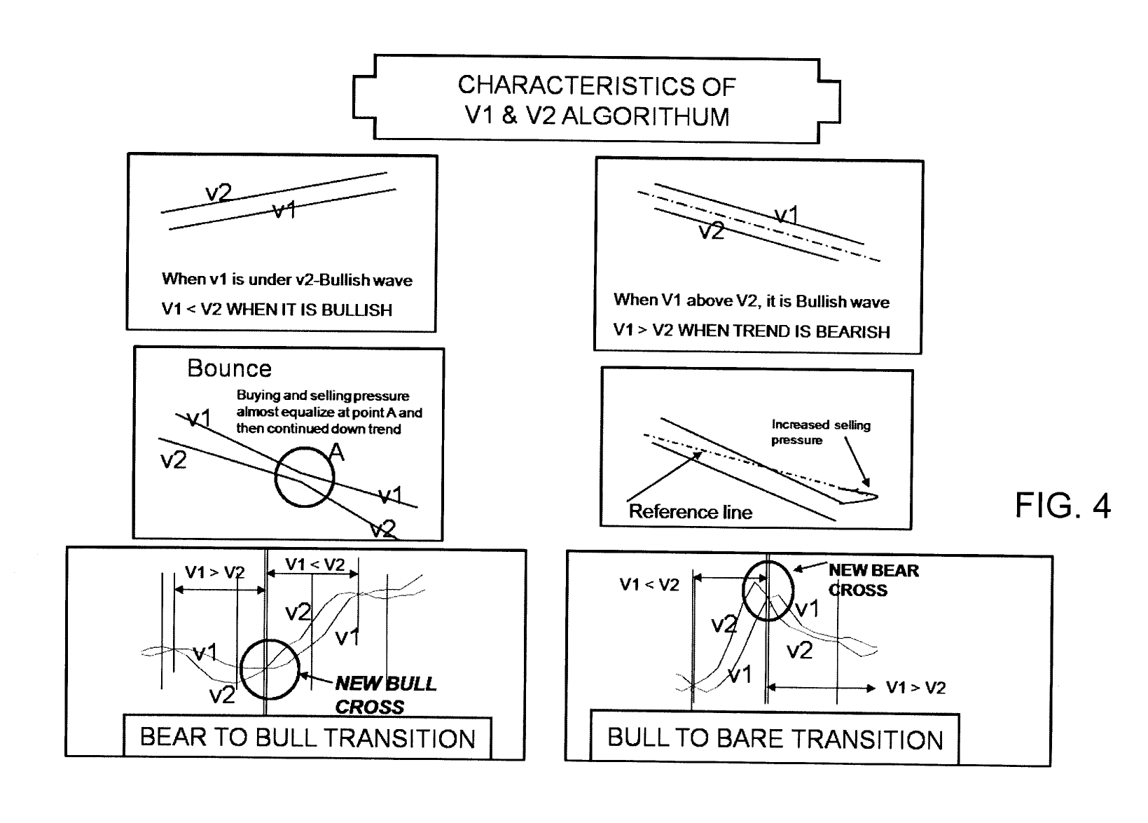

Preferably, both algorithms are created using mathematical formulas based on open, high, low, close prices of the Market Vehicle for a particular timeframe either independently, or in a combination with some variable factors and constants. For example, preferably the open and close price may be used for the average of any number of timeframes using a natural log function as an exponent. Upon reading the teachings of this specification, those with ordinary skill in the art will now understand that, under appropriate circumstances, considering issues such as availability of market data, etc., other arrangements, such as, for example, availability of bid and ask prices, etc., other trend calculation methods may suffice. Examples of the preferred relationship between both algorithms and how they can create a New Cross, or new transition point, in a particular timeframe are shown in FIG. 1, FIG. 2 and FIG. 3 (at least herein embodying creating at least one first graphical representation of such at least one first time-relevant value for such at least one timeframe, and at least herein embodying creating at least one second graphical representation of such at least one second time-relevant value for such at least one timeframe; and at least herein embodying wherein such at least one first graphical representation and such at least one second graphical representation are presented jointly in at least one comparative analysis chart providing at least one system relating to comparative analysis). The preferred basic behaviors of both V1 and V2 for bullish and bearish trends are shown in FIG. 4. As shown in FIG. 4, bullish trends are signified by V2 being above V1 and the reverse for bearish trends (at least herein embodying comparing such historical collective desire to sell such at least one tradable instrument to such historical collective desire to buy such at least one tradable instrument to make a first determining of at least one “greater-lesser relationship” between such historical collective desire to buy and such historical collective desire to sell for at least one timeframe of such at least one plurality of timeframes).

Preferably, evaluating the characteristics and behavior of V1 and V2, permits one to predict the end or the beginning of either a bull or a bearish trend. Preferably, V1 and V2 both may be created with open or close prices with several variable factors in order to achieve the characteristics shown in FIG. 4.

### PREFERRED DEFINITIONS

FX Indicator: The FX Indicator preferably includes plotting a green line (V2), a red line (V1) and green dots (V4), and red dots (V3). The formulas for the FX Indicator preferably determine trends, bullish or bearish and the Bounces and New Crosses for a Market Vehicle. Preferably, V1, V2, V3, and V4 algorithms are recalculated and re-plotted as each new set of market data values is received.

Bounce: Red and green indicators (either V1 and V2 or V3 and V4) converging, not crossing, and then separating. Red and green indicators converge within specified percentage of convergence input. The Red and green indicator values can be equal, but cannot cross. The Bounce signal is preferably triggered once the values exceed the convergence percentage, after moving to or within the convergence percentage.

New Cross: Red crossing green indicators (either V1 and V2 or V3 and V4) in either direction.

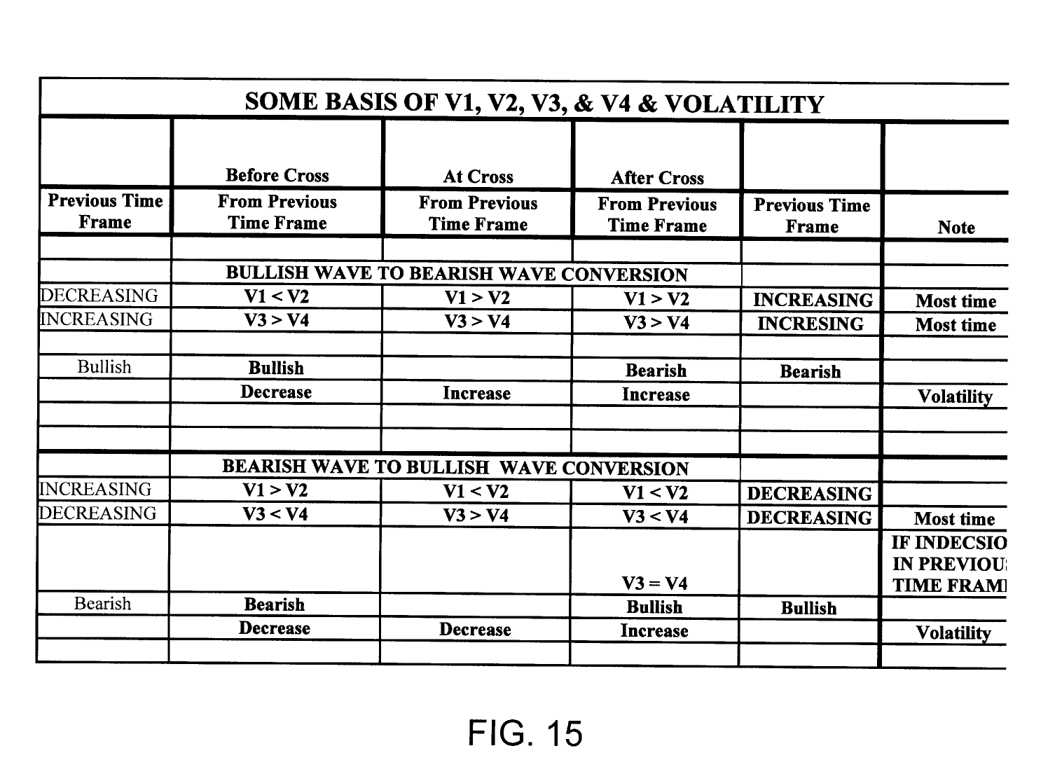

V—TWO Indicator: A simplified version of the FX Indicator as it preferably only presents the plot lines for V1 and V2. Using V1 and V2 algorithm values, preferably the V-TWO Indicator permits real-time identification of buying and selling opportunities, the direction of a trend, and possible reversals in the price direction of a Market Vehicle. Preferably, it works in many ways as an indicator in producing buy and sell signals. Refer to FIG. 1, FIG. 2 and FIG. 3 for the relationship of V1 and V2 and to FIG. 15 for more on the basis of V1 and V2.

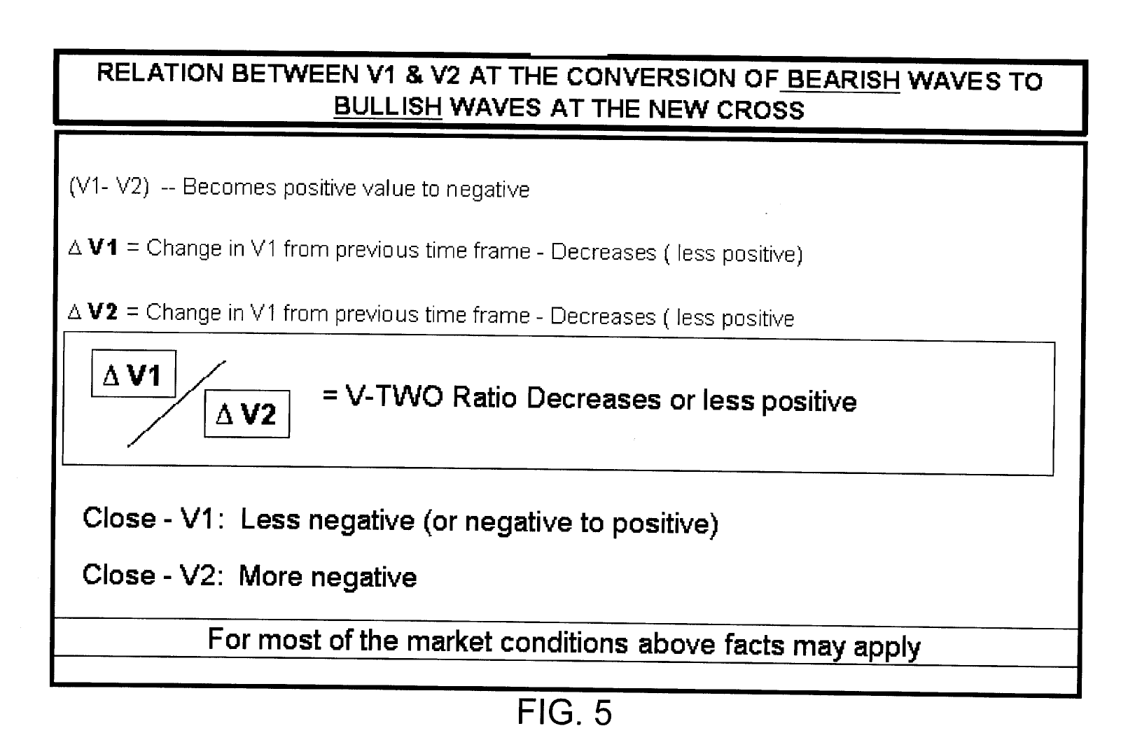

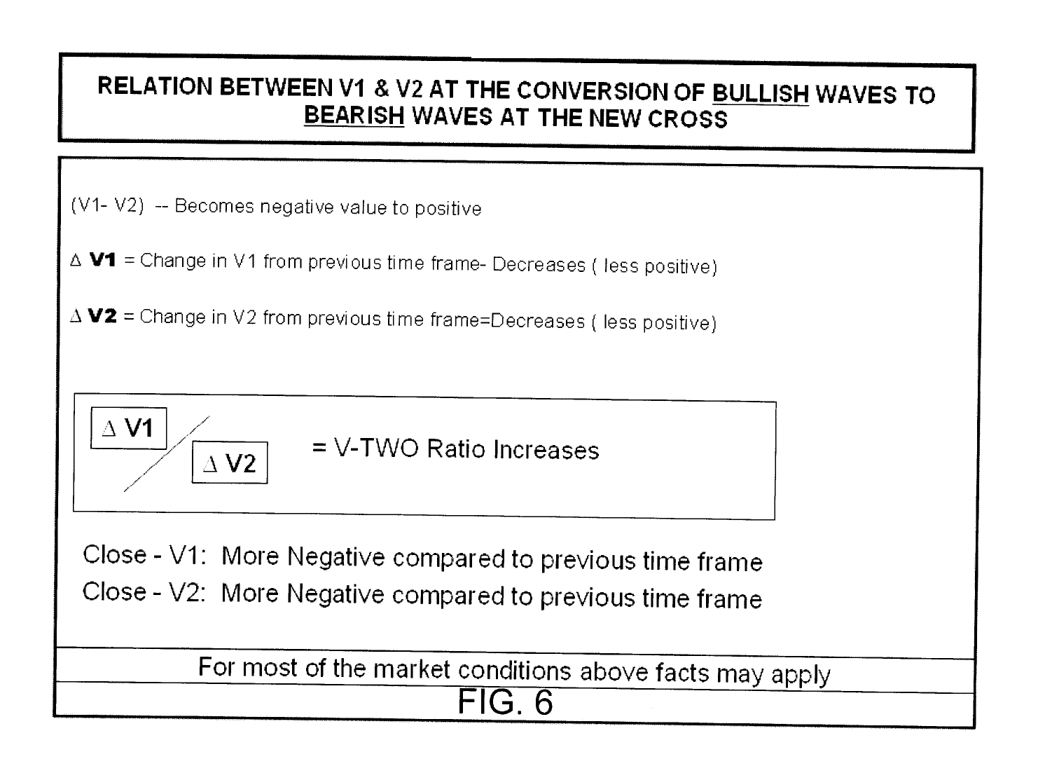

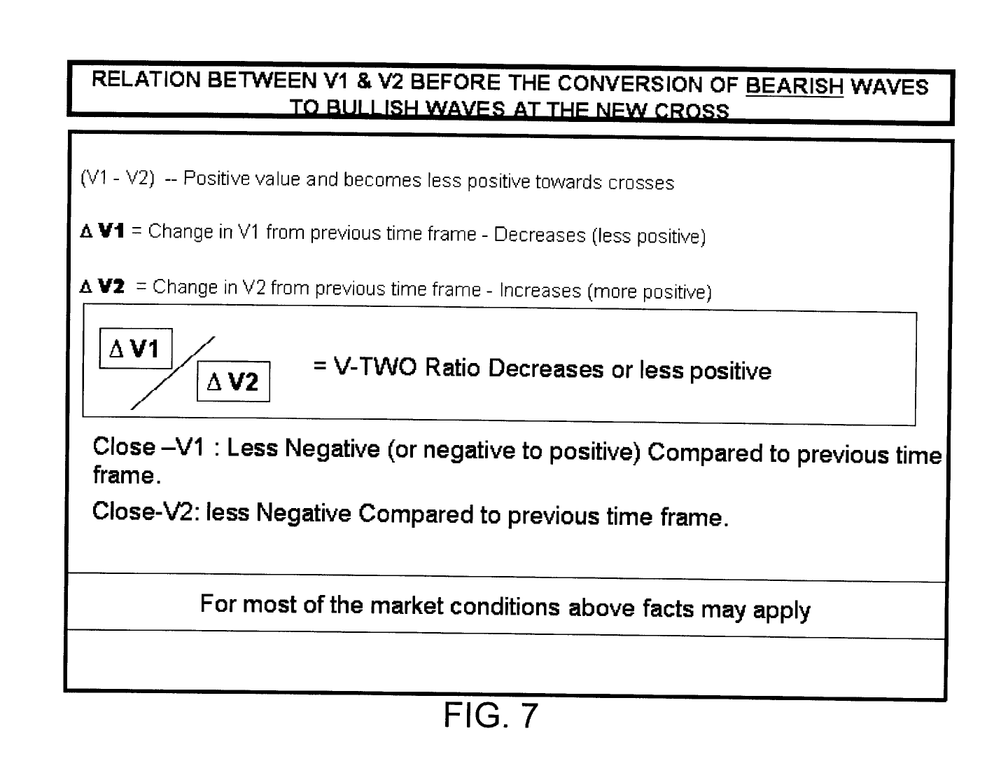

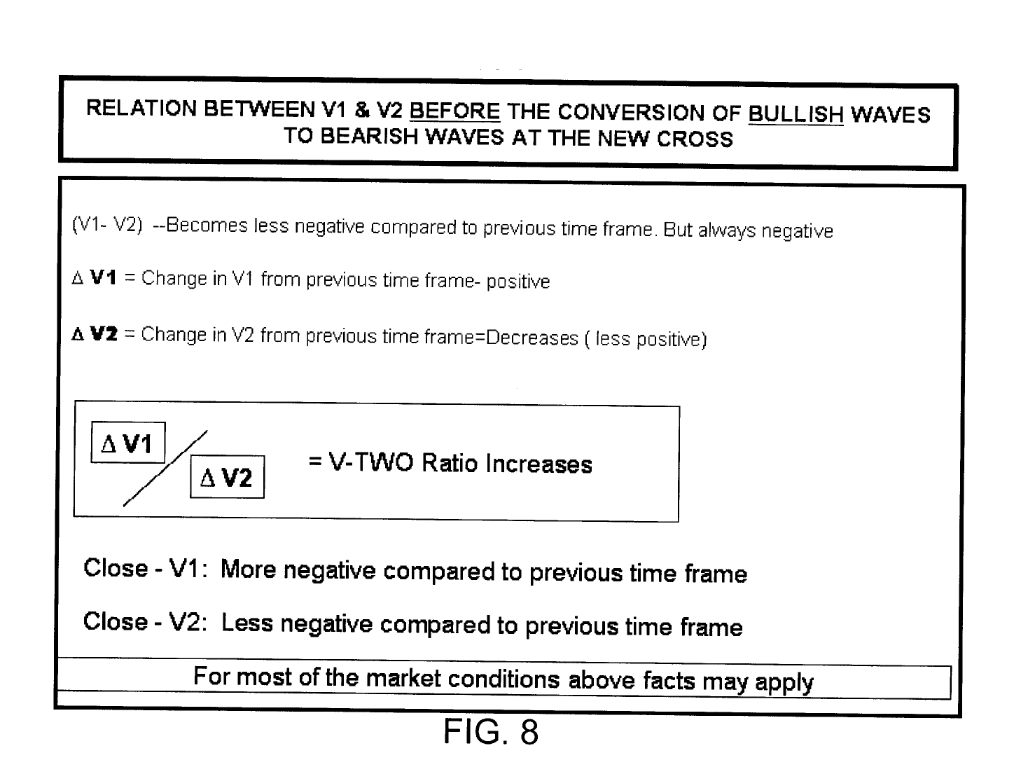

Referring to FIG. 5, FIG. 6, FIG. 7 and FIG. 8, some preferred characteristics of the V-TWO Indicator are:
ΔV1—Change in V1 from previous timeframe; decreases (less positive change in V1 from previous timeframe, decreases (less positive) change in V1 from previous timeframe, decreases (less positive) change in V1 from previous timeframe, decreases (less positive) change in V1 from previous timeframe, positive.
ΔV2—Change in V2 from previous timeframe; decreases (less positive), from previous timeframe; decreases, change in V2 from previous timeframe, increases (more positive) change in V2 from previous timeframe, decreases (less positive).
ΔV1/ΔV2—V-TWO Ratio decreases or less positive, increase, decreases or less positive, increase. The lower the value the more chance for a trend change.
Close-V2: More negative, less negative, negative to positive.
Close-V1: Less negative (or negative to positive), more negative.
(V1-V2): Becomes positive value to negative, becomes negative value to positive, positive values, becomes less positive towards crosses, becomes less negative compared to previous timeframe and negative only in some cases.

V-TWO Intensity: Preferably, the intensity of buying or selling pressure can be measured by the difference of in the values of V1 and V2 in the current timeframe compared to the previous timeframe. For example, in a bearish market the variable factor for V1 (bear) and V2 (bull) preferably remains negative compared to selected price in a previous timeframe. The sudden change in values of V1 and V2 in a reverse direction indicates possible continuation of the trend. The value of V2 accelerates once the trend resolves in a negative direction.

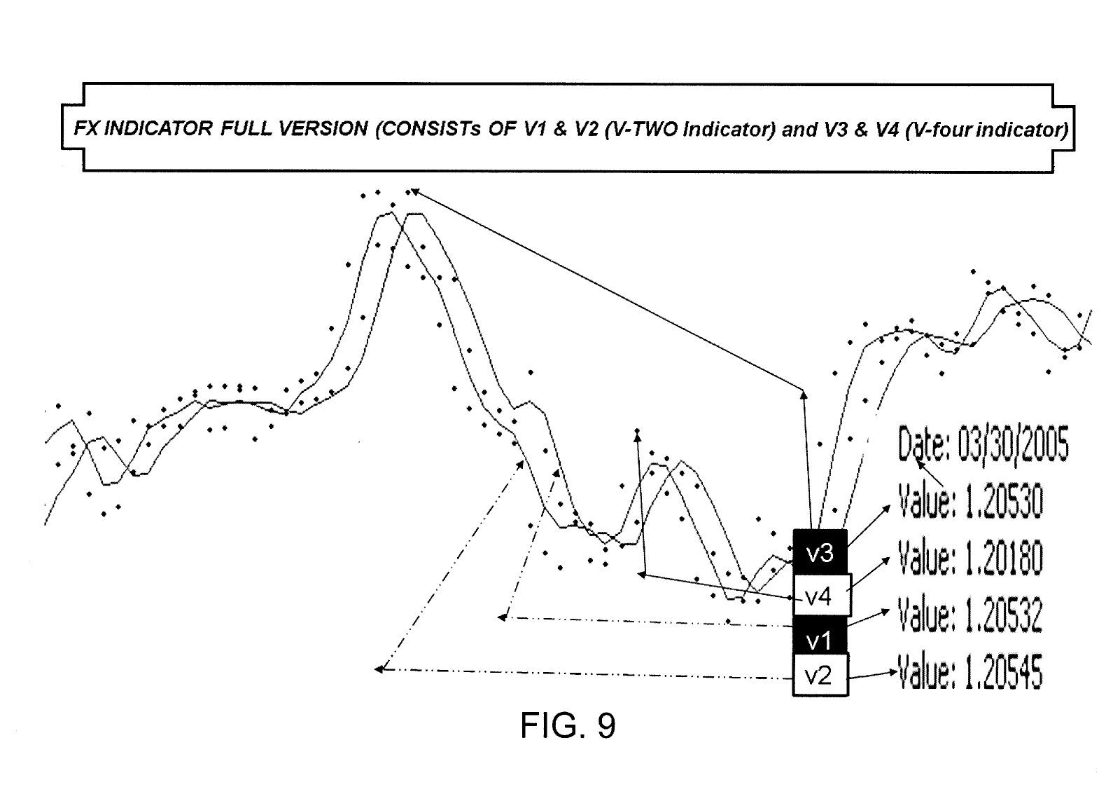

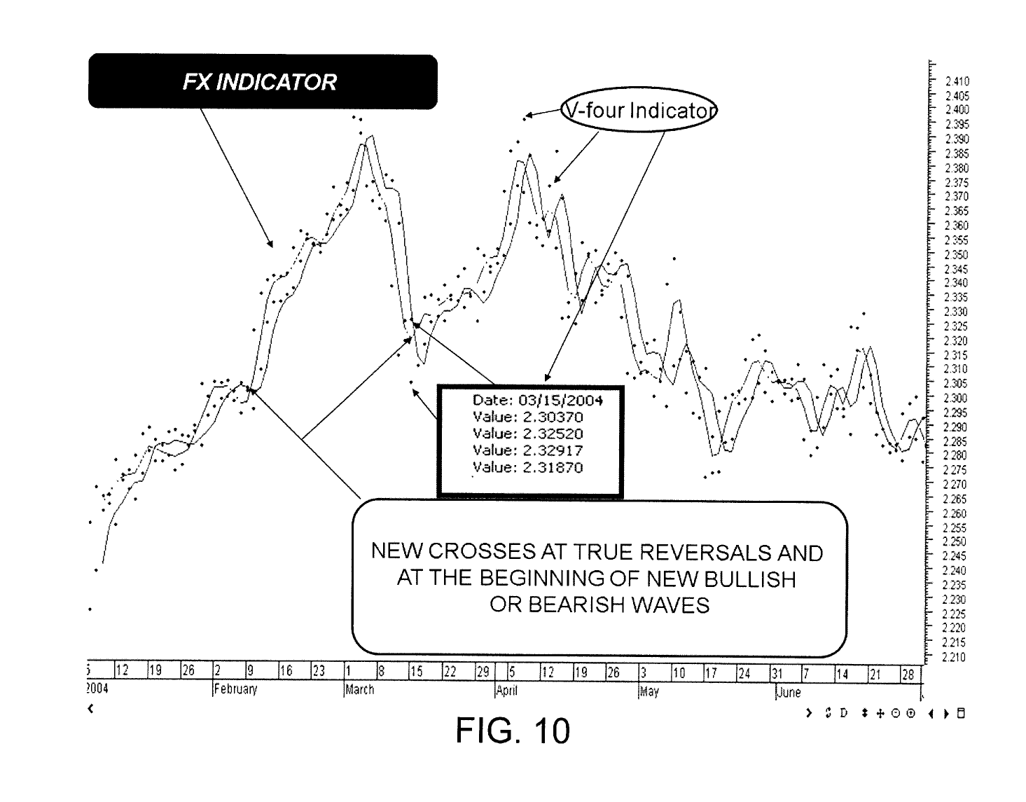

V-FOUR Indicator: Preferably, another set of algorithms can be plotted in real time and in conjunction with the real-time plot of V2 and V1, i.e. around V-TWO Indicator (at least herein embodying wherein such at least one third graphical representation and such at least one fourth graphical representation are each presented jointly with such at least one first graphical representation and such at least one second graphical representation on such at least one comparative analysis chart). Preferably, these algorithms reflect, in real time, the position of highest prices (V4 as depicted by green dots) and lowest prices (V3 as depicted by red dots) in a particular timeframe in relation to the previous timeframe (at least herein embodying calculating at least one third time-relevant value for such at least one timeframe; at least herein embodying wherein such at least one third time-relevant value is based on at least one lowest price paid for such at least one tradable instrument for such at least one timeframe; at least herein embodying calculating at least one fourth time-relevant value for such at least one timeframe; at least herein embodying wherein such at least one fourth time-relevant value is based on at least one highest price paid for such at least one tradable instrument for such at least one timeframe; at least herein embodying creating at least one third graphical representation of such at least one third time-relevant value for such at least one timeframe; and at least herein embodying creating at least one fourth graphical representation of such at least one fourth time-relevant value for such at least one timeframe). Preferably, the position of the V4 green dots will be below the V2 green line, when stronger selling pressure exists and will be above the V2 green line when stronger buying pressure exists in a market. The position of the V3 red dots will be above the V1 red line, when stronger selling pressure exists and will be below the V2 green line when stronger buying pressure exists in a market. At the reversal of trend or at the crosses the position of V3 red dots and V4 green dots will be either reversed, on top of each other or at an angle (different kind of degree for angles). For more explanation about dots, refer below to Dot Theory. Refer FIG. 9 and FIG. 10 for V-TWO Indicator presentation examples. The behavior of V1, V2, V3 and V4 under various market situations is presented in FIG. 15.

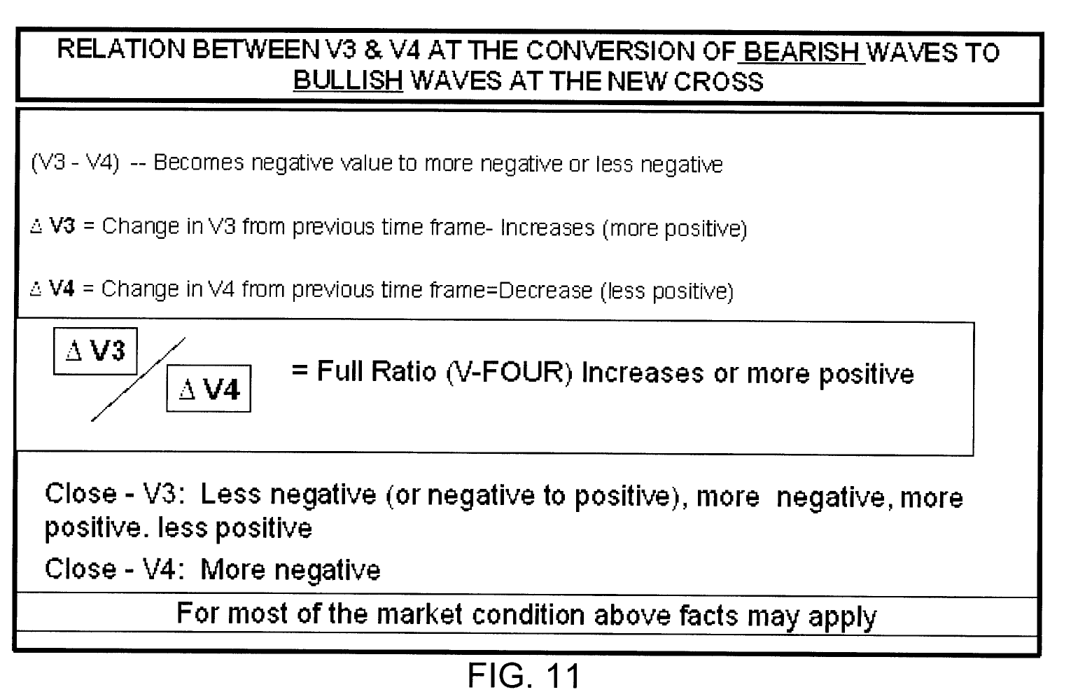

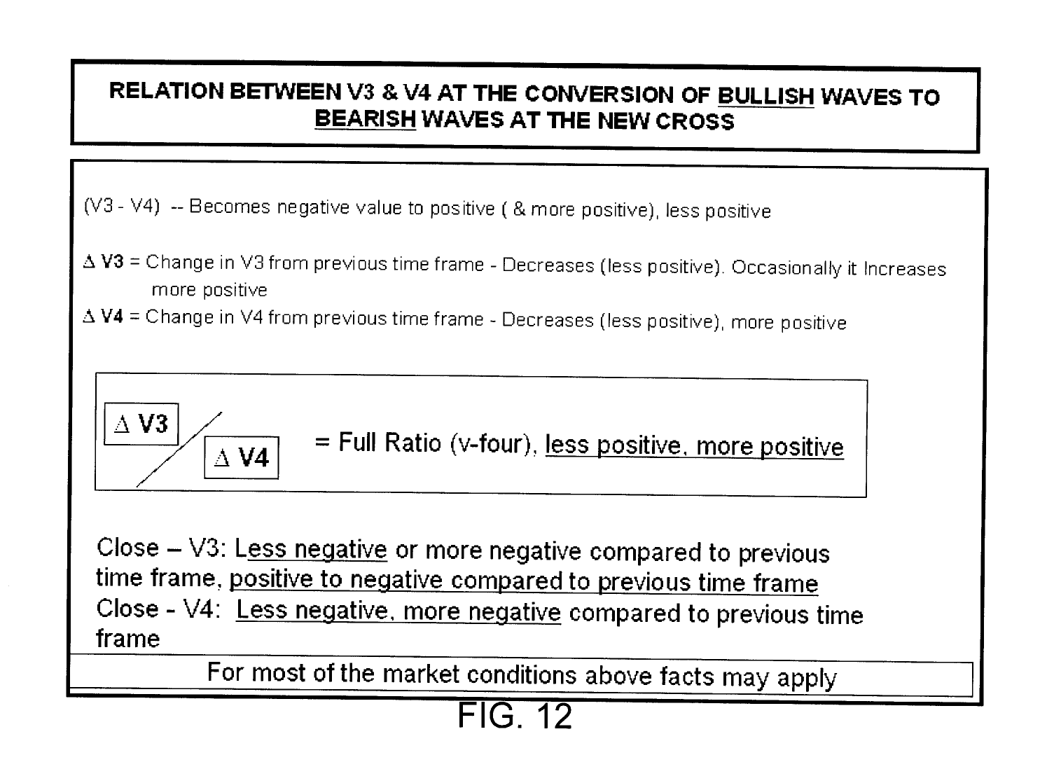

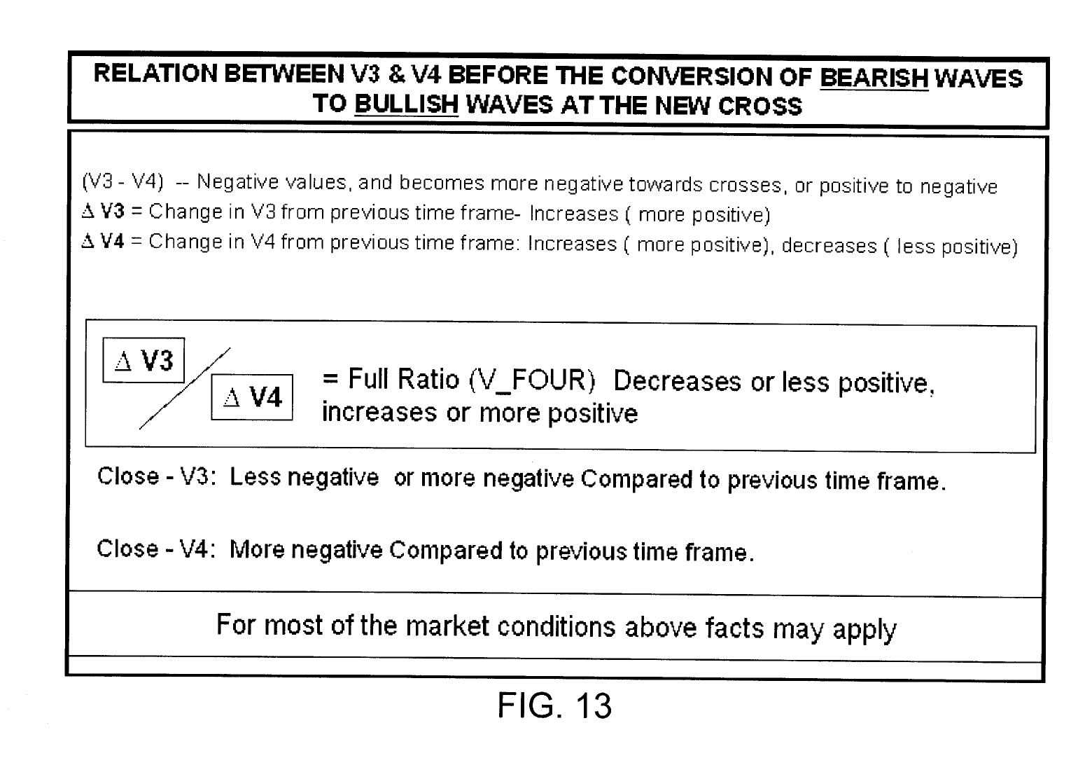

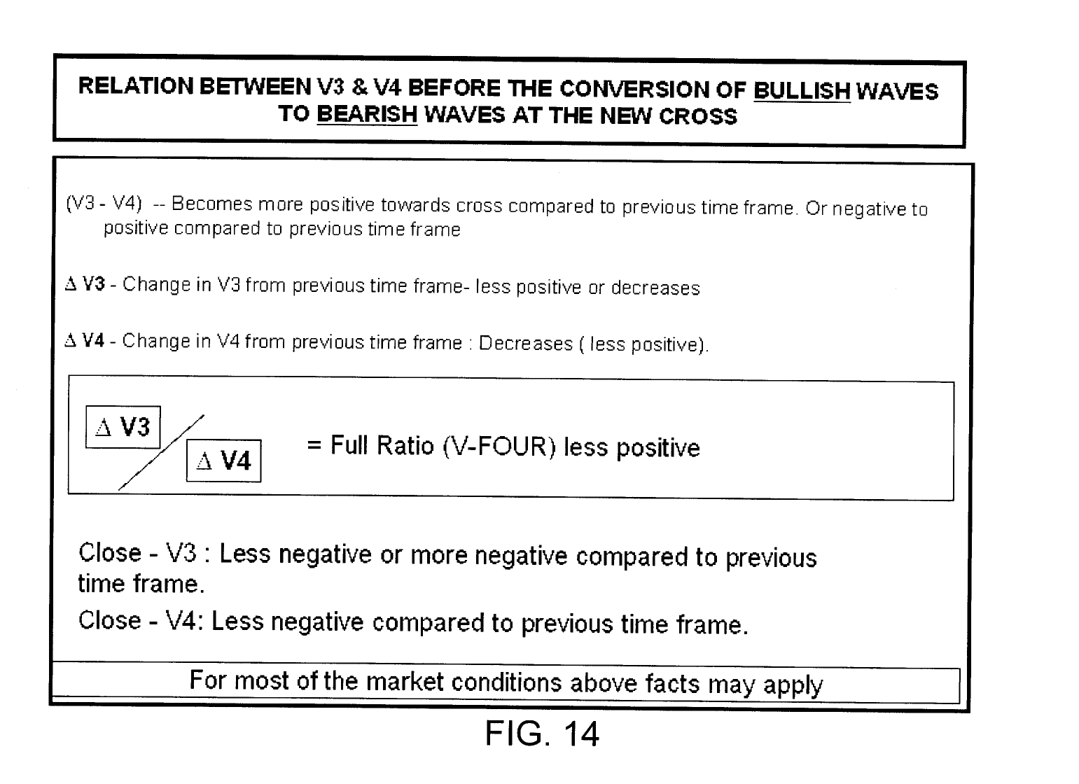

Referring to FIG. 11, FIG. 12, FIG. 13 and FIG. 14, some preferred characteristics of the V-FOUR Indicator are:
A V3—Change in V3 from previous timeframe; decreases (less positive change in V3 from previous timeframe, decreases (less positive) change in V3 from previous timeframe, decreases (less positive) change in V3 from previous timeframe, decreases (less positive) change in V3 from previous timeframe, positive.
A V4=Change in V4 from previous timeframe; decreases (less positive), from previous timeframe; decreases, change in V4 from previous timeframe, increases (more positive) change in V4 from previous timeframe, decreases (less positive) and occasionally it increases.
A V3/A V4—V-FOUR ratio increases or more positive, decreases and occasionally increases, decreases or less positive.
Close-V4: less negative compared to previous timeframe. Occasionally more negative, more negative.
Close-V3: Less negative (or negative to positive), more negative, more positive.
(V3-V4): Becomes positive value to negative, becomes negative value to positive, positive values, becomes less positive towards crosses, becomes less negative compared to previous timeframe and negative only in some cases.

V-FOUR Intensity: The intensity of buying or selling pressure preferably can be measured by the difference of both values (V3 and V4) compared to the previous timeframe. Preferably, in a bearish market the variable factor for V3 (bear) and V4 (bull) remain negative compared to a selected price in the previous timeframe. Preferably, a sudden change in values of V3 and V4 in reverse direction indicates possible continuation of the trend. Preferably, the value of V4 accelerates once the trend resolves in a negative direction.

V-FOUR intensity and V-TWO intensity preferably can be further compared for additional confirmation.

### Event Interjection Techniques

Preferably, event interjection techniques are used to create Synthetic Crosses at the transformation of either bullish waves to bearish waves or from bearish waves to bullish waves. Once the pressure decreases or increases, in order to create precise entries in live trading of any Market Vehicle, interjection of some external variables may preferably be done for both V1 and V2 values to create a new Synthetic Cross exactly at the highest point in the case of transformation from a bullish wave to a bearish wave, or exactly at lowest point in case of transformation from a bearish wave to a bullish wave. Preferably, interjection of external variables may also be used to create a Synthetic Cross at first reversal of closing or open prices of the first timeframe from the high point in case of bullish to bearish transformation, or at first reversal on the closing or opening prices of a second timeframe. Preferably, interjection of external variables can be similarly applied for bearish to bullish wave transformations. Preferably, the New Crosses created by these external injections may also be termed “Synthetic Crosses” while New Crosses created by natural reversal at the transformation without any external injection may also be termed “Natural Crosses”. Herein the terms New Crosses and Natural Crosses are used interchangeably.

The biggest advantage of Synthetic Crosses is to pin-point the entries at the confirmation with conventional charting patterns. This technique may produce lower profit, but is much less risky than using Natural Crosses. Traditional reversal patterns in many charting tools and their reversal confirmation points can preferably be substituted by just plotting Synthetic Crosses.

Preferably, Synthetic Crosses can be plotted against the X and Y axes on any time interval, which can be either first, second, or third interval from the first timeframe that had the highest price for bullish wave or lowest price for bearish waves. Preferably, this applies to all waves, embedded trends, and retracements.

Confirmation of buying pressure drops and crosses by traditional methods or patterns may be referred to as New Bearish Crosses. Confirmation of buying pressure drops and crosses by external variable interjections may be referred to as Synthetic Bear Crosses. Confirmation of selling pressure drops and crosses by traditional methods or patterns may be referred to as New Bullish Crosses. Confirmation of selling pressure drops and crosses by external variable interjections may be referred to as Synthetic Bullish Crosses.

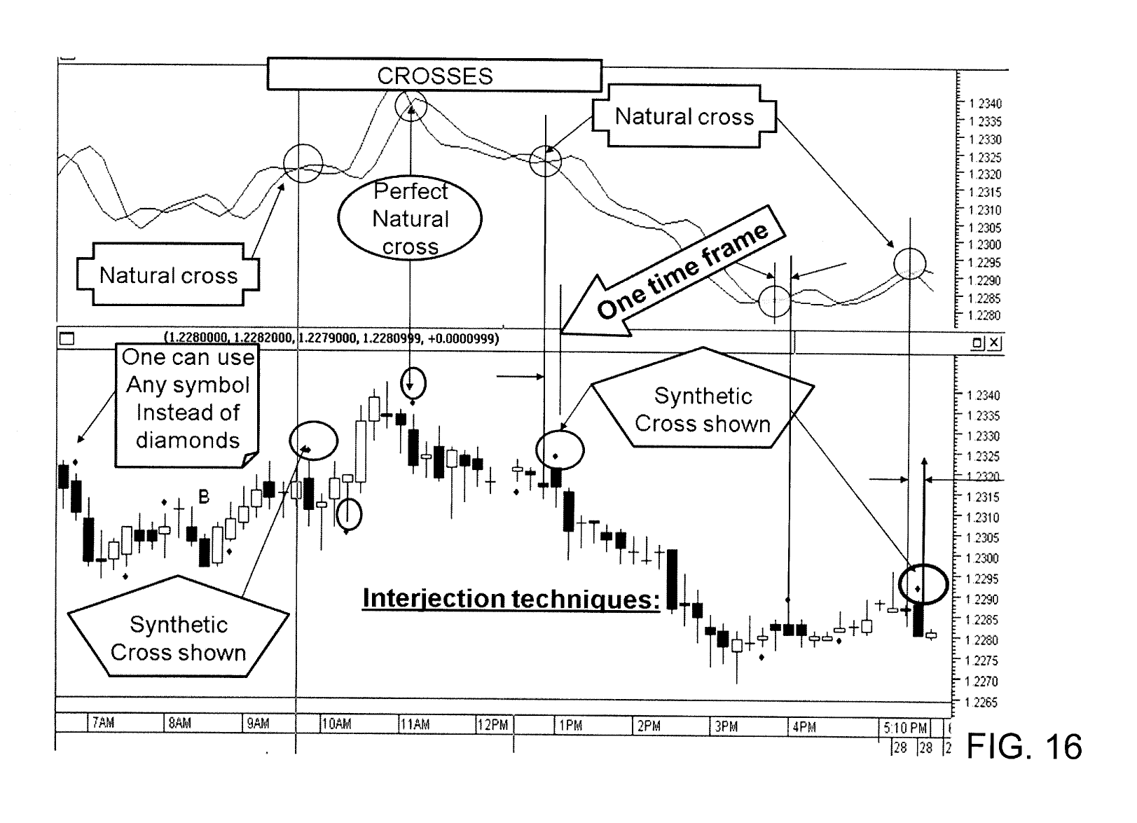

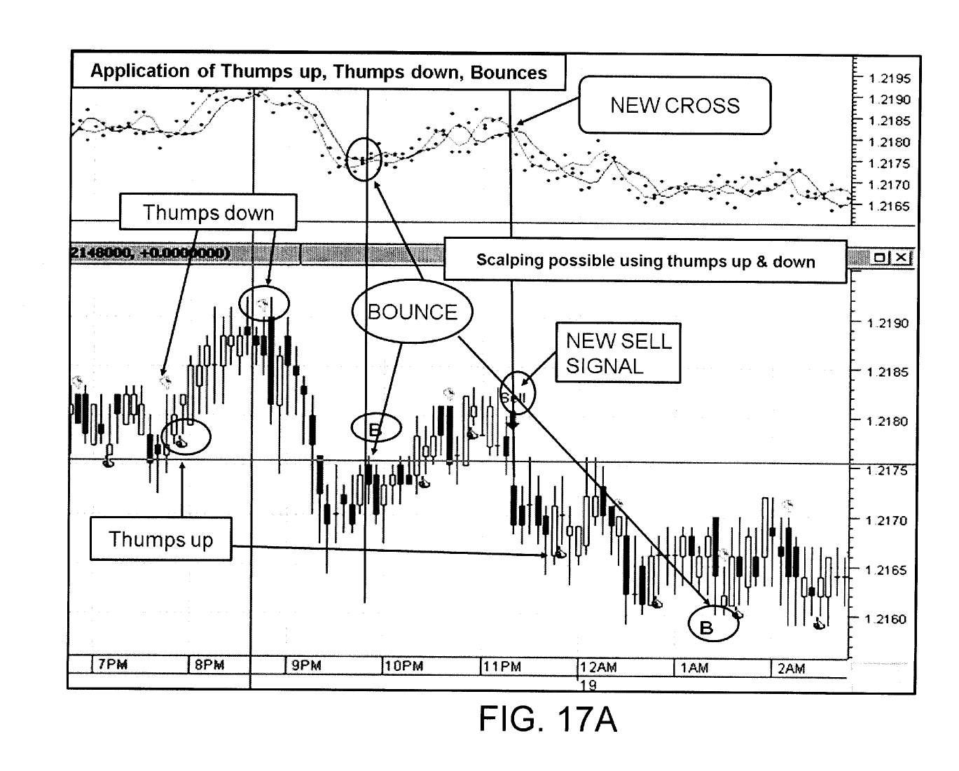

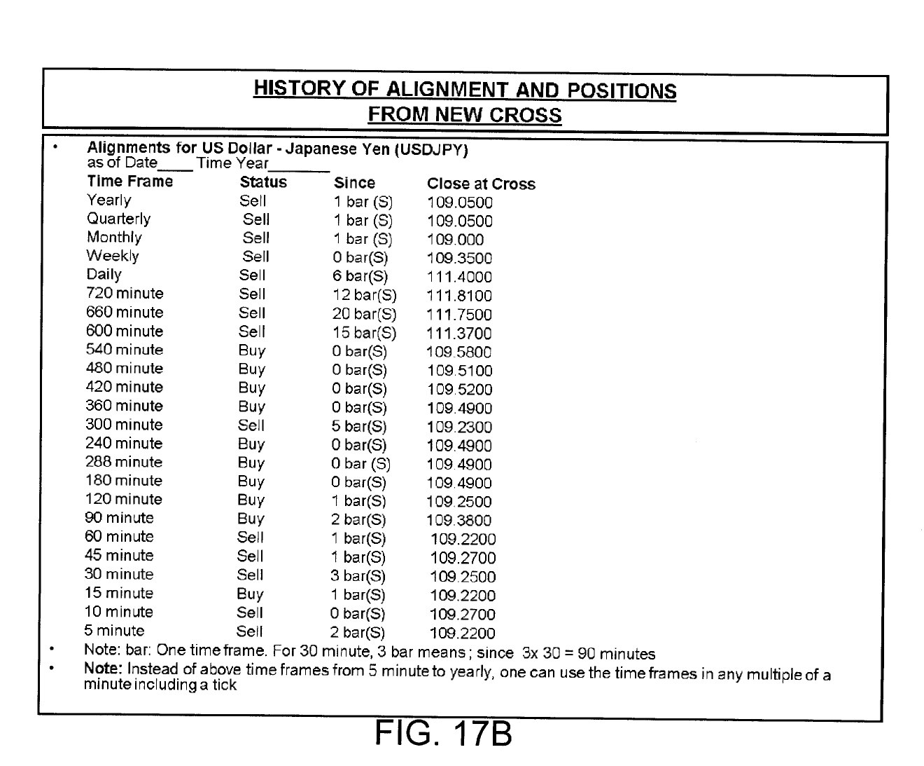

Preferably, both Natural crosses and Synthetic Crosses can be shown, or to keep things simple, every cross can be recognized as a New Cross or as a Bullish Cross or as a Bearish Cross. Preferably, Synthetic Crosses can be spotted, by comparing the crosses on V-TWO Indicator and V-FOUR Indicator and by examining conventional bar charts and candle charts. Refer to FIG. 16 and FIG. 17.

### Using Proper Alignment to Generate Entry and Exit Signals

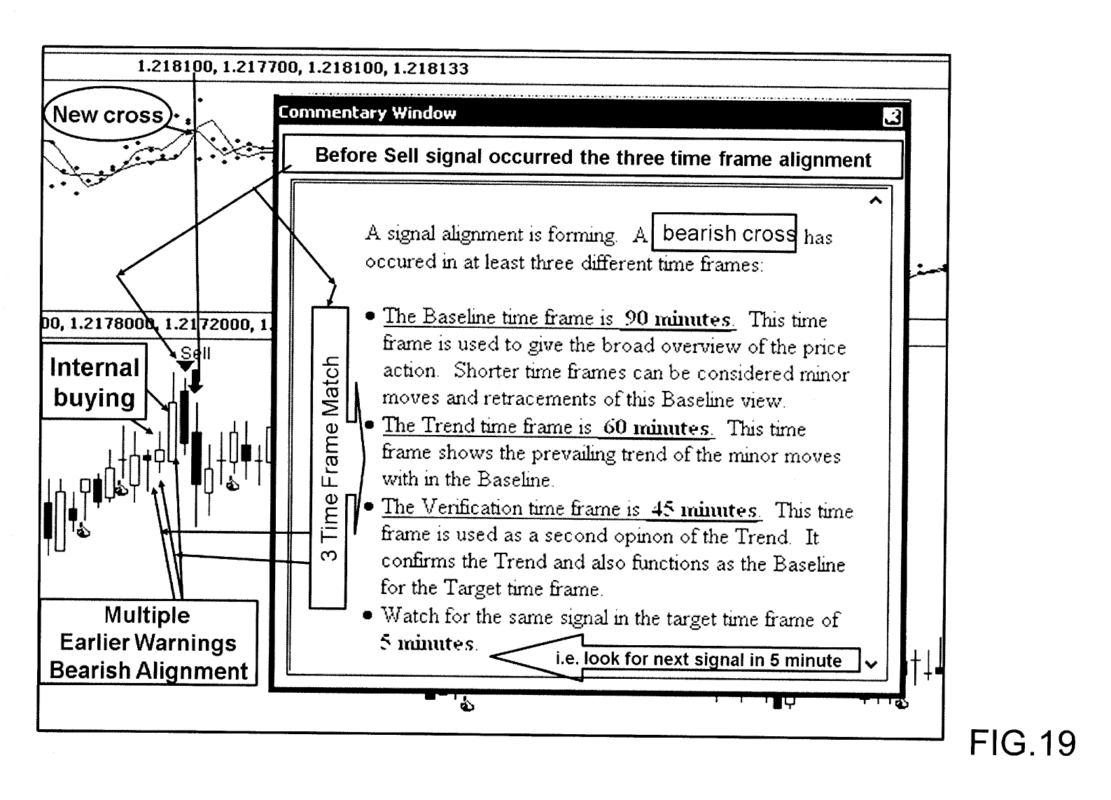

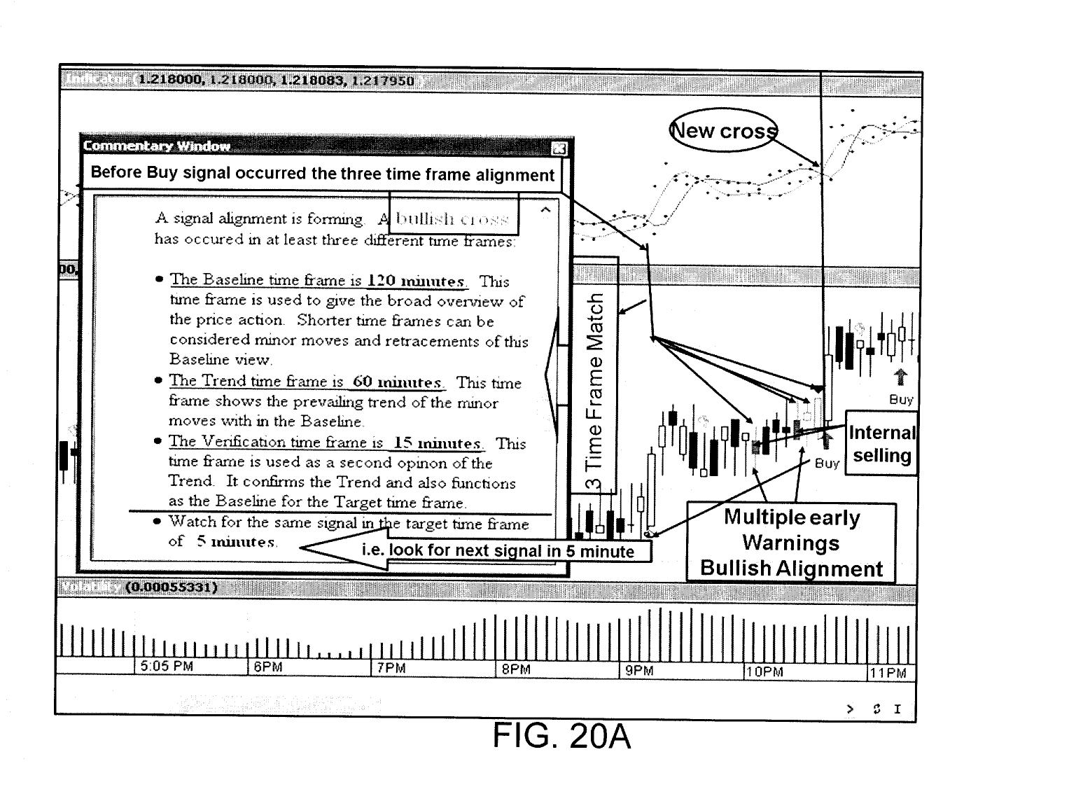

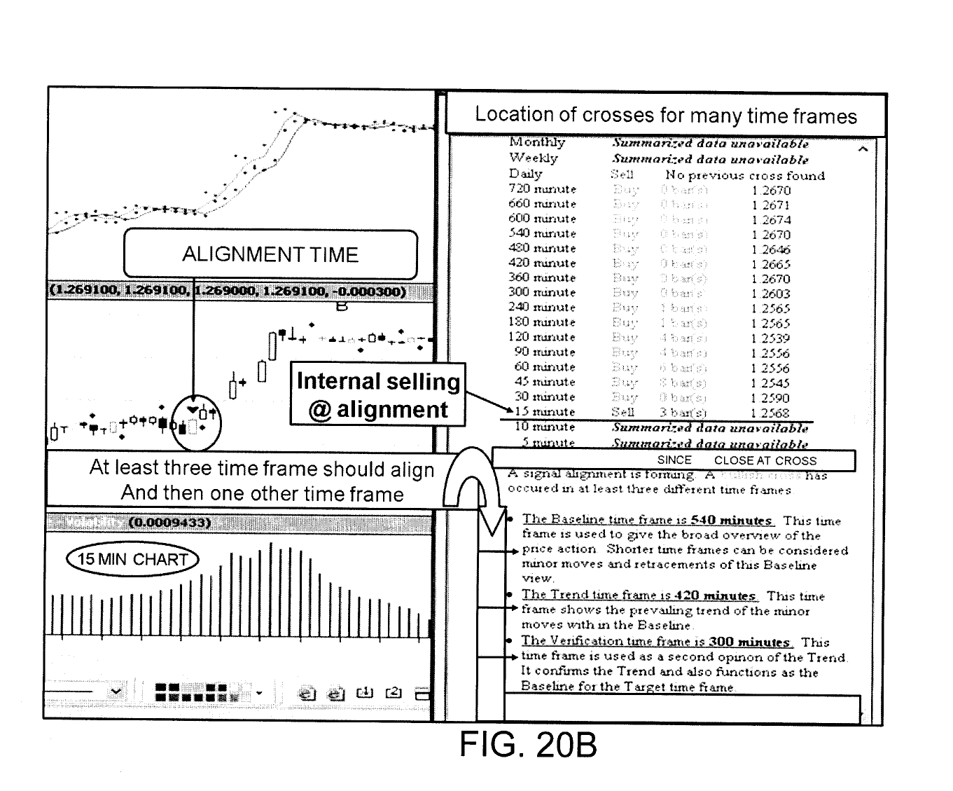

Preferably, the alignment of the first three all bearish or all bullish New Crosses can be used as a pre-warning for the final alignment and can be shown as a colored bar, candle or line in traditional charts. Preferably, these bars/candles/lines can appear multiple times, until alignment of at least four such timeframes occurs. Preferably, on alignment of the fourth timeframe the signal will be transformed as an entry signal on a five-minute timeframe. Preferably, the trader has the option to choose any combination of multiple time-frames such as two, three, four, five, six and more for the alignment and can use a colored bar for any minute timeframe of choice. See FIG. 19 and FIG. 20.

Preferably, it is not necessary to have selected an entry signal of five minute timeframe. Preferably, the trader can use 10, 15, 30, 45, 60 or any combination of multiples of one minute or one tick (one transaction). Preferably, for example, the trader may select a predetermined number of timeframes such as 30, 180, 480, Daily and get alignment on a 30 minute timeframe to generate the signal. Preferably, there are endless combinations one can have for an alignment. Preferably, each alignment event for multiple timeframes can be presented in commentary form for educational purposes before taking into consideration a final alignment signal as an entry for either bullish or bearish market condition. See FIG. 19 and FIG. 20.

When alignment of three timeframes occurs and the trader is waiting for final buy or sell signal, preferably the trader can use the technique of internal selling or buying (buying or selling activity with the five minute timeframe) by preferably using hollow or filled candles on a traditional candle chart. In the case of a bullish cross at the alignment, the candle can preferably appear as filled green candle, to indicate evidence of internal selling, even when there is a bullish alignment. Preferably, the trader can see those timeframes in red, when using Commentary and Alignment (Refer to Commentary and Alignment below). Preferably, the same logic applies in a bearish alignment. A trader can preferably use filled candle as a favorite sign at or before the alignment and avoid empty red candles and locate internal buying in Commentary and Alignment.

Preferably, the entire history can be presented in commentary including all timeframes, currently selected timeframes, the type of wave (bullish or bearish), how many timeframes since the current wave started, the time, the prices of the Market Vehicle at a New Cross, current status, open, close, high and low prices, and when a New Cross happened. Preferably, the trader can customize any timeframe in this history. Preferably, the trader can utilize the results of Critical Path analysis (Refer to Critical Path Method for Alignment) in various alignments for a particular Market Vehicle or for a multiple Market Vehicles. See FIG. 17A for a sample history of alignment and market positions.

### Applications in Market Timing Using Alignment

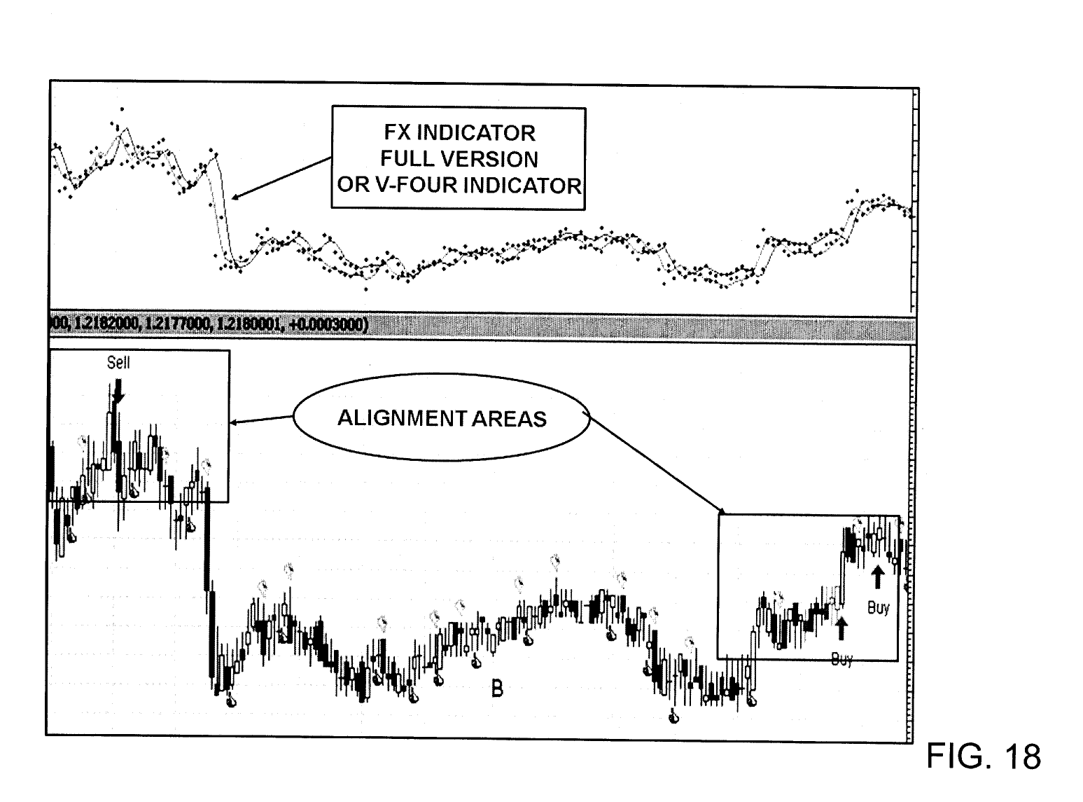

Preferably, New Crosses formed at the beginning of new bullish or bearish waves can be used from different timeframes, at open, close, high, low prices and be aligned with multiple timeframes (more than two) and with a five minute New Cross. Preferably, the final alignment event (four new crosses either bullish or bearish) can be then transferred as a signal on a five minute bar or candle as an entry signal for either bullish or bearish bias in a Market Vehicle. Preferably, the final alignment can be shown as a green or red arrow or any symbol of choice on any traditional chart method such as candles, bar, line etc. Refer FIG. 18 for an example of alignment, and refer to FIG. 19, FIG. 20 & FIG. 20A for examples of alignment and a five minute entry signal.

### Alignment and Commentary

Preferably, the alignment history for a particular Market Vehicle can be given in commentary form by using the expert commentary (as described below). Preferably, expert commentary can help traders making better judgments about entry and exit signals as well as better educate him/her self. Preferably, New Cross positions for all timeframes are reviewed and the best available options are selected and presented to the trader using expert commentary. Preferably, it can automatically show the two or more timeframes which are ready for alignment arranged from the shortest to longest timeframe which produces a less risky entry. Preferably, the trader may choose pre-selected timeframes to create alignment, but this will result in fewer opportunities and lower profits. Preferably, natural alignments provide ample opportunities and fewer trades in real time. Also, preferably expert commentary can recognize the smallest timeframe which can be available for alignment after looking at the nearest possible New Cross in another timeframe and select the most probable timeframe and put it on a watch list in the commentary section.

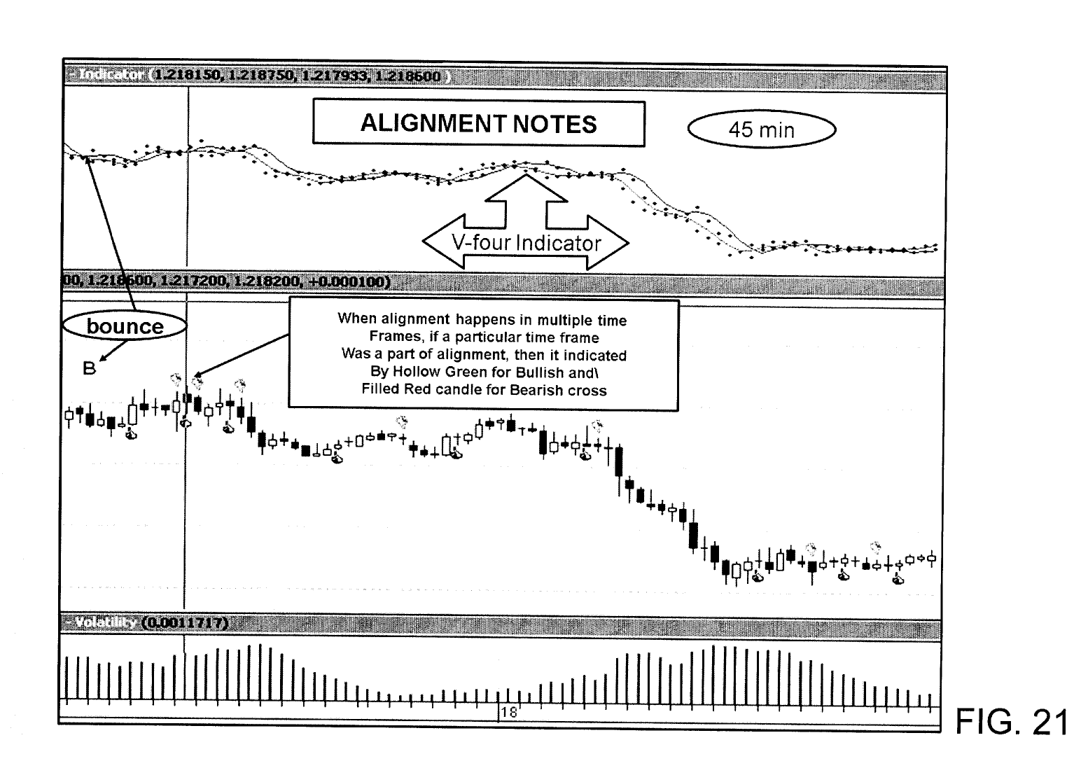

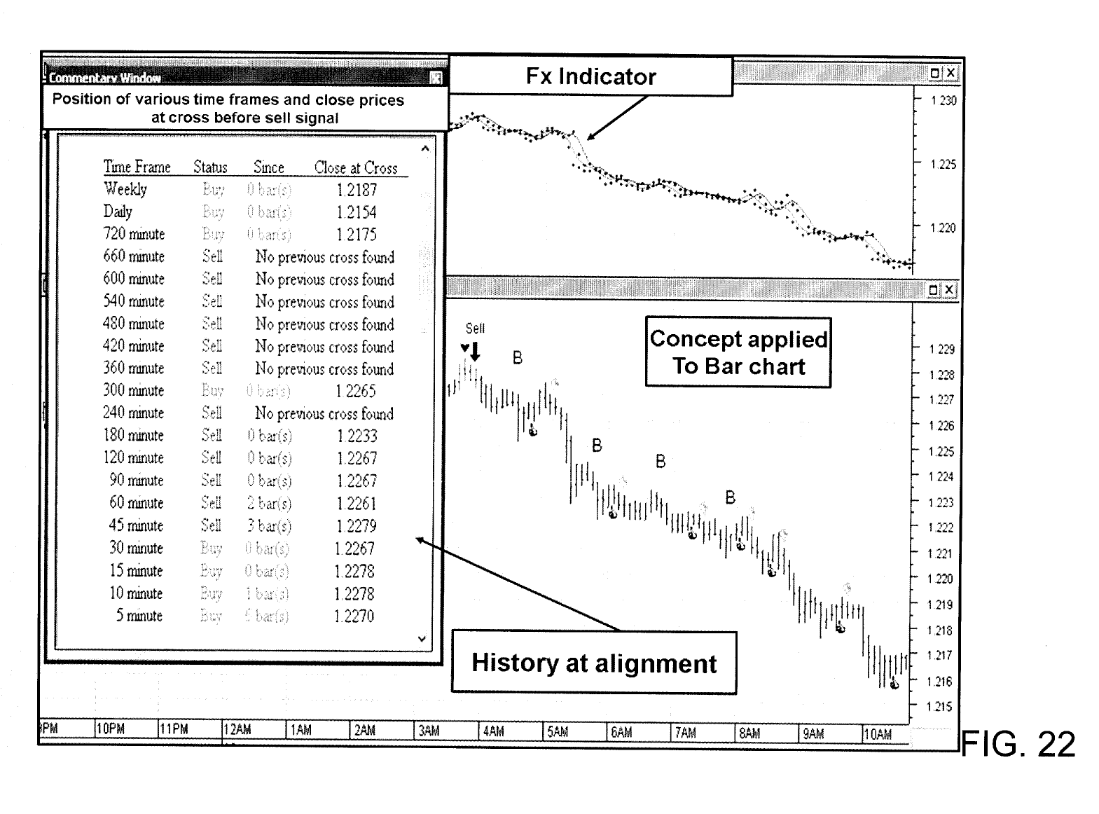

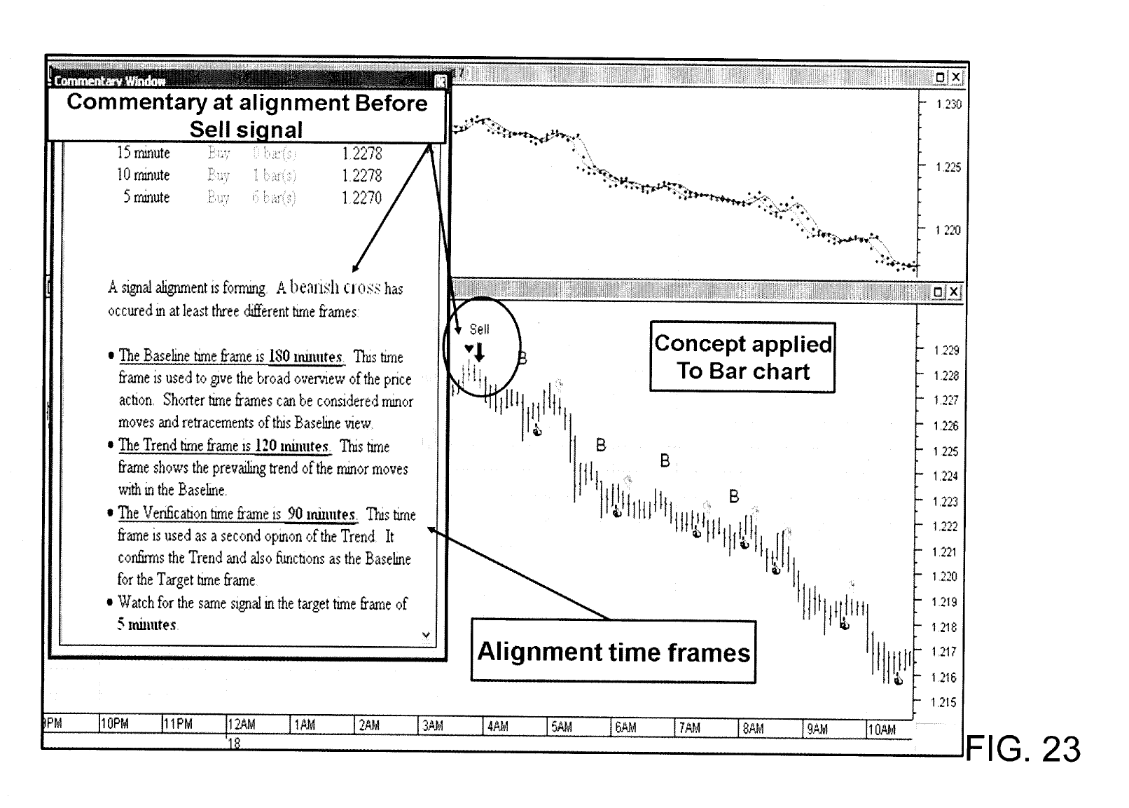

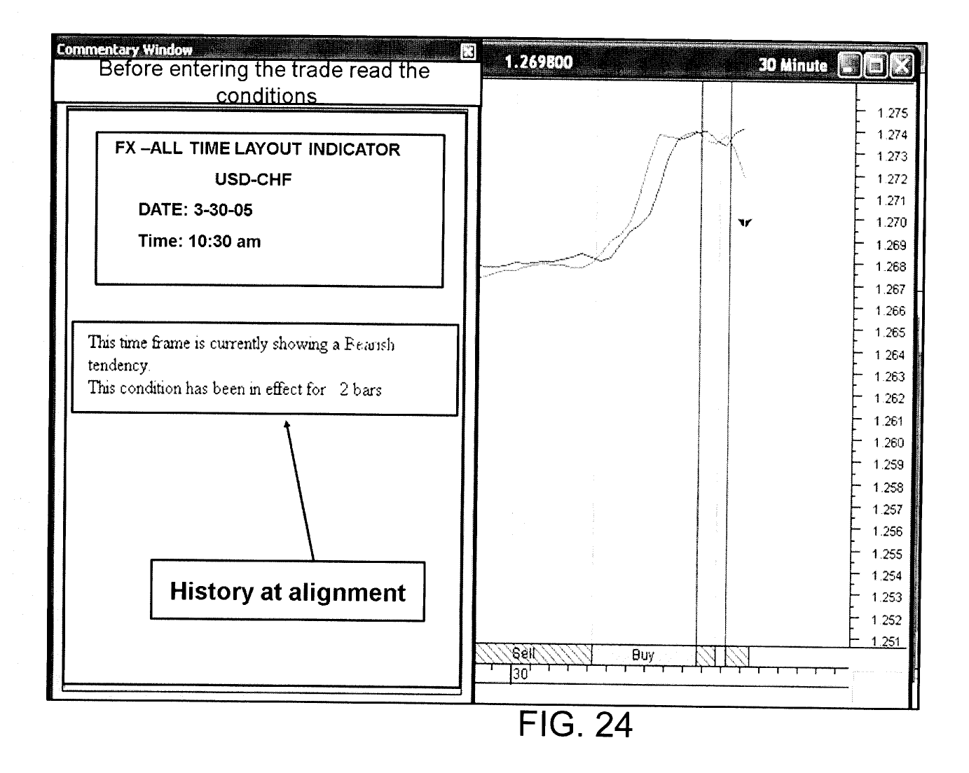

The concept of alignment and signals produced at alignment can also preferably be used on traditional charting methods such as bar chart, line chart, candle chart, etc. Refer to FIG. 22 and FIG. 23 for examples of the use of Bar charts with alignment. Preferably, the alignment concept can be also used with V-TWO, V-FOUR, Day Trader Heaven and other charting methods and layouts, as shown in FIG. 21 and FIG. 24.

The following example interpretation preferably can be done using current expert commentary and alignment methods (Refer FIG. 19 for a bearish alignment example and FIG. 20 for a bullish alignment example):
“A signal alignment is forming. A bullish cross has occurred in at least three different timeframes.
The Baseline timeframe is 480 minutes (strongest). This timeframe is used to give a broad overview of the price action. Shorter timeframes can be considered minor moves and retracements of this Baseline view.
The Trend timeframe is 360 minutes (stronger). This timeframe shows the prevailing trend of the minor moves within the Baseline. (Embedded trend).
The Verification timeframe is 180 minutes (strong). This timeframe is used as a second option of the Trend. It confirms the Trend and also functions as the Baseline for the Target timeframe.
Watch for the same signal in the target timeframe of 5 minutes. (Good Entry)”

Preferably, at or after every New Cross, regardless of the above alignment, another signal can be given on the traditional bar, candle or other types of charts in form of colored thumbs up (for bullish move) and a different color thumbs down (for bearish move). Preferably, this symbol may be used to take intermediate entries or for adding or removing existing lots. These thumbs up or thumbs down can be also used to show retracements within the baseline/trend time or verification timeframe. It is prudent to recognize the alignment of strongest waves and then enter at the smallest timeframe to avoid deep draw downs.

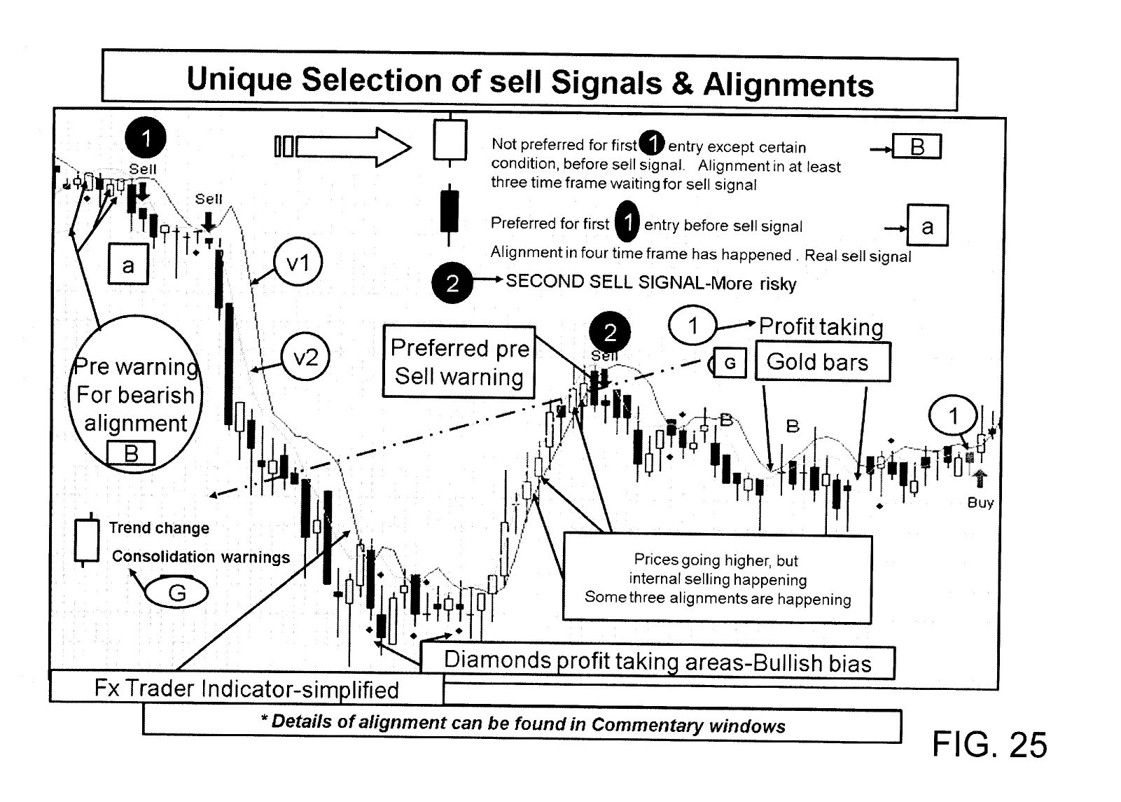

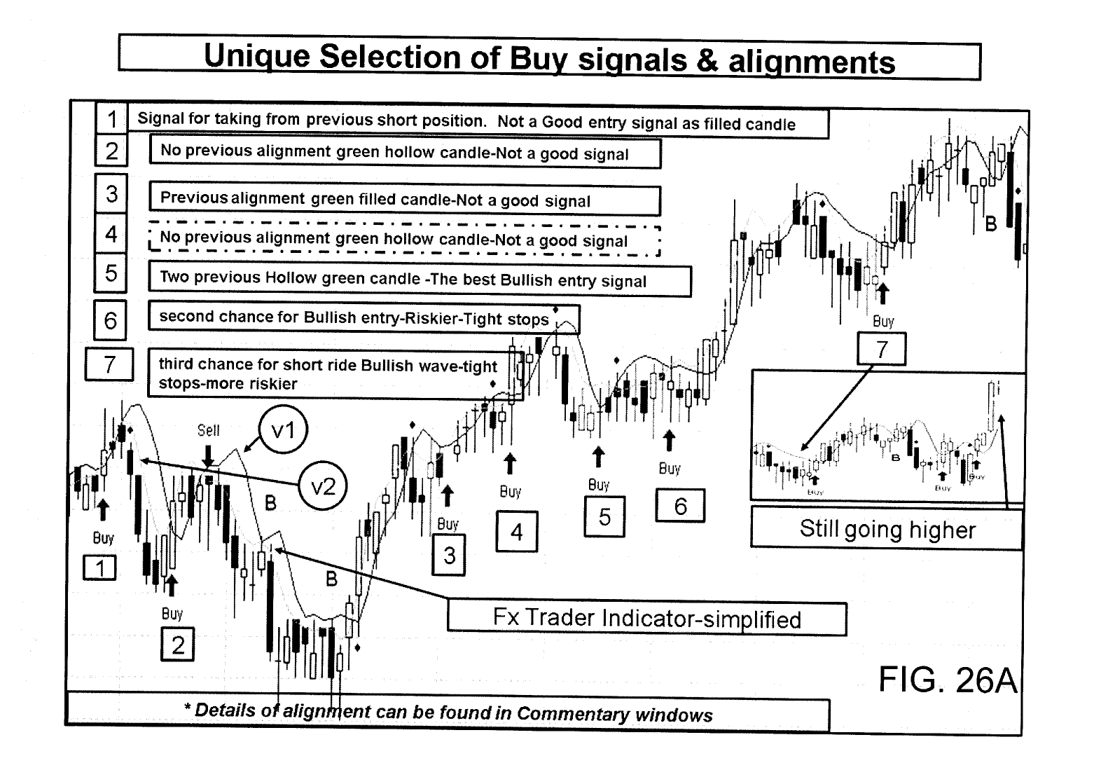

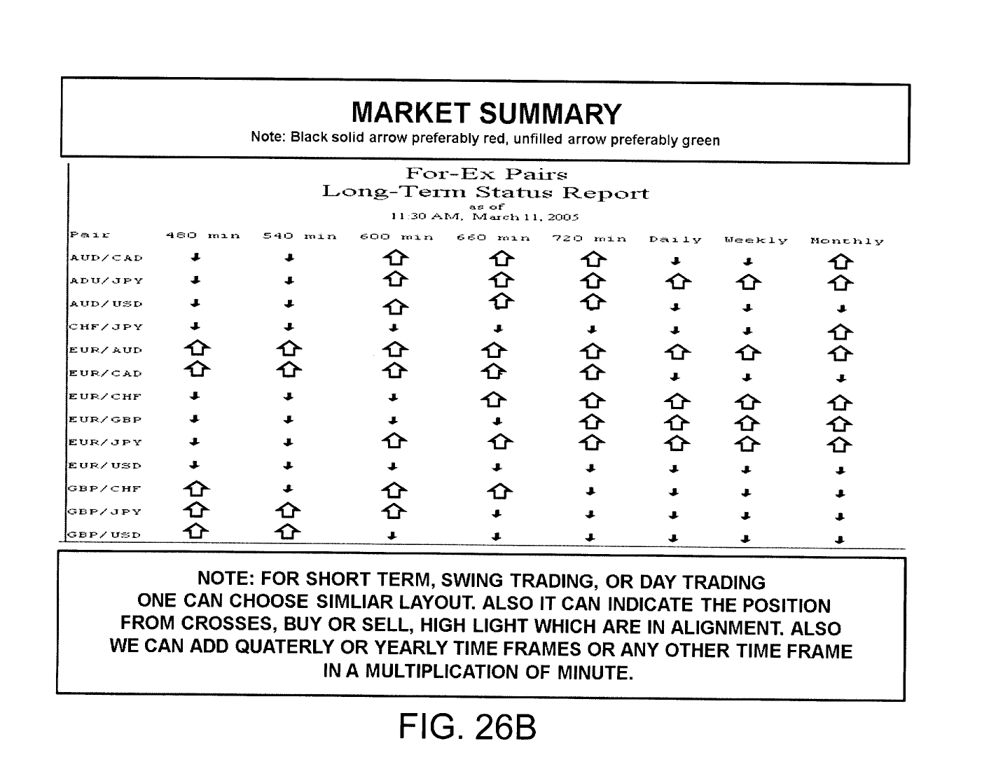

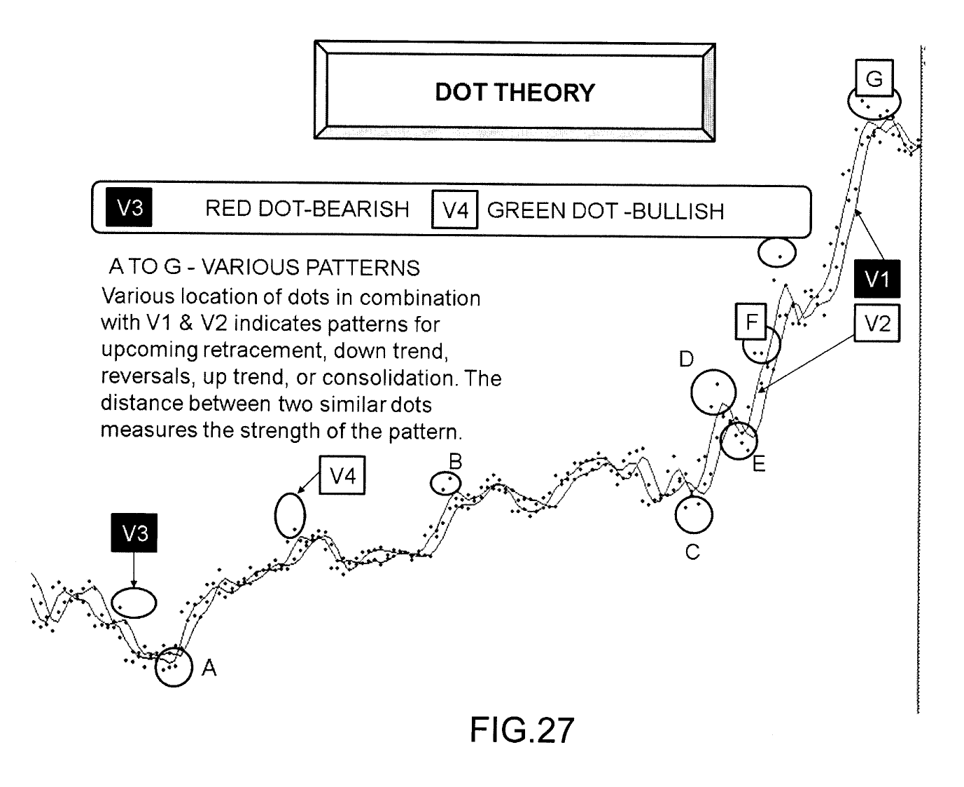

Preferably, the alignment concept can be used for any pre-determined combination of various timeframes such as: 180 minutes, 720 minutes, weekly and monthly with five minute entry signals. Preferably, the above concept is based on the natural occurrence of waves build up permitting a trader to ride any wave small or large as it develops at any give time. Cases like this may produce fewer buy or sell signals, but do indicate weighted buy and sell signals. In weighted alignment, the trader has to wait for things to happen and which may cause the trader to miss earlier entry opportunities. Refer to FIG. 25 for examples of a selection of sell signals that may be used with alignment. Refer to FIG. 26 for examples of a selection of buy signals that may be used with alignment.

Referring to FIG. 26A which presents a display example of a Market Summary for several currency pairs Market Vehicle. A Market Summary for several different individual currency pairs (or any Market Vehicle elements), preferably can be created using the New Crosses by showing different timeframes in any selected multiple of minutes or ticks (transactions). This broad visualization preferably eliminates the need for examining different timeframe charts for a variety of different Market Vehicles. Preferably, an alert can be created for various Market Vehicles and summarized, when using an exploration feature. This can be a huge time savings for institutional traders. Using current robotics, preferably a trader can use buy and sell signals for multiple Market Vehicles and their elements (elements refers to pairs of currencies, such as usd-jpy, usd-chf, aud-nzd, etc. each pair being an element of a Market Vehicle called currency pairs). The same logic can be applied for any Market Vehicle after certain adjustments.

Using existing alert signal technology, preferably an alert for any buy or sell signal can be generated when New Crosses (bullish or bearish) for two or more timeframes are aligned using either open, close, high, or low prices or a combination of any of four or more. Preferably, a signal can be sent either via email, pager, or to cell phone before and at the new alignment. Preferably, using alert signals other alerts can be created such as golden bar (Refer to Reversal Bar and Golden Bar Theory), when new crosses are formed or aligned on weekly, daily or quarterly or yearly timeframes. Preferably, it is practical, to custom design an alert using any of these concepts.

### Additional Theories

In combination with V-TWO Indicators, V-FOUR Indicators, Alignment, New Crosses and Synthetic Crosses, following theories can be of help to traders:
Dot Theory
Reversal Bar and Golden Bar Theory
Real Time Swing Bar Theory (floating pivots to hard pivots)
FX Pivot Theory
Volatility Theory
Day Trader Heaven, Swing Trader Heaven, Short Term Trader Heaven or Long Term Trader Heaven Theory (also called FX All Target)
Critical Path Method for Alignment

### Dot Theory

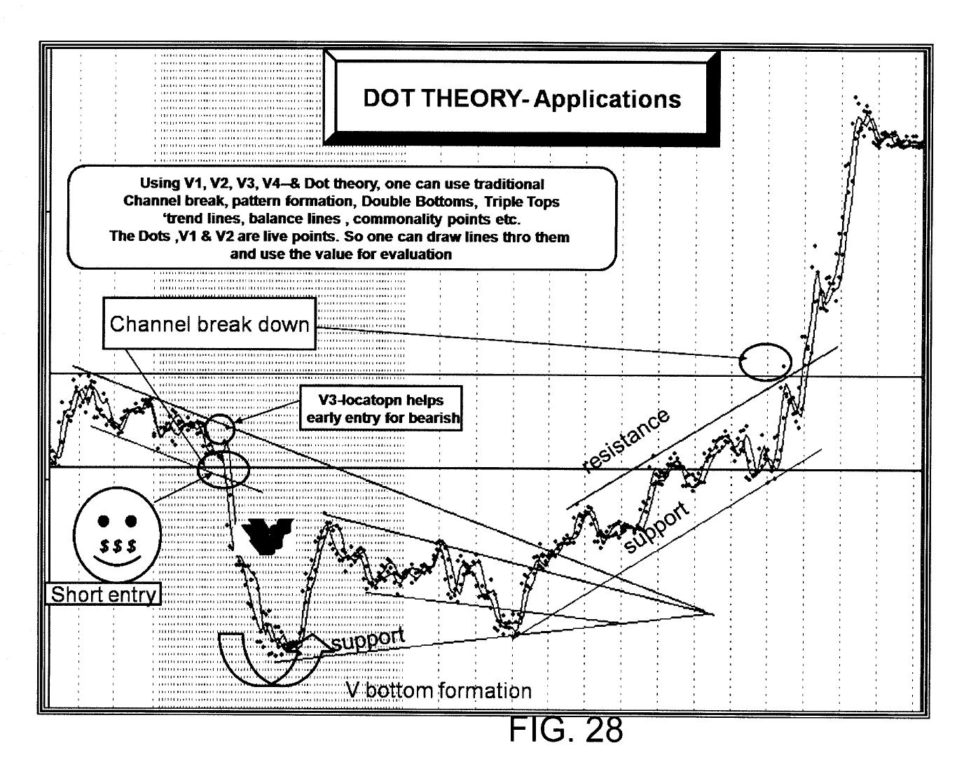

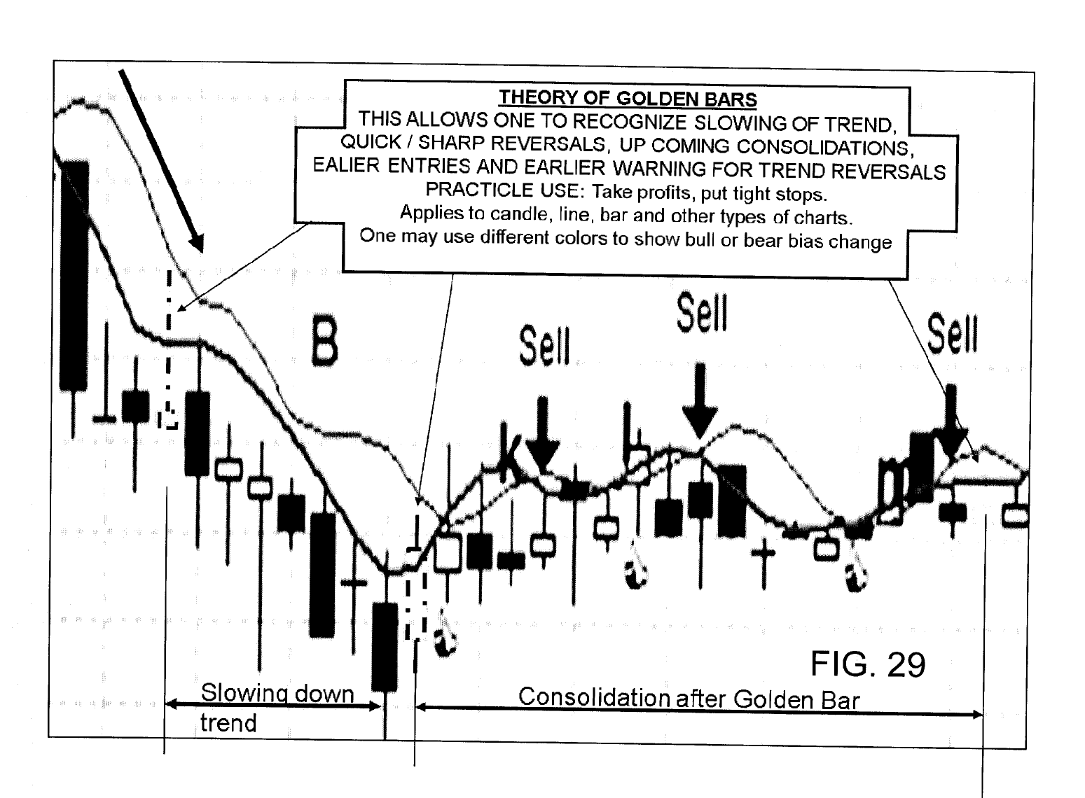

Using any Market Vehicle, preferably patterns can be developed and the key reversals can be identified visually as well as by using four values, two bullish and two bearish. For example, the distance between various V4 green dots and V3 red dots can further indicate the intensity of either buying or selling pressure. As discussed earlier, the V-FOUR Indicator which is the combination of V1 green lines, V2 red lines, V3 red Dots and V4 green dots plotted against an X and Y axis preferably can be used to indicate entry and exit points for any Market Vehicle. The V-FOUR Indicator may be referred to as a FX Indicator for Currencies, an ST Indicator for Stocks, an MU Indicator for Mutual funds, a COM Indicator for Commodities, an INX Indicator for Index. In fact, any Market Vehicle can be given similar name using the same concept. The New Crosses created by V1 and V2 and the position of V3 and V4 dots in comparison with the V1 and V2 lines can preferably give further evidence of real buying and selling pressure in a particular timeframe. The New Crosses created after plotting V1 and V2 to X and Y axis preferably can be then used to identify an alignment as described earlier. Preferably, at the New Crosses the position of V4 dots and V3 dots reversing identifies reversal points, while V4 dots and V3 dots over-lapping indicates indecision in the market. Further, the four values (two bullish and two bearish) shown as either V4 or V3 dots preferably can be used to find earlier entries and exits and can be used independently or in a combination with crosses or with other patterns. Refer FIG. 28 and FIG. 29 for examples.

### Reversal Bar and Golden Bar Theory

Preferably, a colored bar can be used and added to the candle charts, traditional bar or other charts at several junctions for FX (currencies markets), ST (stock markets), MU (mutual fund markets), COM (commodities), INX (indexes). These junctions preferably are the key reversals using open, close, high, low prices and optionally FX Traders Volatility (Refer to Volatility Theory) identifying entry and exit based on dot patterns. A preferred formula looks at open, high, low, close and volatility to create a bar (or candle on candle charts), which can be displayed as a Golden bar (bearish reversal indicator) and a Turquoise bar (bullish reversal indicator).

The following are the preferred formulas for displaying a Golden bar for bearish reversals or a Turquoise bar for bullish reversals. Golden/Turquoise bars are preferably used to indicate a sudden reversal in trend, a sudden buying or selling indication, a slowdown of trend, an indication of a consolidation or a break out of a consolidation. Preferably, Golden/Turquoise bars can be used for any market in conjunction with traditional candle stick charts or bar charts. Preferably, they may also be used to enhance V-TWO and V-FOUR charts.

Preferably, a Turquoise bar will be displayed when the following bullish conditions are met, where T1 is the previous time frame and T2 is the current time frame:
Opening price on T2<Opening price on T1
High price on T2>High price on T1 (For bullish signal: High on T2>High on T1)
Low price on T2> or =low price on T1
Close price on T2>Close price on T1
Volatility on T2>Volatility T1

Preferably, a Golden bar will be displayed when the following bearish conditions are met, where T1 is the previous time frame and T2 is the current time frame:
Open price on T2>Open price on T1
High price on T2< or =High price on T1
Low price on T2<Low price on T1
Close price on T2<Close price on T1
Volatility on T2>Volatility on T1

In either case, conditions are usually reversals.

Factors of 1.2, 1.5, etc. can be applied to Volatility to evaluate the strength of bullish or bearish waves. For example:
Volatility on T2=1.2*Volatility on T1→Light selling
Volatility on T2=1.5*Volatility on T1→Heavy selling

Factors of 1.2, 1.5 , etc. can be applied to High price of T2 can indicate the strength of a Turquoise bar. For example:
High price of T2=1.2*High price of T1→Light bullish
High price of T2=1.5*High price of T1→Very bullish

Preferably, using open, high, low, close prices for any time frame, the above formulas can be used in different ways to assist in finding key reversals, V-formations, U-formations, double tops, double bottoms, etc. Preferably, the formula can help to determine Double Tops and the possible reversal of a bullish trend.
Open price on T2<Open price on T1
High price on T2=High price on T1
Low price on T2>Low price on T1
Close price on T2< or =Close price on T1
Volatility on T2< or =Volatility T1

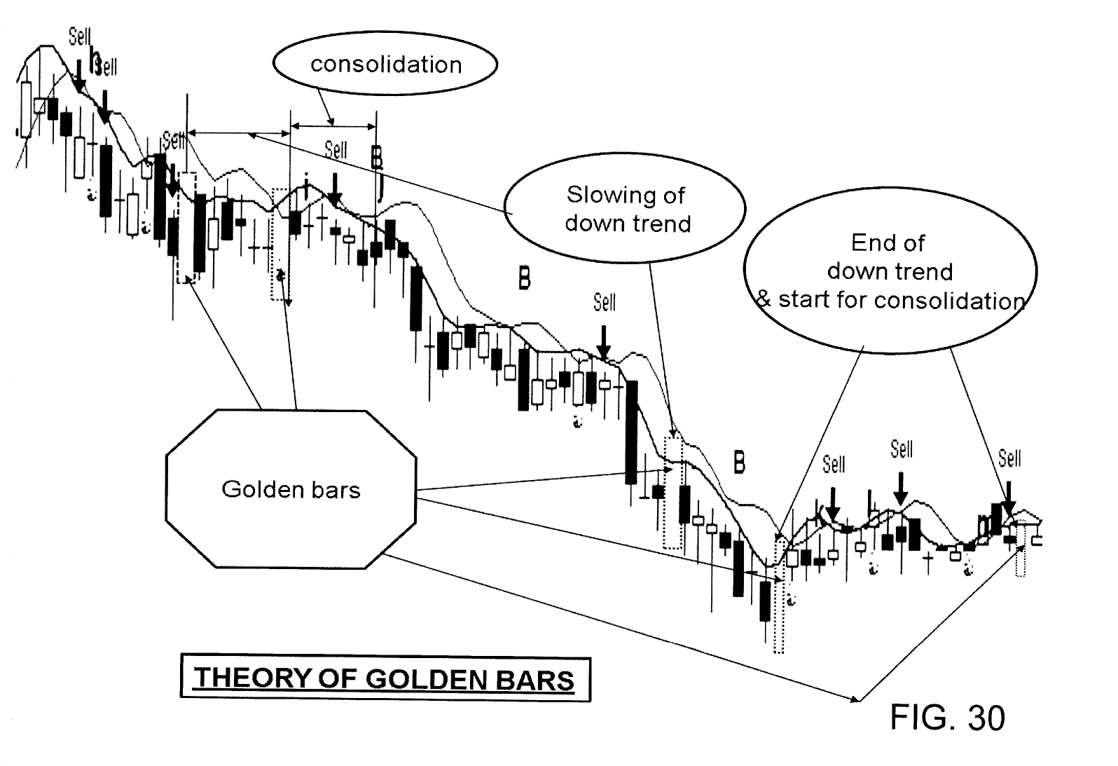

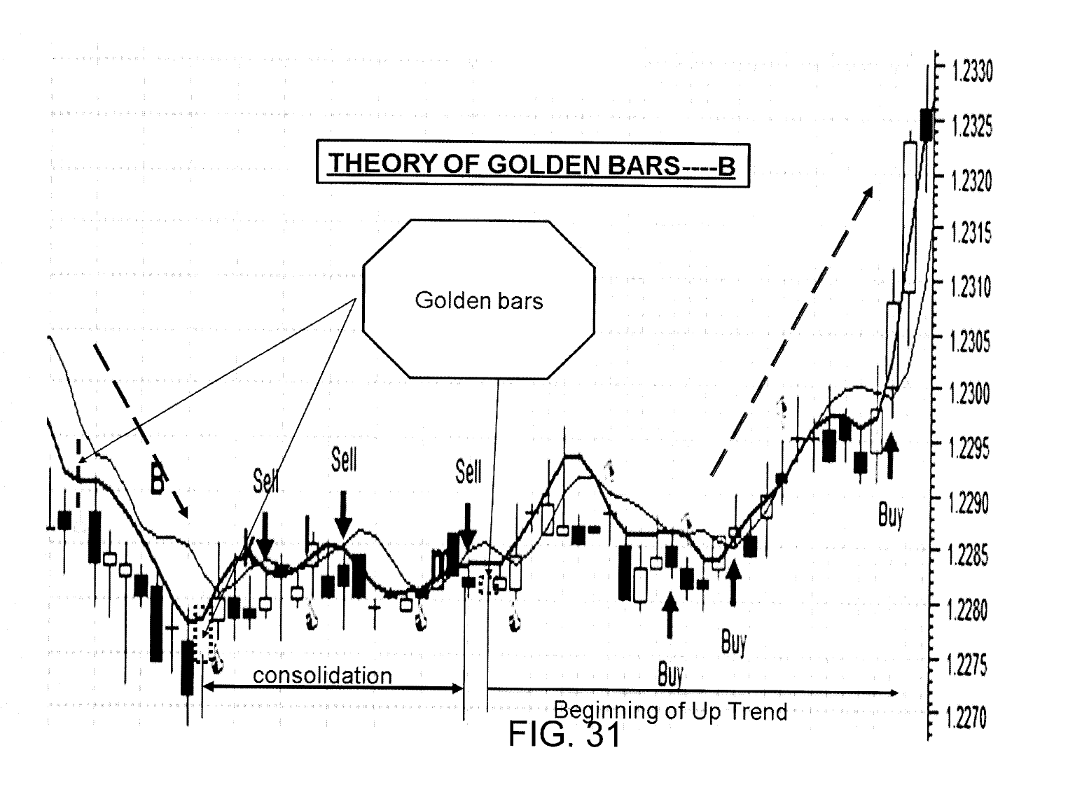

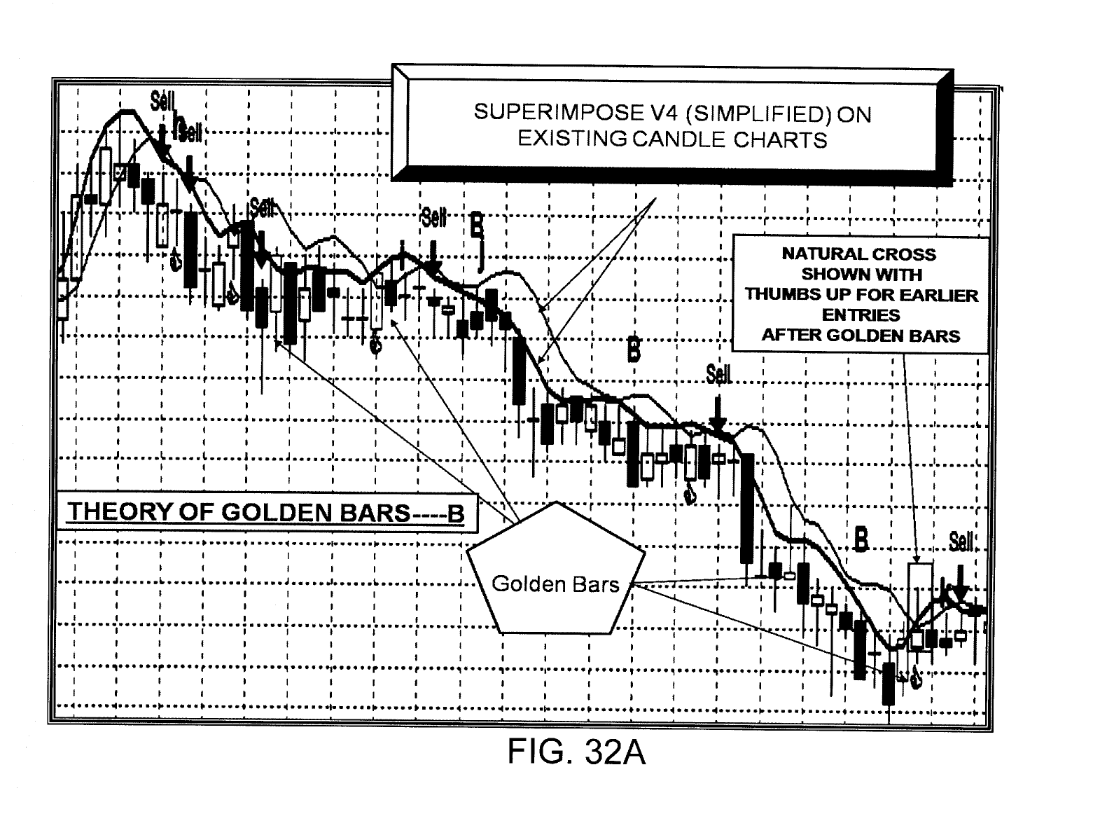

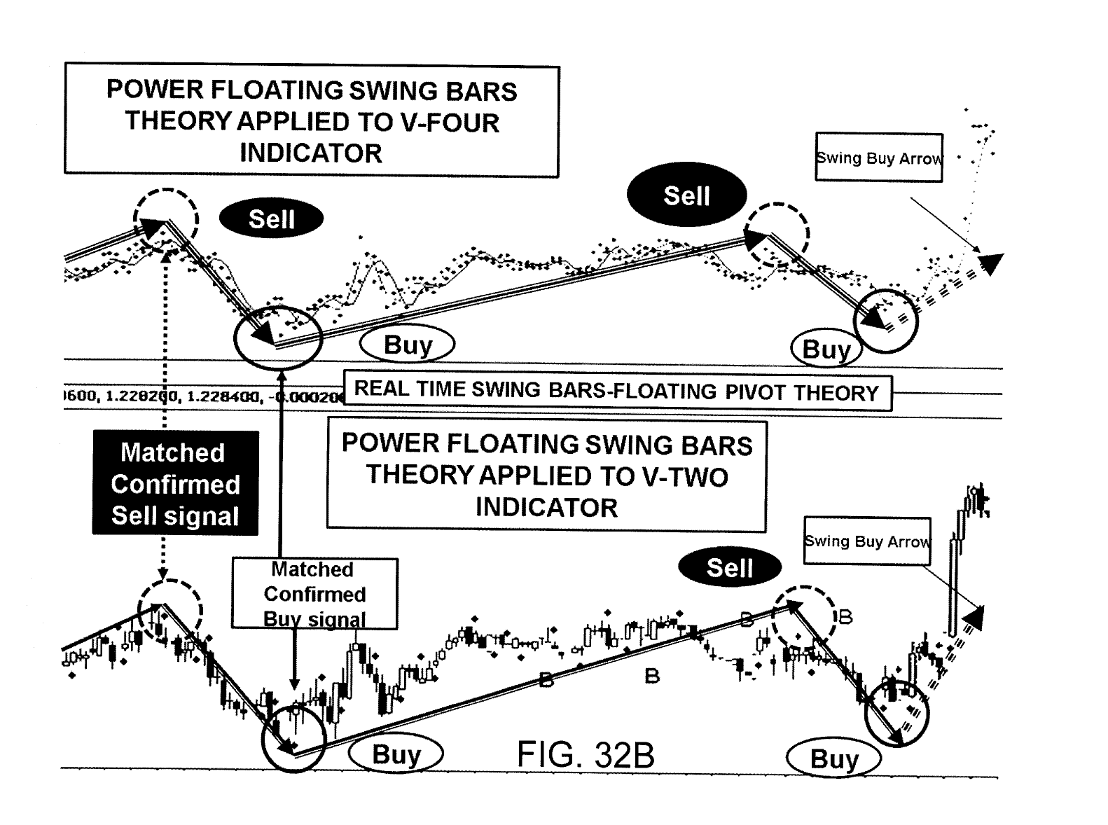

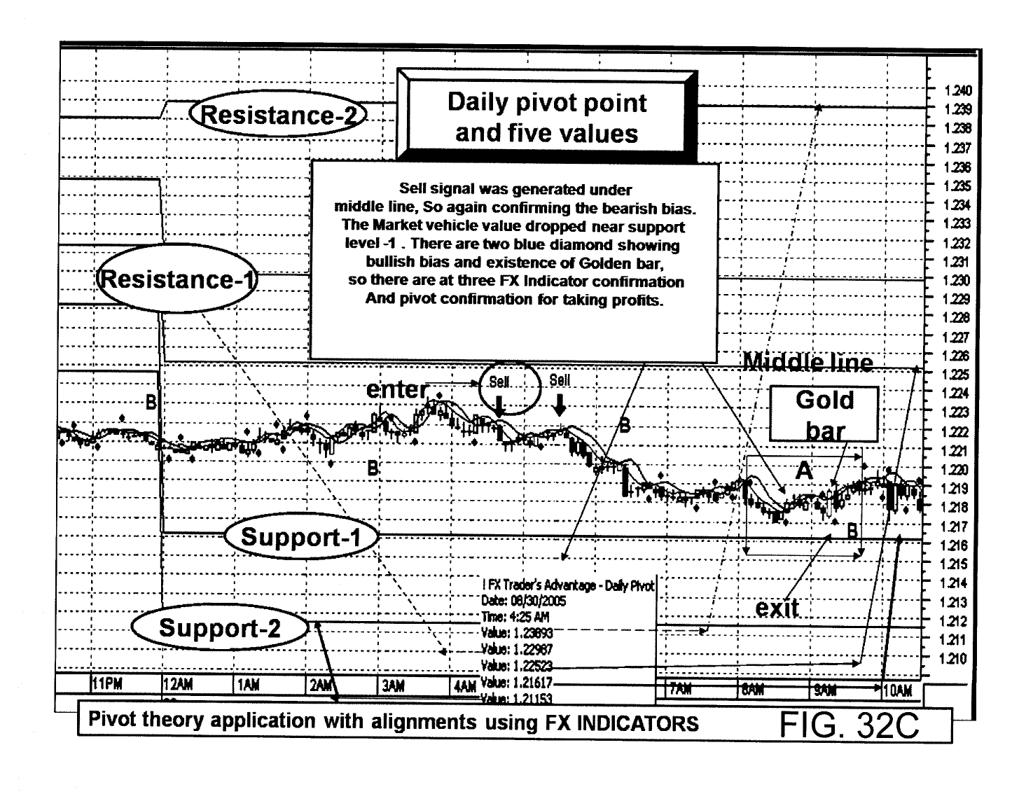

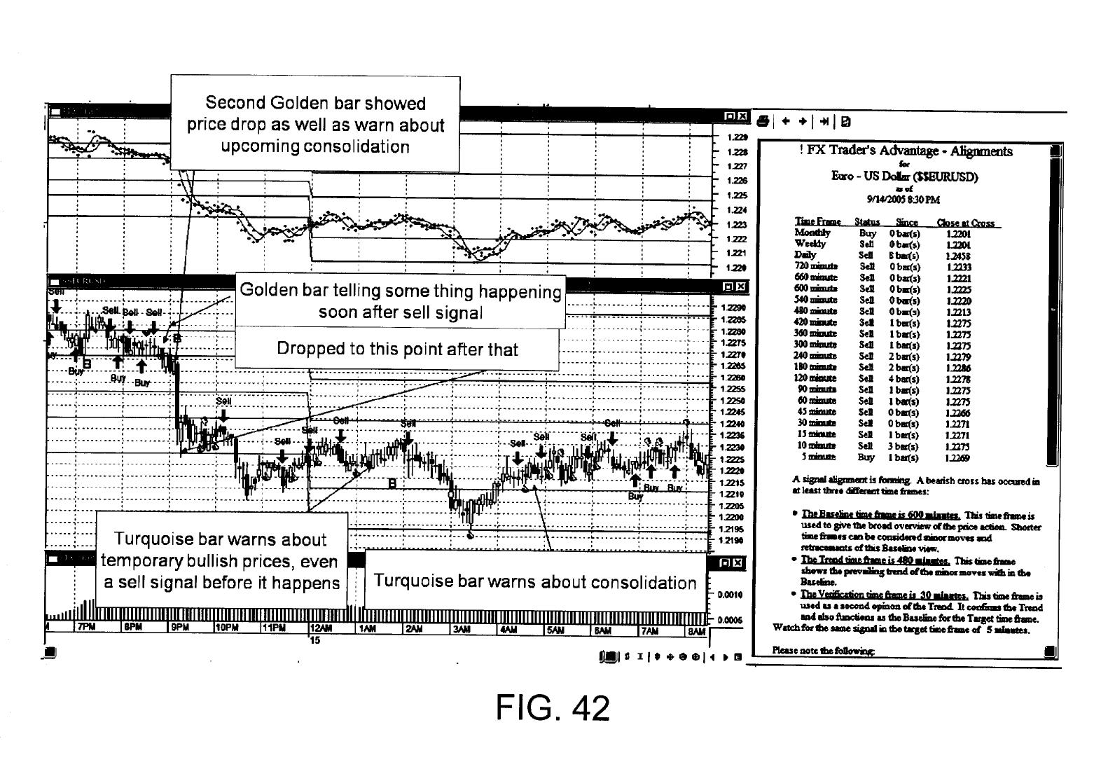

These bars preferably appear on either a candle or a bar chart. These bars indicate slowing of trends, beginning of new trends, consolidations, quick reversals, new event time reversals. They also act like speed bumps in the financial market. Refer to FIG. 29, FIG. 30, FIG. 31, FIG. 32 and FIG. 42 for more examples.

### Real Time Swing Bar Theory (Floating Pivots to Hard Pivots)

Preferably, using dot peak points (V4) and low points (V3), real time swing bars can be created for establishing major trend lines, intermediate trend lines, and live pivot points. Preferably, the tops and bottoms of these bars can be referred as floating pivots. Preferably, the same thing can be done with diamonds using the V-TWO Indicator. The floating pivots which match with V-TWO Indicator and V-FOUR Indicator are very powerful in their nature. It only requires a few timeframes matching the floating pivots of both Indicators to produce better odds of making the appropriate buy/sell decision. Preferably, the floating pivots for the V-TWO indicator are calculated based on values of V1 and V2 and floating pivots for V-FOUR Indicator are calculated based on the values of V3 and V4. Preferably, other factors and parameters may be used to get desired results. Preferably, the last swing line is always a real time swing line and it is always floating. Preferably, it projects the direction of the new trend after the last steady pivot created by previous movement. Each new floating pivot will preferably become steady when a new direction has been established. Combining these pivot points with traditional daily pivots and buy and sell signals generated by five minute charts using alignment and V-FOUR Indicator, can preferably create additional rigid entry and exit points (multiple confirmation points). Using current technology, preferably a live expert commentary can be created explaining the commonality of such points in various timeframes. Refer to FIG. 32A.

### FX Pivot Theory

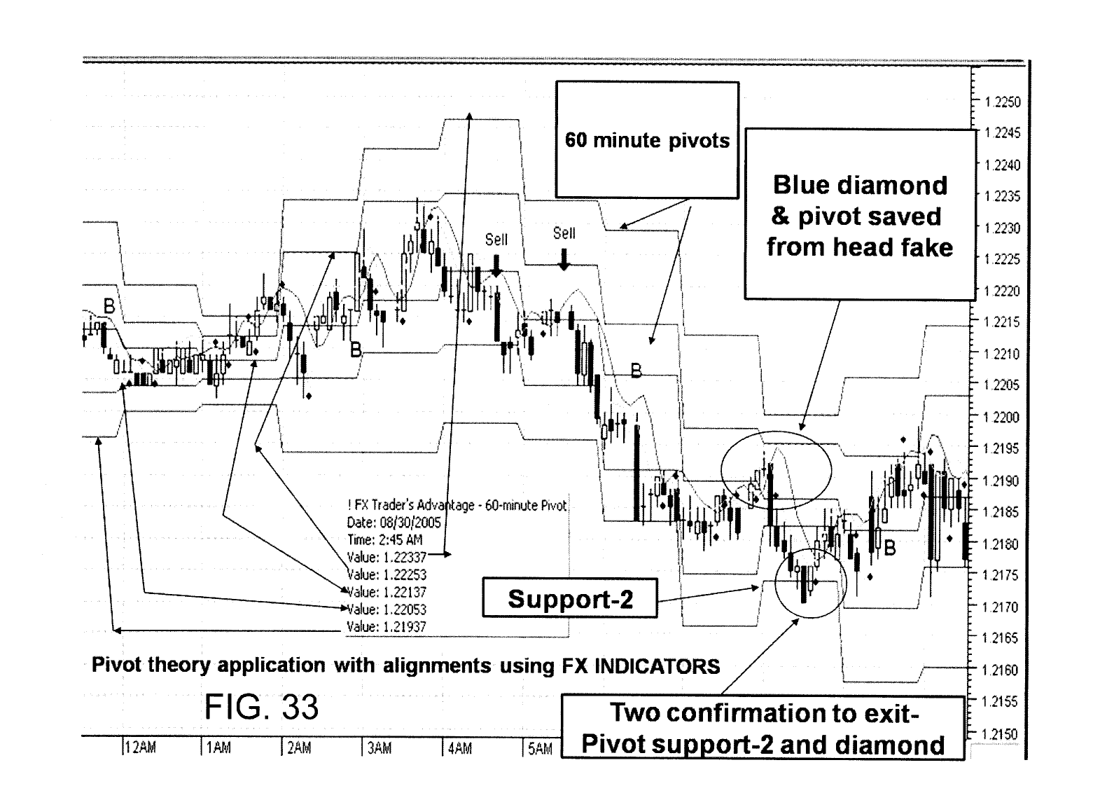

Pivots, such as daily pivots, 60 minute pivots, or pivots for any timeframe, can be calculated using high, low, close prices of any Market Vehicle. Preferably, combining multiple alignment confirmation signals created by V-FOUR Indicator, V-TWO Indicator, or Golden bars with pivots calculations provide a very powerful signal either to the bullish side or bearish side of a market. As an example, in a bullish market, buy signals are created by alignment after verification of Critical Method to provide a strong visual buy signal. Preferably, entry will be after it has stayed above daily or desired pivot points or above first or second resistance levels. The same logic applies in opposite way for bearish entries. The gains from the application of this theory are usually very profitable in any market as well as with any Market Vehicle. Preferably, the five pivot lines or seven pivot lines can be merged with the x and y axis to visualize the location of entry or exit points. The same principals apply with any specially created pivots. Refer to FIG. 32B and FIG. 33.

### Volatility Theory

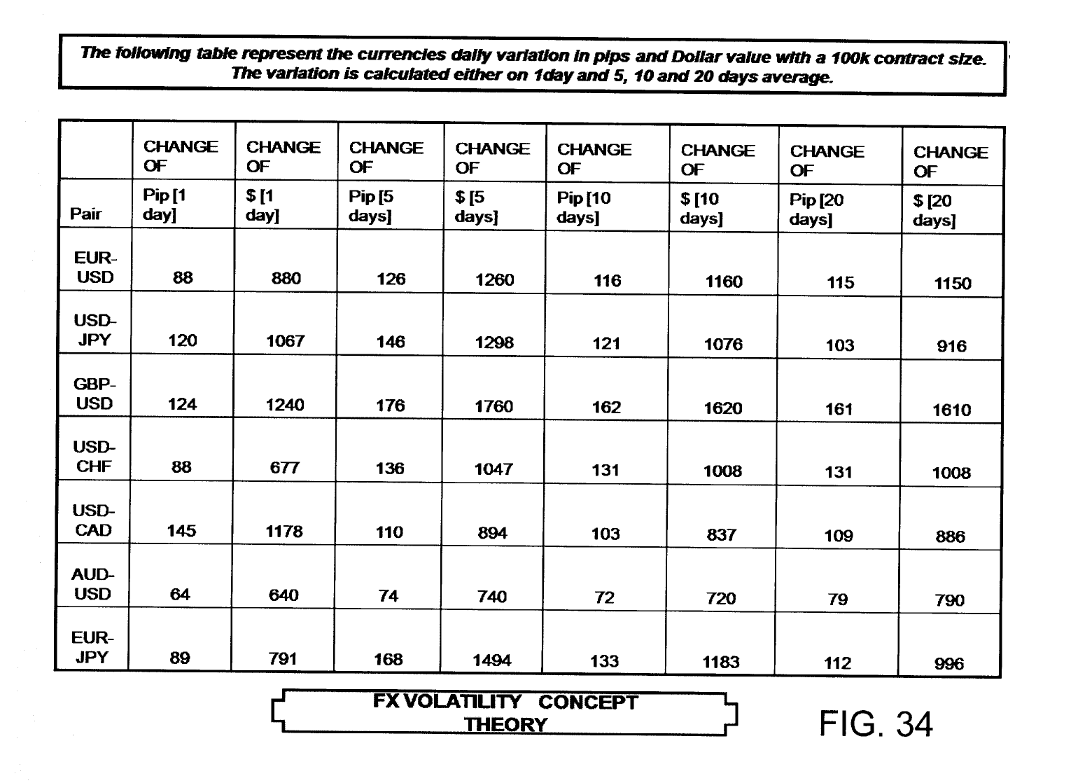

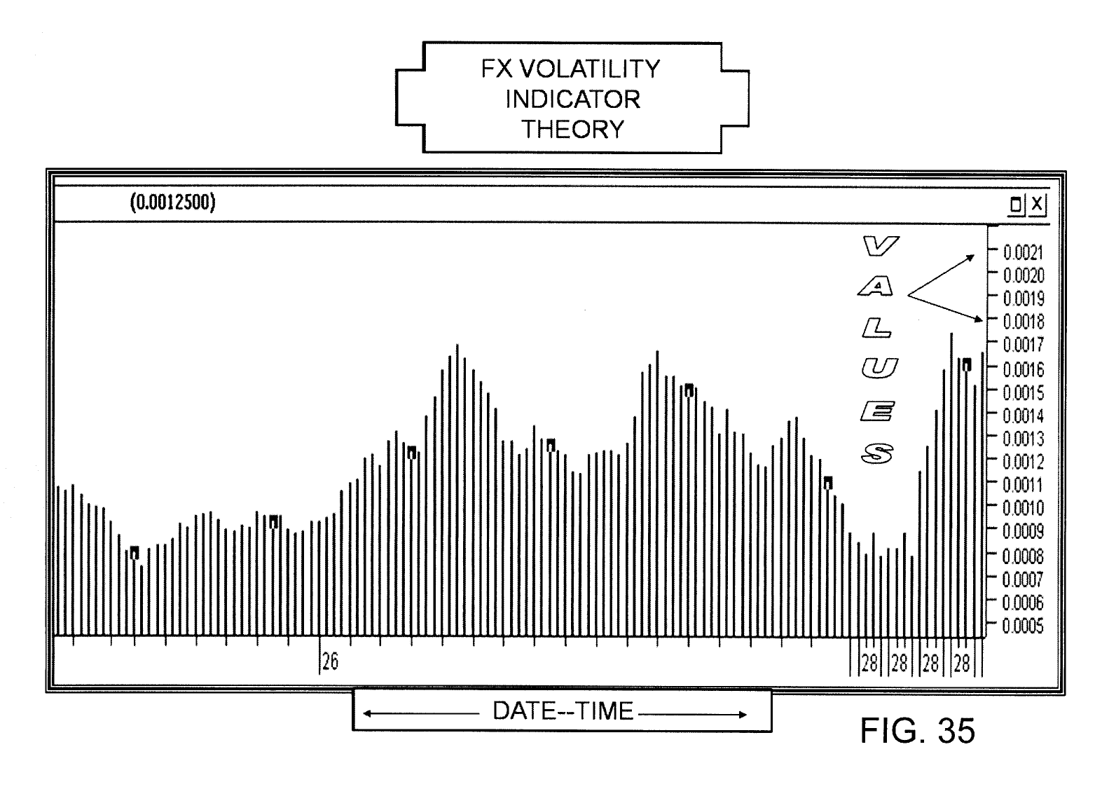

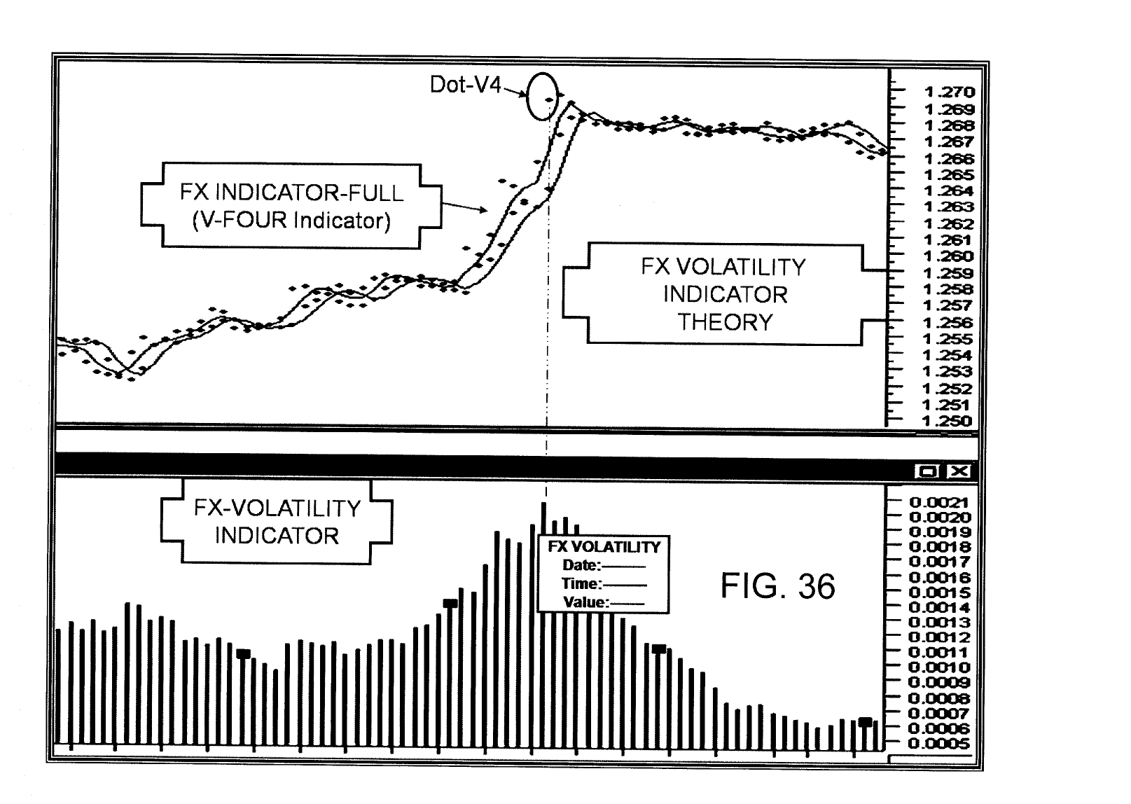

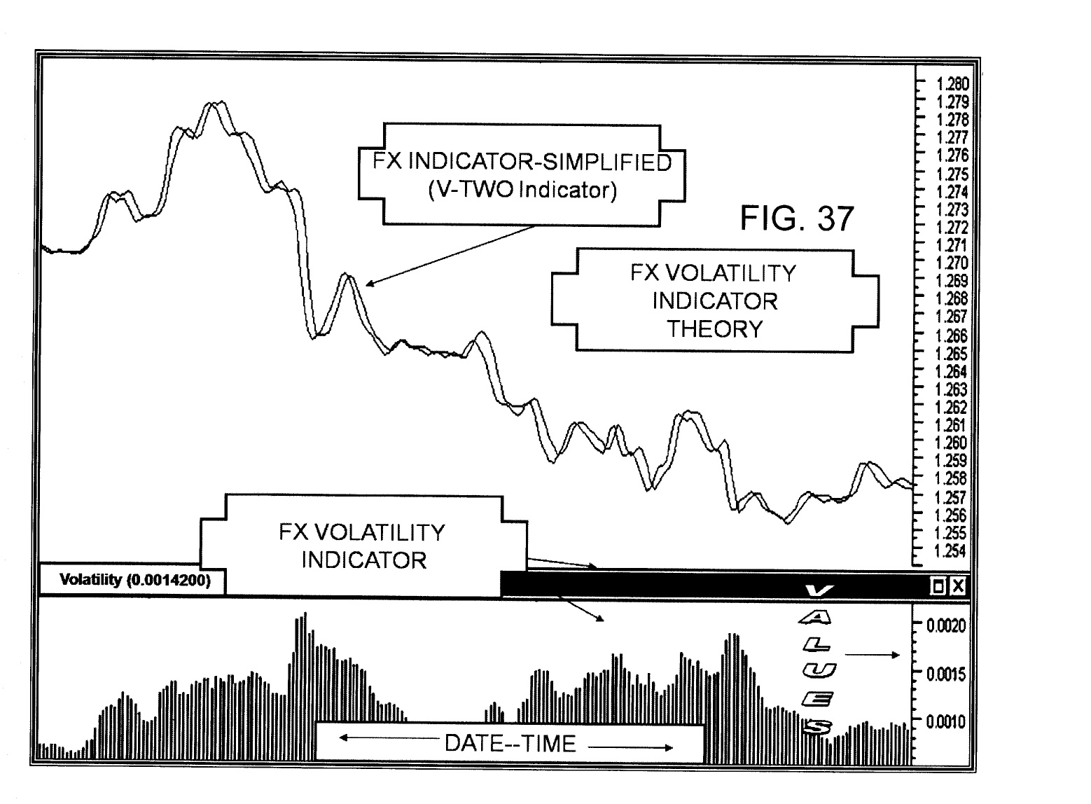

Preferably, an indicator for volatility in foreign exchange markets can be developed on the basis of the variation of pips in any timeframe by adding the variation of a pip values based on the variations in one timeframe, the last five timeframes, the last ten timeframes or the last twenty timeframes (at least herein embodying calculating at least one fifth time-relevant value representing volatility of such at least one tradable instrument for such at least one timeframe). Preferably, the change in dollar values based on the contract size for any timeframe can also be plotted (at least herein embodying wherein such at least one fifth time-relevant value is based on at least one range of prices paid for such at least one tradable instrument for such at least one timeframe; and at least herein embodying creating at least one fifth graphical representation of such at least one fifth time-relevant value for such at least one timeframe). The rate of change in values of the price in a particular timeframe is very important in calculating volatility in foreign exchange markets. Refer to FIG. 34, FIG. 35, FIG. 36, and FIG. 37 for examples of volatility.
Bullish to bearish wave formation examples:
   At cross: The value of volatility from the previous timeframe in most cases decreases.
   After cross: The value of volatility increases compared to the volatility at cross.
   Before cross: The value of volatility decreases compared to previous timeframe.
Bearish to bullish wave formation examples:
   At cross: The value of volatility from the previous timeframe in most cases increases.
   After cross: The value of volatility decreases compared to the volatility at cross in most cases.
   Before cross: The value of volatility decreases compared to previous timeframe.

Preferably, the volatility value has a relationship with the values of V1, V2, V3 and V4. In other words both FX indicators, V-TWO and V-FOUR, have a relationship with values of all four. Knowing this relationship preferably permits predictions to be made for upcoming bullish or bearish waves, consolidation, slowing of trends or indecision times in the market.

### Day Trader Heaven, Swing Trader Heaven, Short Term Trader Heaven or Long Term Trader Heaven Theory (Also Called FX all Target)

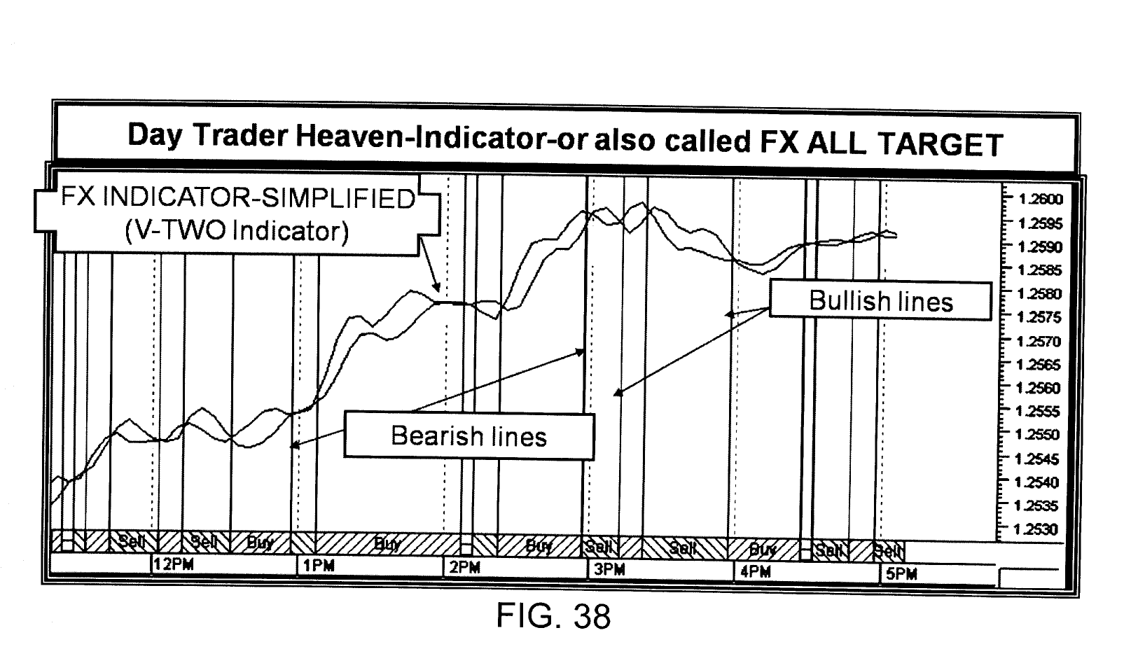

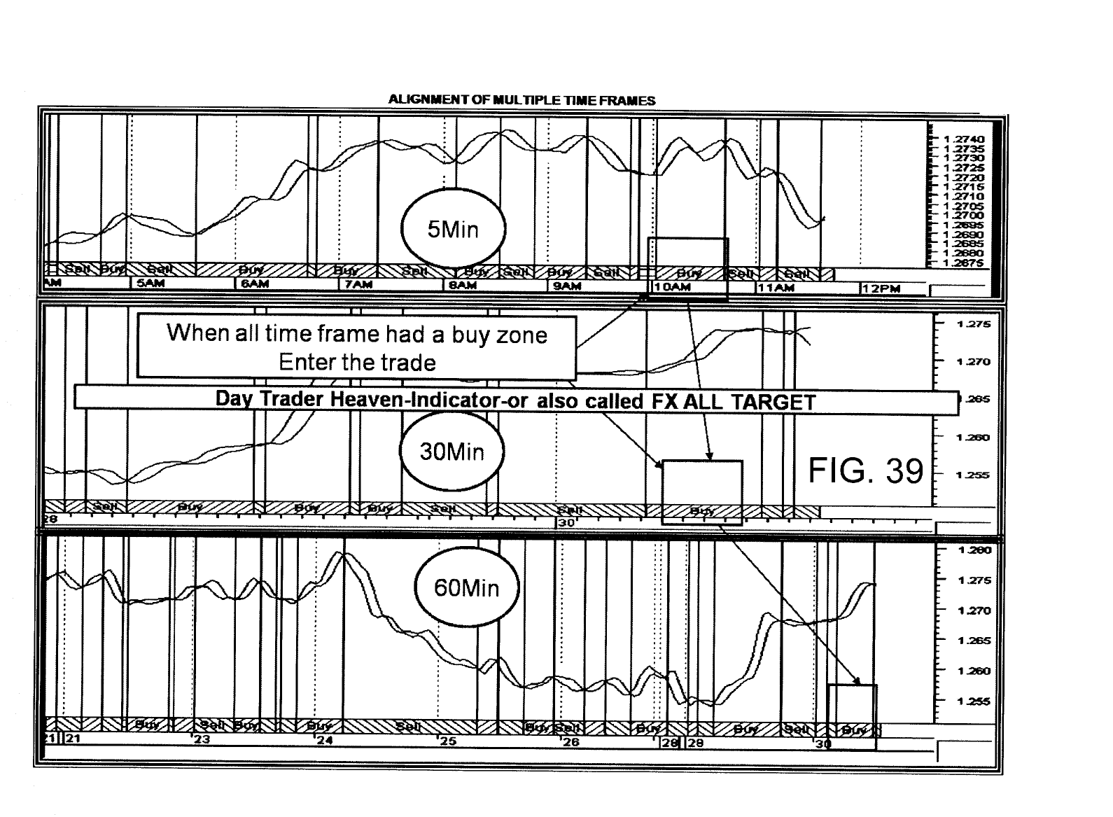

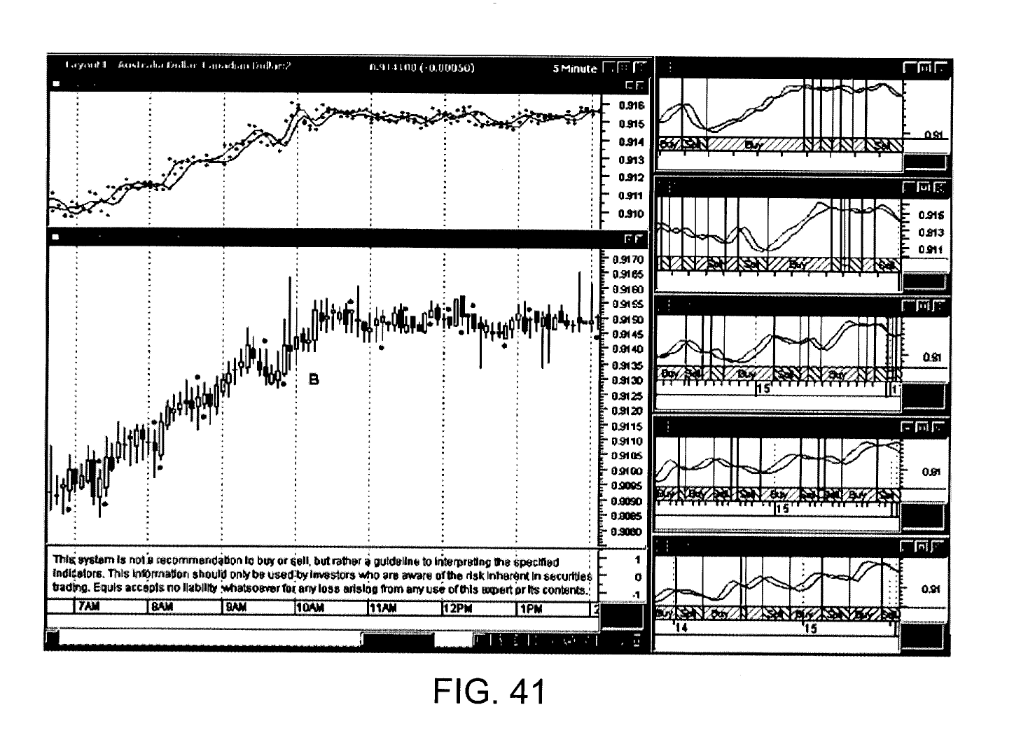

In order to take advantage of short term alignments of bullish and bearish waves, using the V-TWO Indicator (FX Indicator Simplified), vertical lines may preferably be drawn through bullish crosses and bearish crosses. When the Green line, V2, is above the Red line, V1, after the cross, it is preferably interpreted as bullish bias or bullish wave signal and shown as a green vertical line. If, after the cross, the Red line, V1, is above Green line, V2, it is preferably considered a bearish bias or bearish wave signal and shown as a red vertical line. A trader can avoid the smaller waves and therefore avoid very short entries then plot them as no event or not tag them as buy or sell zone. Preferably, a trader may watch for alignment on a five minute to 60 minute chart and then enter a trade only when all timeframes either have a buy or sell zone. This can help scalping or day trading activities. Preferably, this concept can be used for any timeframe combination and also used for swing trades, short term trades and long term trades depending upon the timeframe selected. Also, preferably using expert commentary one can get live commentary about particular timeframe wave type and the location of current bar from previous cross. Refer to FIG. 38, FIG. 39 and FIG. 41.

### Critical Path Method for Alignment

Preferably, a Critical Path (agreement of multiple alignment timeframes) can be created using multiple buy and sell signals either in five minute or other timeframes at an alignment. The resulting Critical Path preferably can be used to eliminate false or short term signals and identify strong signals.

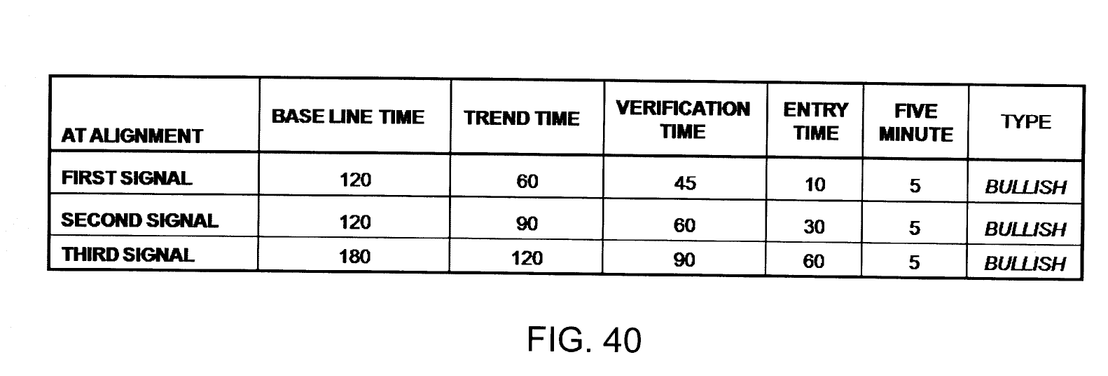

Preferably, an algorithm can be created using the history provided by expert commentary at the alignment to recognize the real or false bullish or bearish waves. Preferably, the Critical Path algorithm will evaluate each individual timeframe set and for some number of sets in the past up to the present to determine the number of times the longer-time sets agreed or disagreed with the bearish to bullish signal set alignment. If the preponderance of the “longer” alignments were in the same direction, for instance from bearish to bullish, the trader will preferably be notified of the confirmation of the trend as shown in FIG. 40 (at least herein embodying such at least one plurality of timeframes comprises at least one part of multiple sets of such pluralities (of such different discrete periods of time) wherein each such set comprises a different combination of such discrete periods from any other such set; at least herein embodying at least one computer processor adapted for determining which of such sets are bullish and which of such sets are bearish; at least herein embodying at least one computer processor adapted for notifying such at least one trader of each of such sets which are bullish and each of such sets which are bearish; and at least herein embodying wherein such notifying may be used to assist such decision making by such least one trader).

Preferably, the position of New Crosses (either Natural or Synthetic) at alignment of multiple timeframes can be further used for development of Critical Path for real bullish or bearish waves, a sideways market or an oscillating market. A clear bull and bear fight can preferably be demonstrated by using flow of bullish and bearish waves at the critical alignments. Refer to FIG. 40 for an example of commentary for three consecutive alignments. Preferably, the following logic can be tracked:
Verify that this was a first bullish cross (first signal) and did not take the entry.
On second signal it observed that entry time increases from 10 to 30 and trend time increased from 60 to 90.
The verification time increased from 45 to 60.
This is evidence that the small bullish waves are building up stronger bigger waves and a indicator to enter on next available signal is produced.
In the same way, after entering the third signal, if it produces a higher base line, it is further evidence for a stronger trend. The same logic applies for bearish waves.
During a sideways market, the signals are tracked to give the trader a first bullish signal and then bearish signals with the timeframe built up going back and forth on smaller waves to bigger waves, to generate a warning sign of the market being in oscillation or going sideways. When coming out of such a condition, the strength of the bullish or bearish waves are preferably tracked to determine which is generating stronger waves, and selects the one which is strongest to create a Critical Path for trading.
Additional types of Critical Paths can be developed using the same logic.

### Concept to Reality

Preferably, the following are the basic indicators that use the algorithms for V1, V2, V3, and V4:
V-FOUR FX INDICATOR—Full Version uses V1, V2, V3, and V4
V-TWO FX INDICATOR—Simplified version uses only V1 and V2

Preferably, the above indicators can be used to create the following timeframe indicators:
FX-5 MINUTE BUY SIGNAL/FX-5 MINUTE SELL SIGNAL
FX-10 MINUTE BUY SIGNAL/FX-10 MINUTE SELL SIGNAL
FX-15 MINUTE BUY SIGNAL/FX 15 MIN SELL SIGNAL
FX-30 MIN BUY SIGNAL/FX 30 MIN SELL SIGNAL
FX-45 MIN BUY SIGNAL/FX-45 MIN SELL SIGNAL
FX-60 MIN BUY SIGNAL/FX-60 MIN SELL SIGNAL
FX-DAILY BUY SIGNAL/FX-DAILY SELL SIGNAL
FX-WEEKLY BUY SIGNAL/FX-WEEKLY SELL SIGNAL
FX MONTHLY BUY SIGNAL/FX-MONTHLY SELL SIGNAL
FX QUATERLY BUY SIGNAL/FX-QUATERLY SELL SIGNAL
FX YEARLY BUY SIGNAL/FX YEARLY SELL SIGNAL

Note: One can apply any custom timeframe from a tick (transaction) to any multiple of minutes.

Preferably, following are independent indicators which work in conjunction with above indicators:
FX-VOLATILITY INDICATOR
FX-DAILY PIVOT FORMULA
FX-60 MIN PIVOT FORMULA
FX-ANY TIMEFRAME PIVOT FORMULA
FX-REAL TIME SWING PIVOT FOR ANY TIMEFRAME

Preferably, additional indicators that can be developed:
Indicator showing all golden bars (Bullish) and Turquoise bars (bearish) in all timeframes
Indicator which can tag first buy and first sell signal in all timeframes.
Indicator showing possible reversal in trend, forecasting slower or faster trend, upcoming consolidation or break out with a possible direction using the V-TWO FX
Indicator and V-FOUR FX Indicator.
V1-V2 Indicator
V1/V2—Simple ratio (V-TWO) Indicator
Delta V-Rate of Change (V1 and V2)
Close-V1, Close-V2
Pivot-V1, Pivot-V2
V3-V4 Indicator
V3/V4—Full ratio (V-FOUR) Indicator
Delta V-Rate of Change (V2, and V3)
Close-V3 Indicator, Close-V4 Indicator
Pivot-V3, Pivot-V4 Indicator
V1/V3—Bear strength Indicator
V2/V4—Bull strength Ratio

Preferably, alignments can be developed using Natural Crosses and Synthetic Crosses, the following alignments can be used for entry or exit signals:
Alignment of Golden Bars (Bearish) and Turquoise Bars (Bullish) in multiple timeframes using expert commentary. These alignments will preferably produce possible trend reversal points, upcoming trend changes, and possible upcoming strong or weaker consolidations, and forecasting retracements.
Alignment of multiple timeframes (two or more) to have better entry and exit for any Market Vehicle.
Alignment created in a first phase of Commentary window for multiple timeframes can preferably be used to create a critical path to track down the flow of bullish or bearish waves and distinguish good waves from false waves, track embedded trends, distinguish internal buying or selling, may be called Guided Wave Theory.
Alignment between V1, V2, V3, V4 using various conditions preferably can be used to forecast possible reversals, upcoming trend changes, consolidations, critical entry and exit points, multiple confirmations for entry and exit.
Alignment of real time swing bars with traditional FX daily or other timeframe pivots, and with buy or sell signal alignment using V-FOUR Indicator.

Possible Templates

Preferably, the following display templates can be created for the ease of using V-TWO FX Indicator, V-FOUR FX Indicator and many other creations.
All Target Short Term template—Using 5 minute, 10 minute, 15 minute, 30 minute, 45, minute and 60 minute timeframe using either V2 OR V4 Indicator (five minute) for an entry and exit signal. This preferably uses buy and sell zones and their alignment. This is called either a Day Trader Heaven or FX Indicator. The preferred purpose of creating this layout is to do very short term trades and use it as an entry for a longer term trades, including swing trading. For swing traders it will be named Swing Trader Heaven Indicator, Short Term Heaven Indicator, etc.
Golden Bar template—This template may be used in conjunction with traditional bar or candle charts with V-FOUR Indicator.
Volatility template—Use this template as an independent indicator in conjunction with V-FOUR OR V-TWO Indicators.
Market Summary template—Provides an overview of all 17 major currency pairs, using FX Long Term Direction template, a FX Short Term Direction template and a FX Signal (Master) template.
   FX Long Term Direction template preferably includes:
      Commentary—Preferably, the main 17 currency pairs are listed in columns. The current trend of the long term interval is displayed with either green or red arrows indicating direction. The long term intervals are: 480, 540, 600, 660, 720, Daily, Weekly, and Monthly (option: Quarterly, Yearly)
      Highlights—Preferably, the price plot is highlighted either green (bullish) or red (bearish) depending on the trend.
   FX Short Term Direction template preferably includes:
      Commentary—Preferably, the main 17 currency pairs are listed in columns. The current trend of the short term interval is displayed with either green or red arrows indicating direction. The short term intervals are: 60, 90, 120, 180, 240, 300, 360, 420 minutes.
      Highlights—Preferably, the price plot is highlighted either green (bullish) or red (bearish) depending on the trend.
   FX Signal (Master) template preferably includes:
      Commentary—Preferably, will display a grid of 17 currency pairs by five columns. Column Headings are: Base line, Trend time, Verification and Entry. Grid will identify each time interval and the signal that is given. Where no trades exist for a pair this will be indicated by and line of text N/A. Preferably, it will suggest the chart of the pair with the entry timeframe be monitored if they want to watch the trade develop.
      Highlights—Preferably, the price plot is highlighted either green (bullish) or red (bearish) depending on the trend.
      Symbols—Preferably, the following symbols will be plotted when there is a signal: Bullish Bounce, Bearish Bounce, Bullish Cross, and Bearish Cross.
      Alerts—Preferably, the following Alerts will be triggered when there is a signal: Bullish Bounce, Bearish Bounce, Bullish Cross, and Bearish Cross. Preferably, the trader can pick and choose any combination of four on an individual basis.

### Other Layouts

FX Layout: A layout of Daily, Weekly, 60 min and 15 min charts with the FX Indicator on all. The FX Long Term Direction commentary will preferably be included on the Daily and Weekly, the FX Short Term Direction Commentary will preferably be on the 60 minute and the FX Signal Expert will preferably be on the 15 minute And other timeframes on latter stages and with five minute entries.

Day Trader Heaven: A layout can be created for 5 min, 10 min, 15 min, 30 min, 45 min and 60 minute with FX Trader Indicator and commentary preferably can be generated for each timeframe. Preferably, putting them together as a group of charts, a buy or sell signal can be generated the similar way as described above when alignment of all New Crosses occurs in all four or fix timeframes.

FX Exploration: Filters for Crosses and Bounces and will display in a Results Report those pairs that either had a Cross or Bounce. Displays in the Results Reports:
Col A-Crosses (1 or 0)
Col B-Bounces (1 or 0)
Col C-Entry time (interval)
Col D-Verification time (interval)
Col E-Trend Time (interval)
Col F-Base line (interval)

### Automation

Preferably, a buy or sell order can be sent to trading robots for trade execution in real time, based on the first buy and sell signals shown on five minute charts generated with a combination of FX TRADE with green or red candles and with buy and sell signs at the confirmation of alignment of multiple crosses. Additionally, preferably any signals generated after first buy or sell signals can be also used and traded automatically. Preferably, with trading robots a trader can use any signal generated from any indicator, from any theory here, from any concept here, mix them, match them and have robot give the trader some rest.

### Ticks Versus Timeframes

One common time basis for reporting trading data (open price, close price, high price, low price) is five minutes, however the same data may be reported on the basis of five transactions or five ticks. According to a preferred embodiment of the present invention, all algorithms and calculations can be completed on the basis of time, such as minutes, or on the basis of transactions completed, commonly referred to as ticks. Preferably, the trader may specify which reporting basis is to be used.

### Using Traditional Indicators

Preferably, there is no requirement for using traditional indicators such as RSI, Stochastic, etc. However, a volatility Indicator (FX Traders Volatility) based on price swings during any timeframe may be created.

### Training Programs Content, Preparation and Delivery

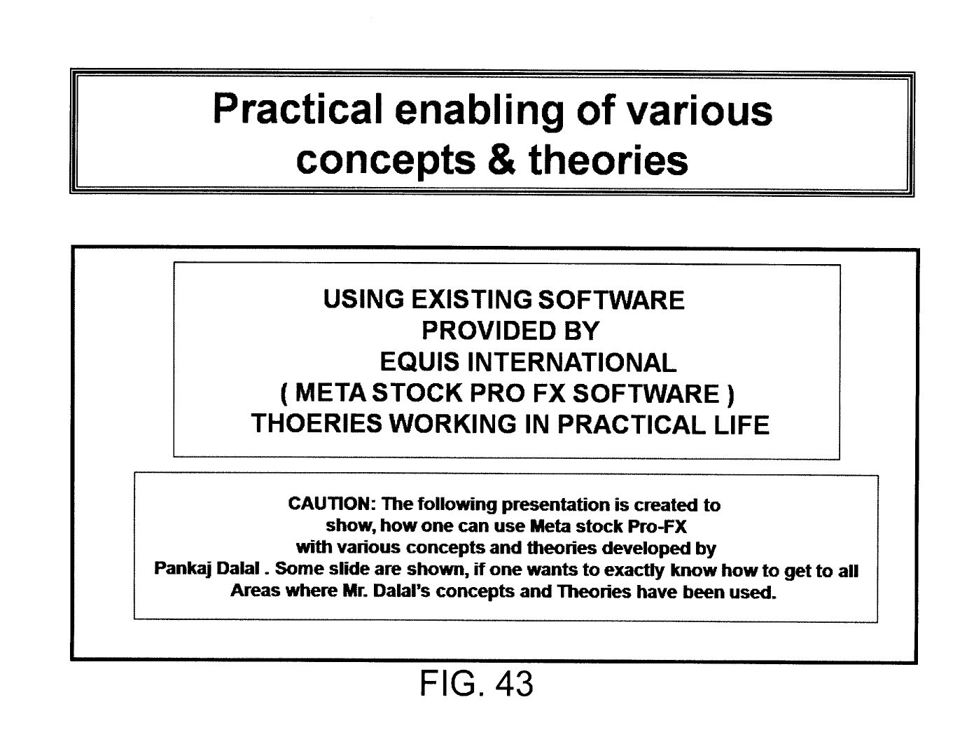

According to a preferred embodiment of the present invention, the preferred objective of the trader training curriculum is to provide traders the tools, understanding and skills to make the best possible trading decisions as suggested by an example training program introduction slide as shown in FIG. 43. Preferably, the trader training program comprises presentation of example analysis screens, discussion of the underlying computations for each key indicator (for example V-FOUR), presentation of the nature of the signals produced by each key indicator and presentation of the significance of the signals and what trading decisions the signals suggest and why. Preferably, the scope of training comprises the concepts, methods and the signals embodied in the preferred computer real-time analysis system for the following concepts:
V-FOUR Indicators,
V-TWO Indicators,
Alignment and Commentary,
New Crosses and Synthetic Crosses,
Dot Theory,
Reversal Bar Theory,
Golden Bar Theory,
Real Time Swing Bar Theory,
FX Pivot Theory,
Volatility Theory,
Day Trader Heaven,
Swing Trader Heaven,
Short Term Trader Heaven,
Long Term Trader Heaven Theory (also called FX All Target), and
Critical Path Method for Alignment.

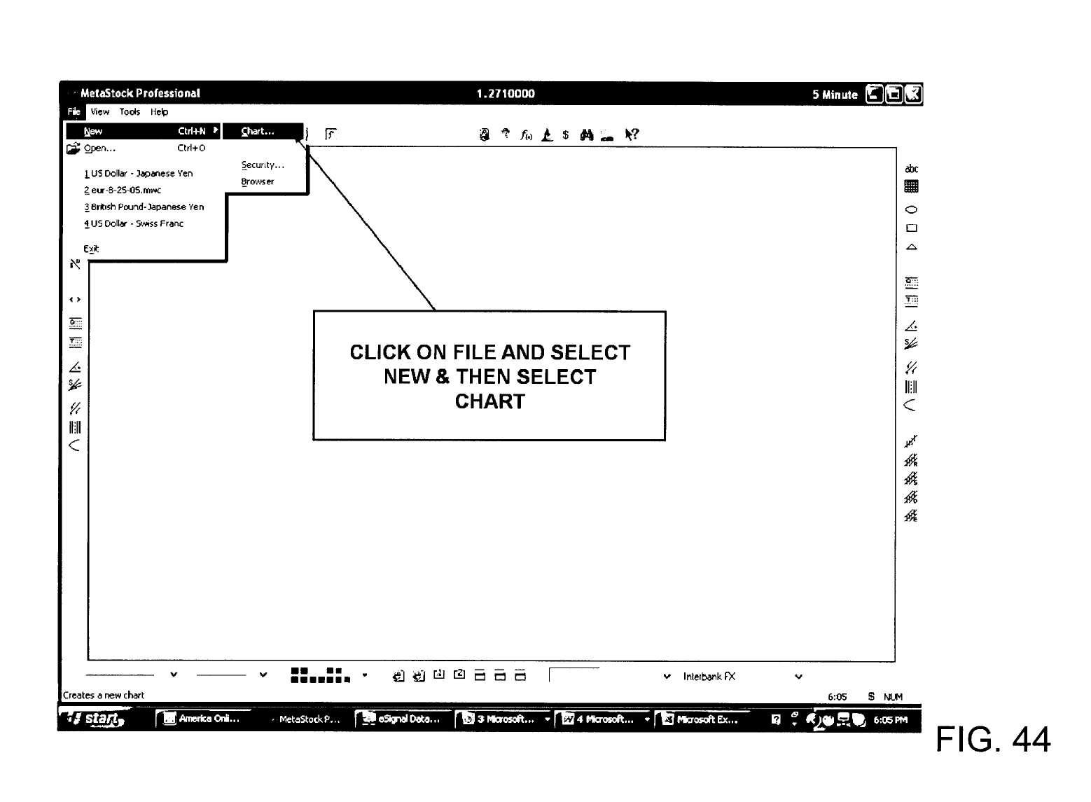

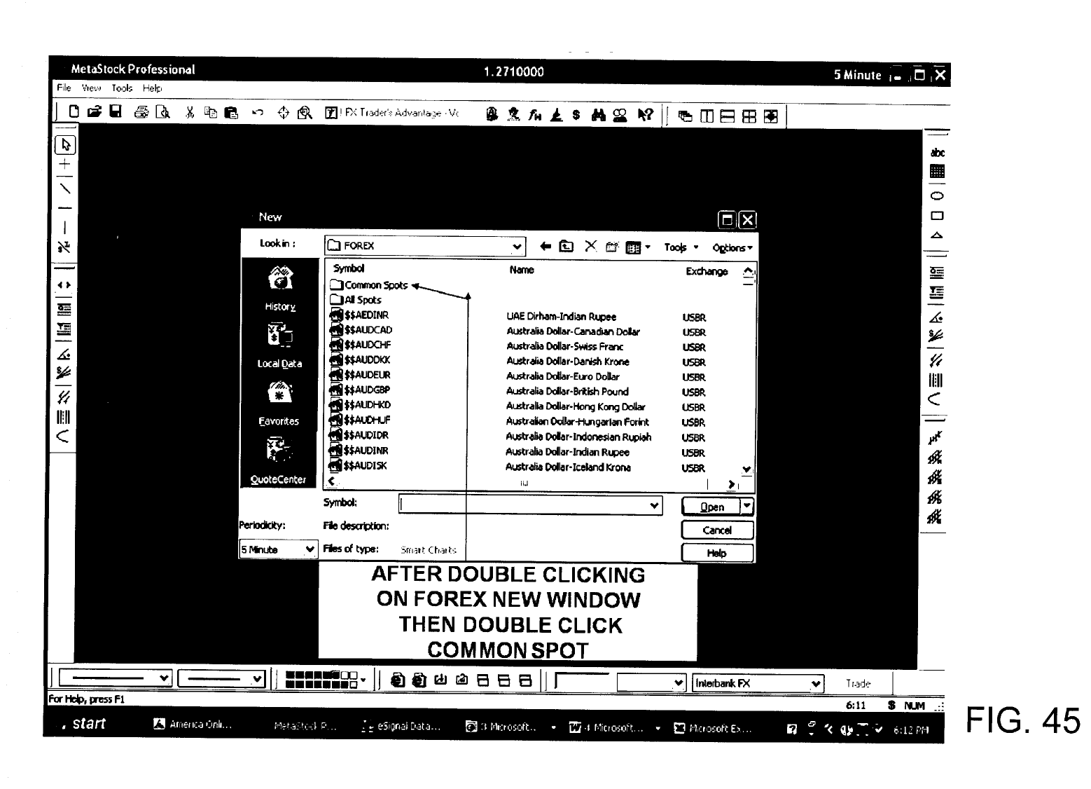

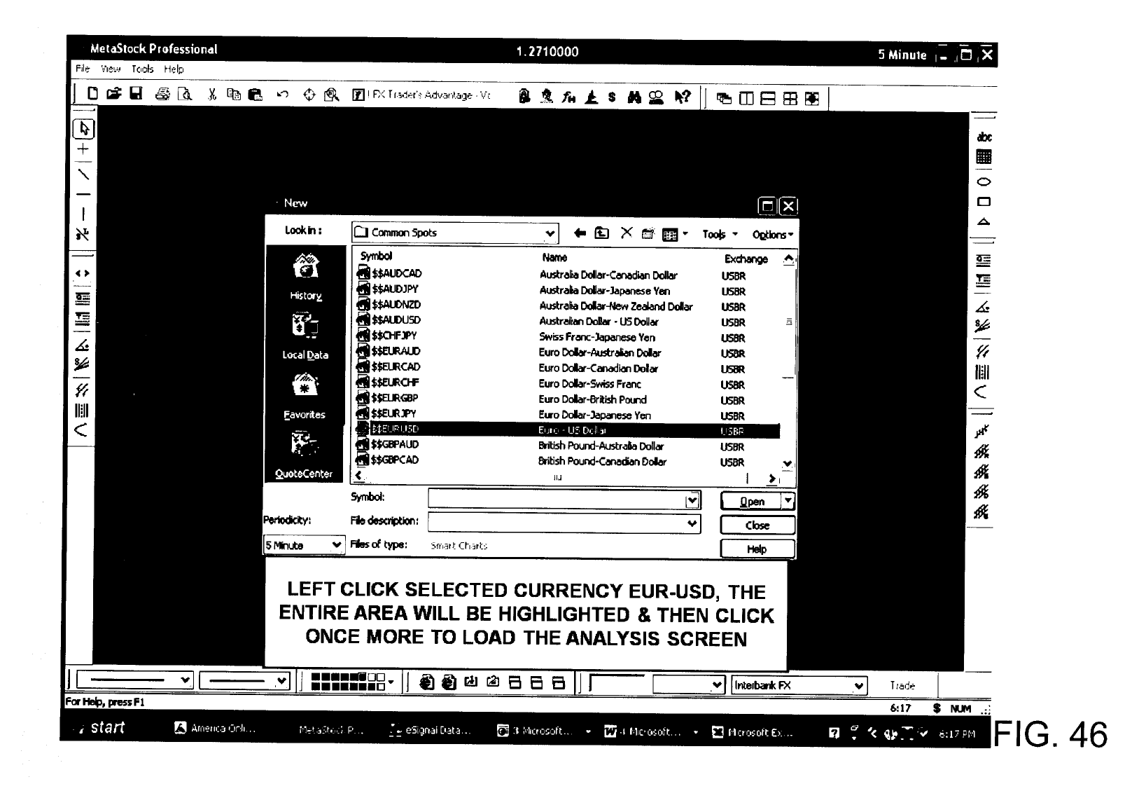

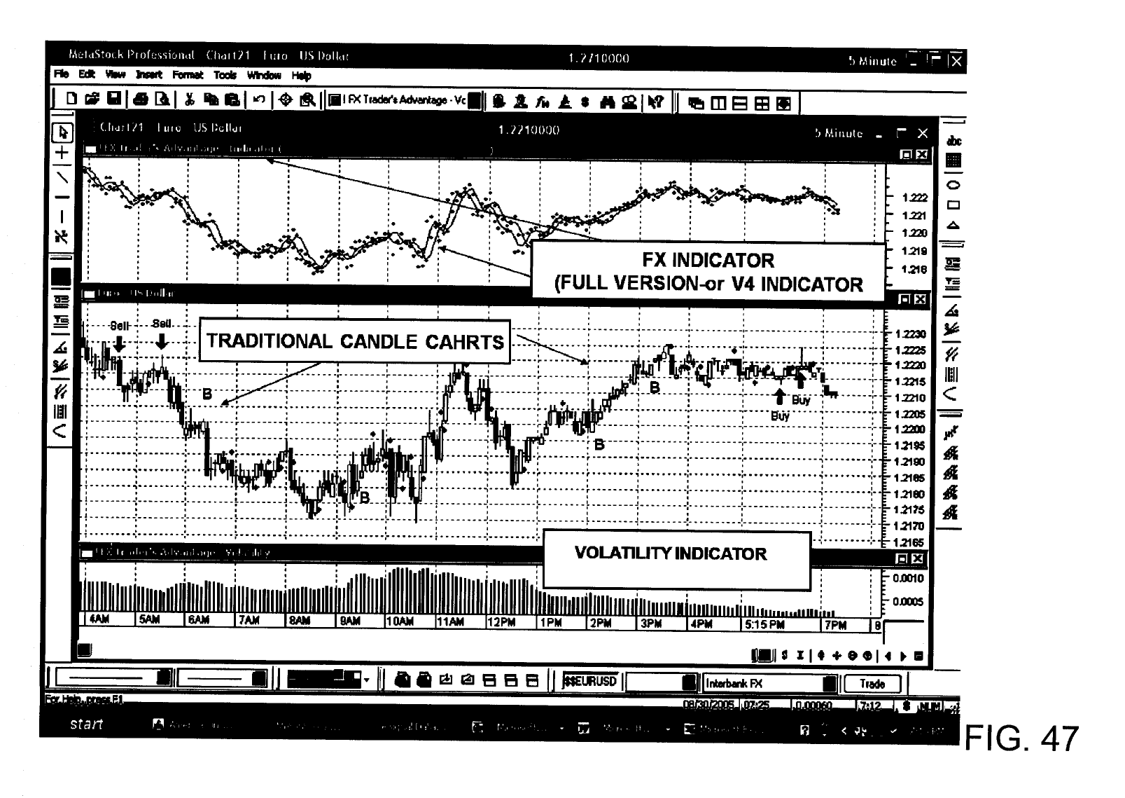

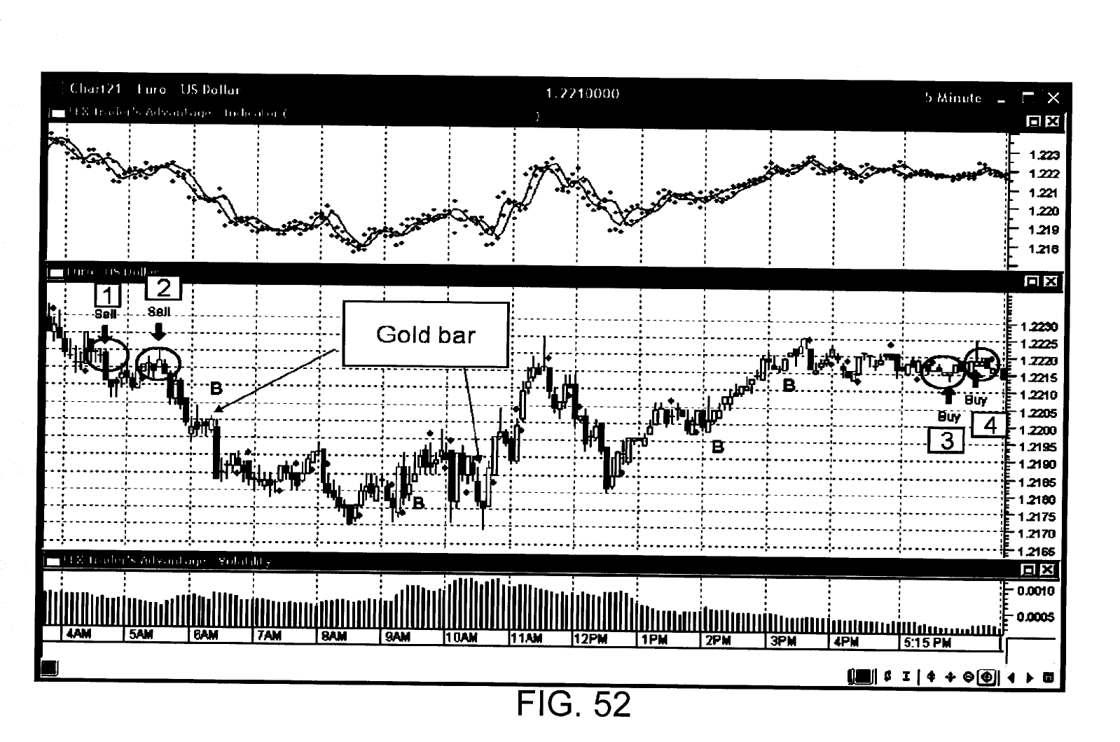

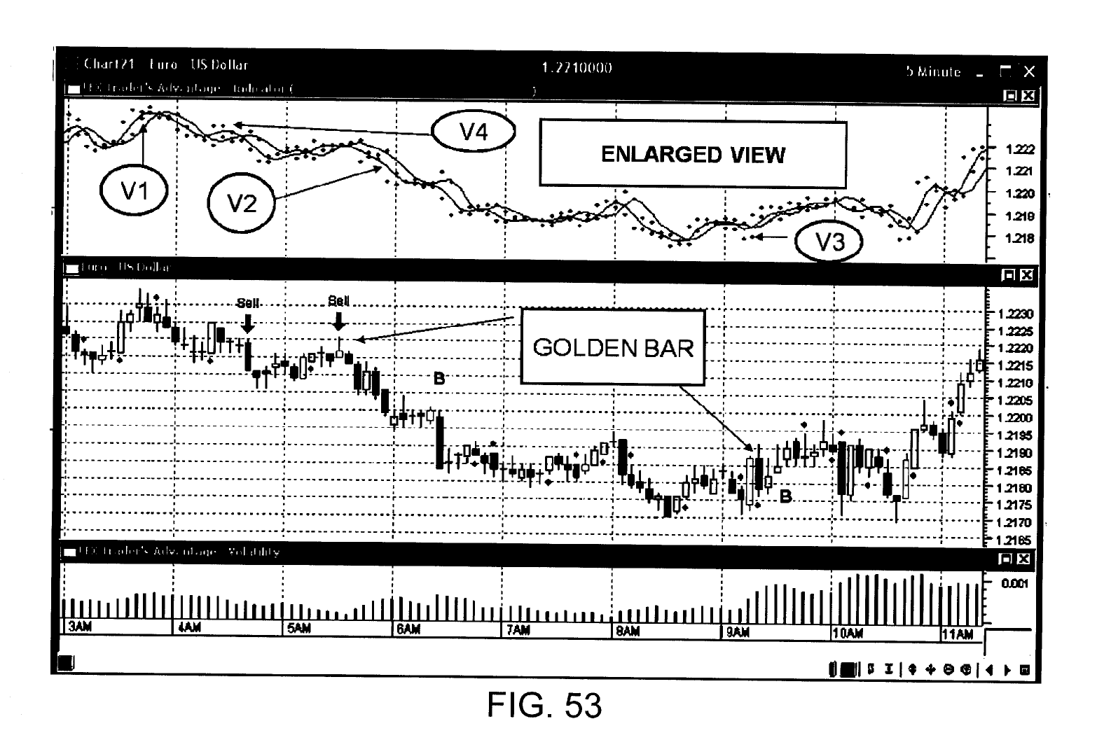

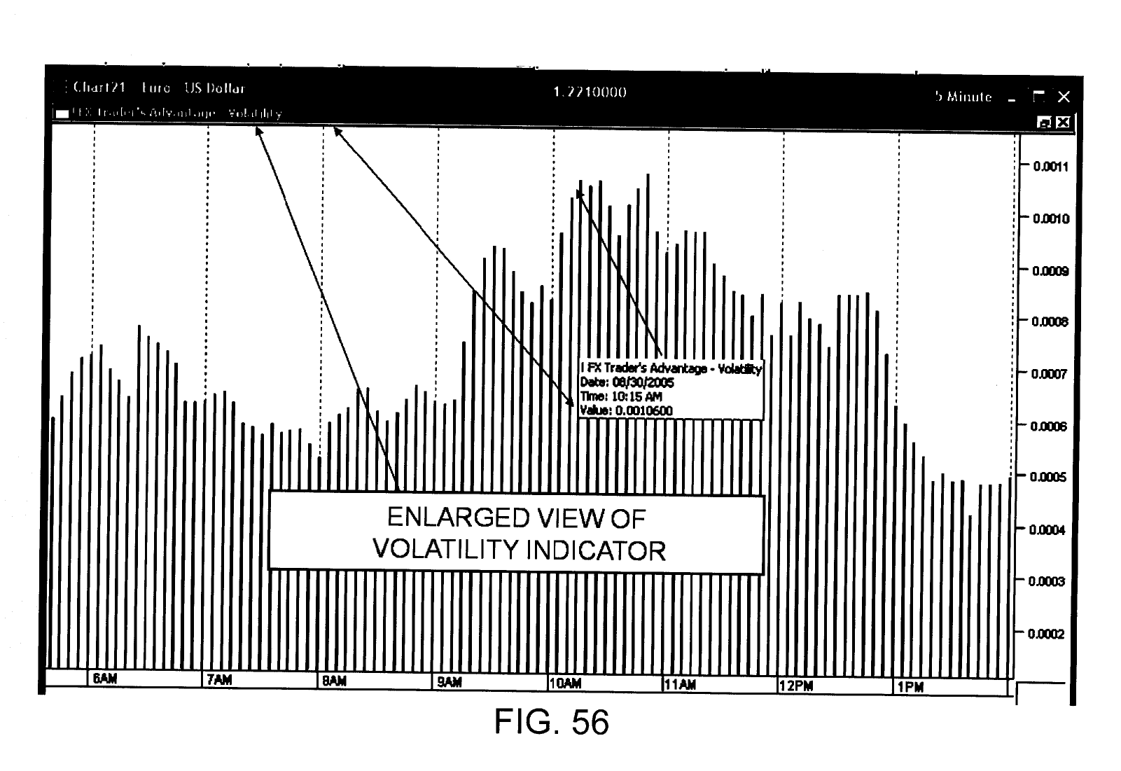

Preferably, training will include instruction on initial set up of the desired analysis screens and indicators. Selected example steps of the method for loading an analysis screen are provided in FIG. 44, FIG. 45, and FIG. 46 culminating in presentation of an analysis screen as shown in FIG. 47, FIG. 52, FIG. 53, and FIG. 56. Further, as shown in FIG. 47, preferably V_FOUR indicators are provided in the upper portion of the screen with a candle chart in the middle section and a volatility indicator chart at the bottom (at least herein embodying providing at least one first teaching aid comprising at least one first explanatory chart associated with at least one example of such at least one analysis screen; and at least herein embodying wherein such at least one analysis screen comprises at least one indicator signal computed by said computer real-time analysis system). As shown in FIG. 56 an analysis screen may be adjusted to present only one indicator, in this case volatility. Upon reading the teachings of this specification, those with ordinary skill in the art will now understand that, under appropriate circumstances, considering such issues as training requirements, user preferences, available data, etc., other combinations of indicators, such as FX Pivot Theory with candle charts and V-TWO, etc., may suffice. Preferably, traders are provided instruction on the methods of calculation associated with each of the indicators. Refer to FIG. 4, FIG. 5, FIG. 6, FIG. 7 and FIG. 8 for examples of presentation of calculations used for various indicators (at least herein embodying providing at least one second teaching aid comprising at least one second explanatory chart relating to at least one method of computation of such at least one indicator signal).

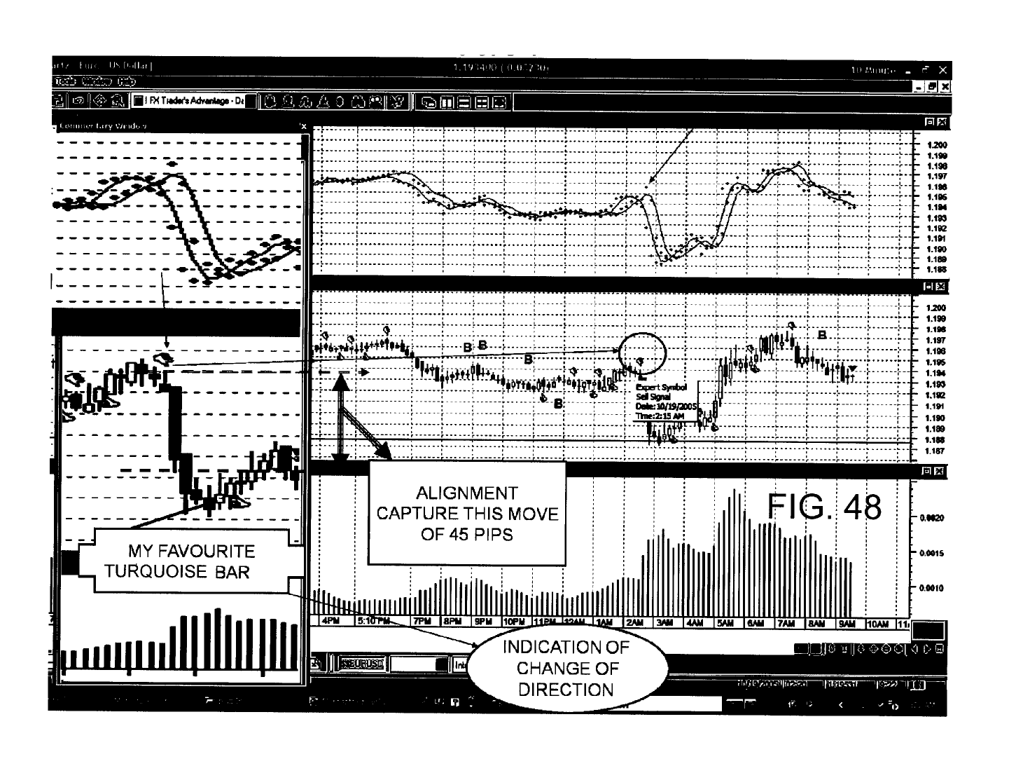

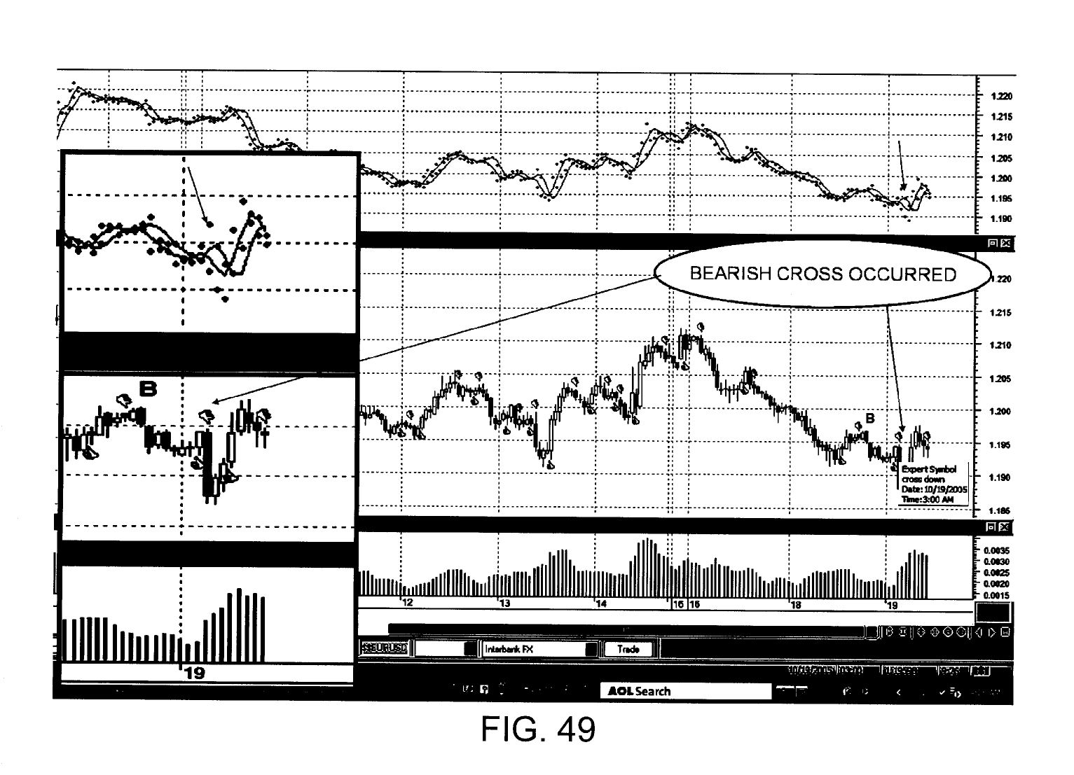

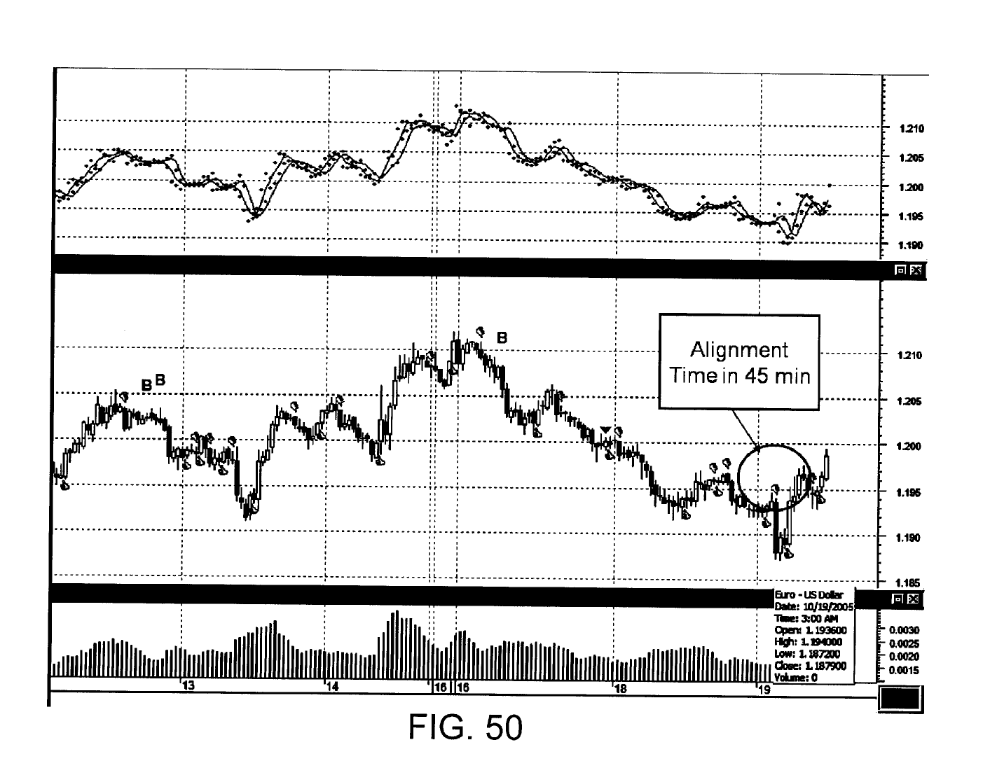

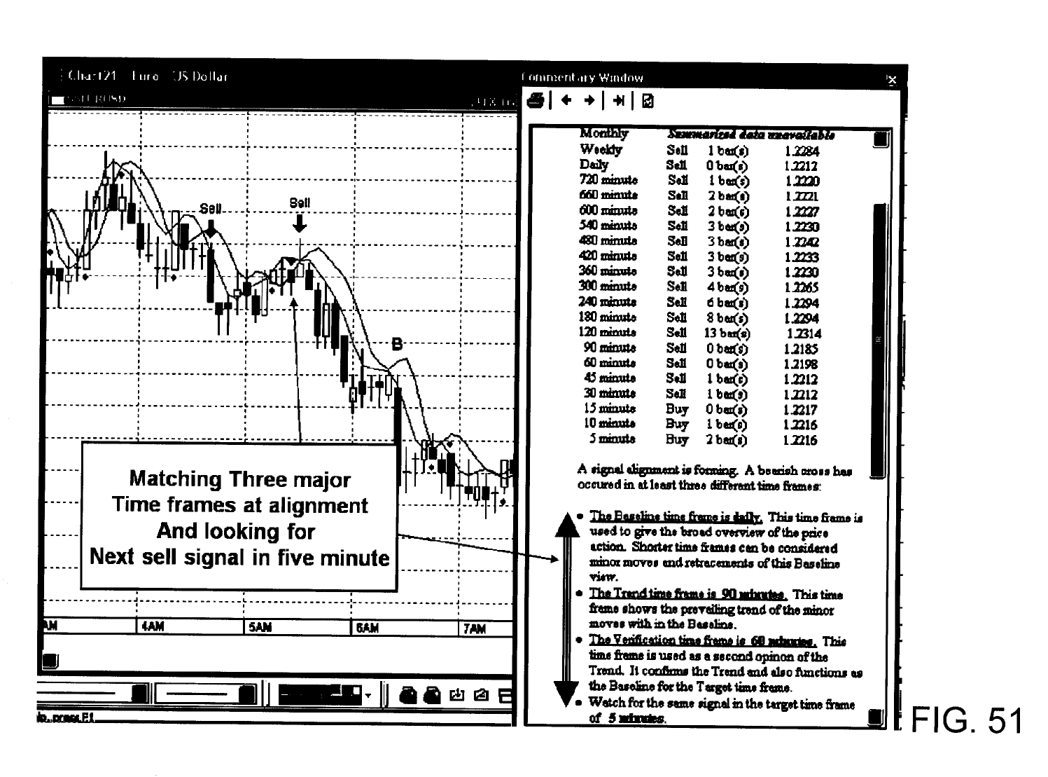

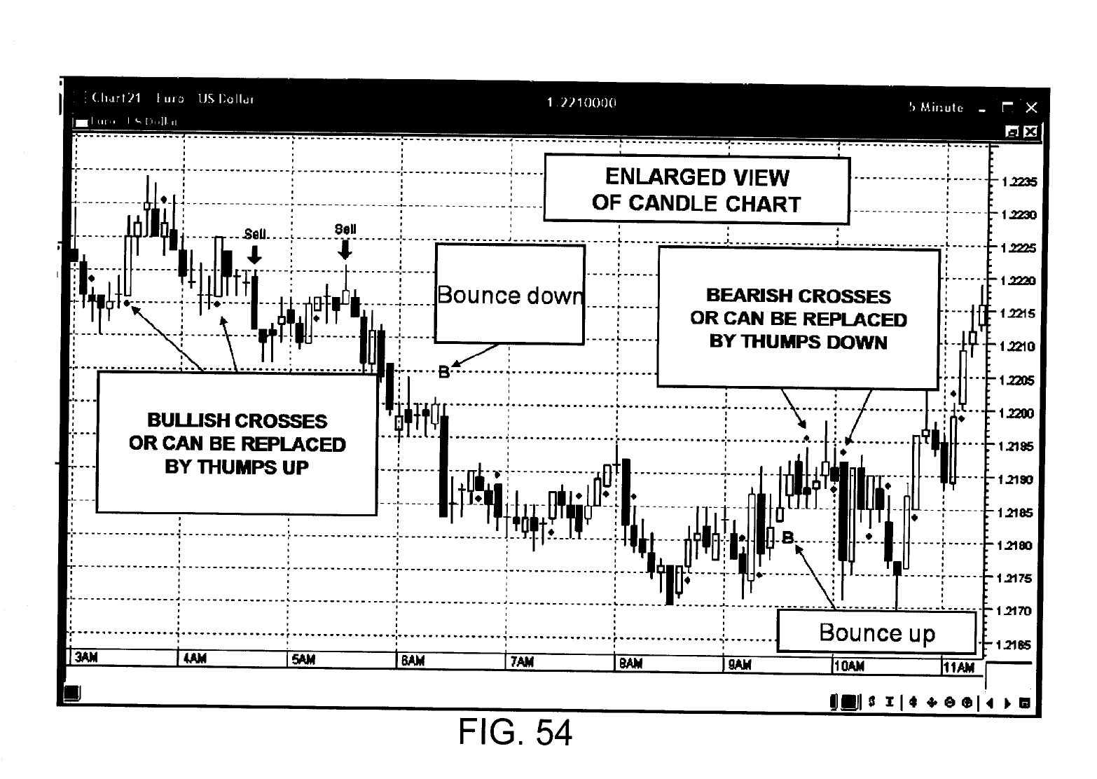

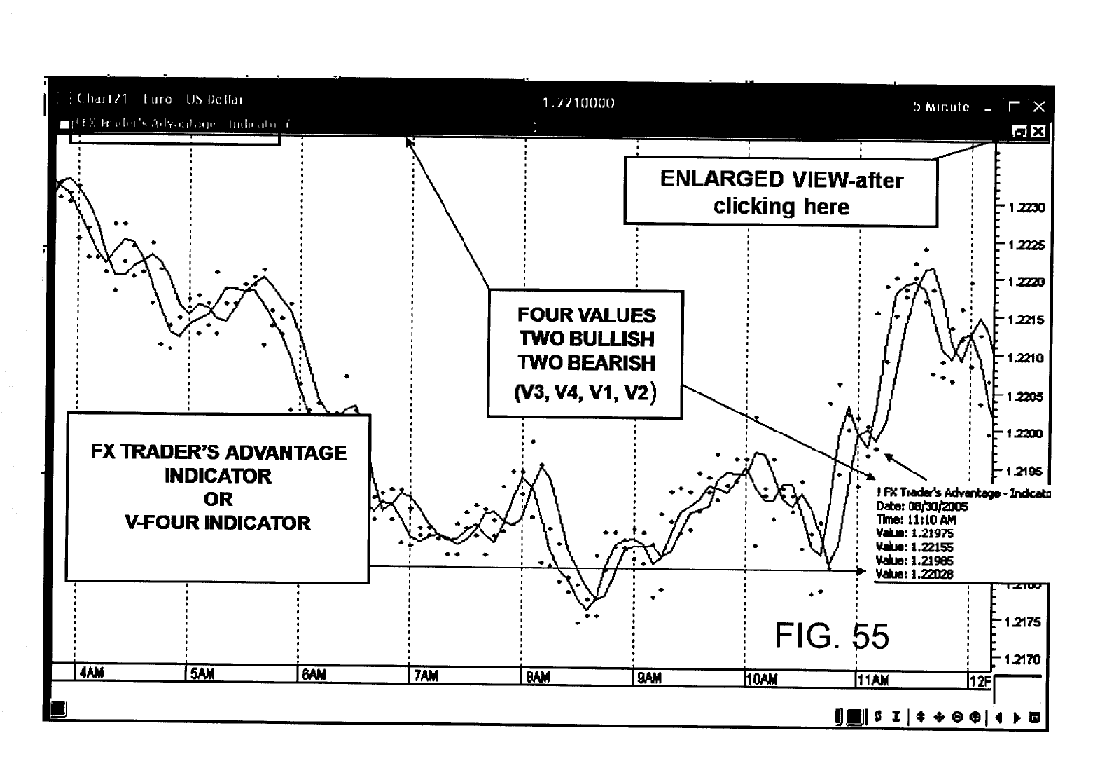

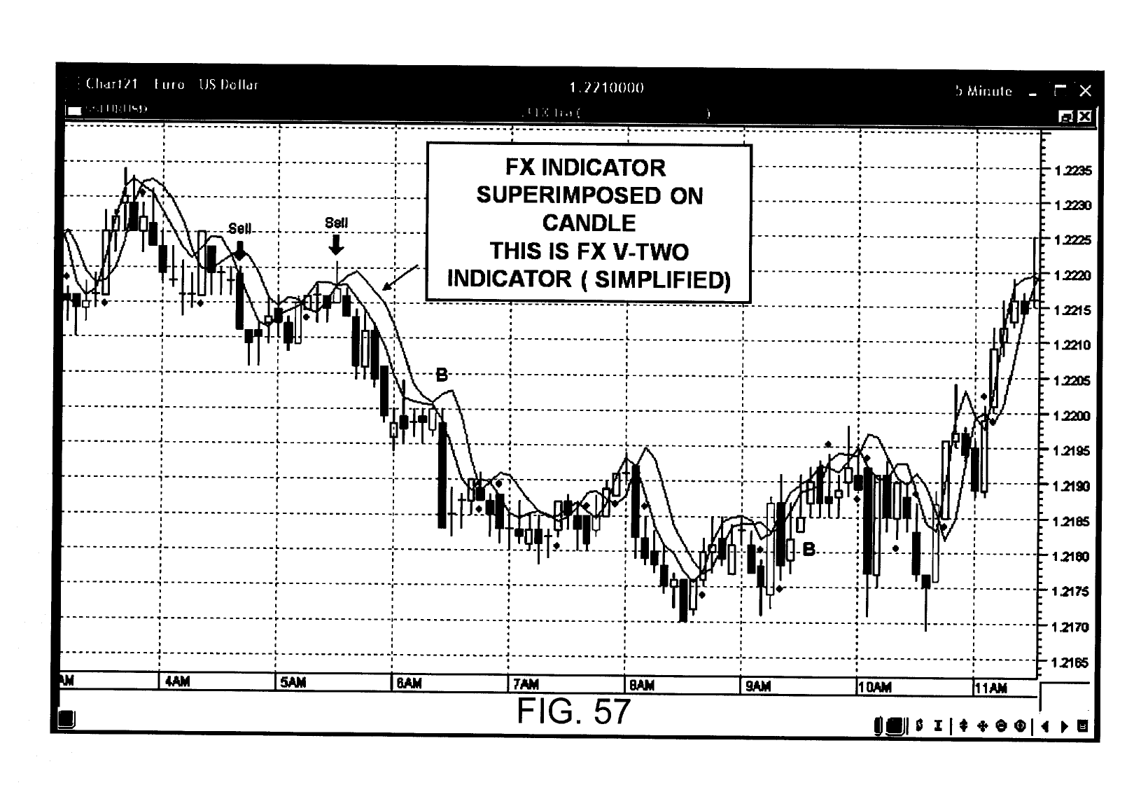

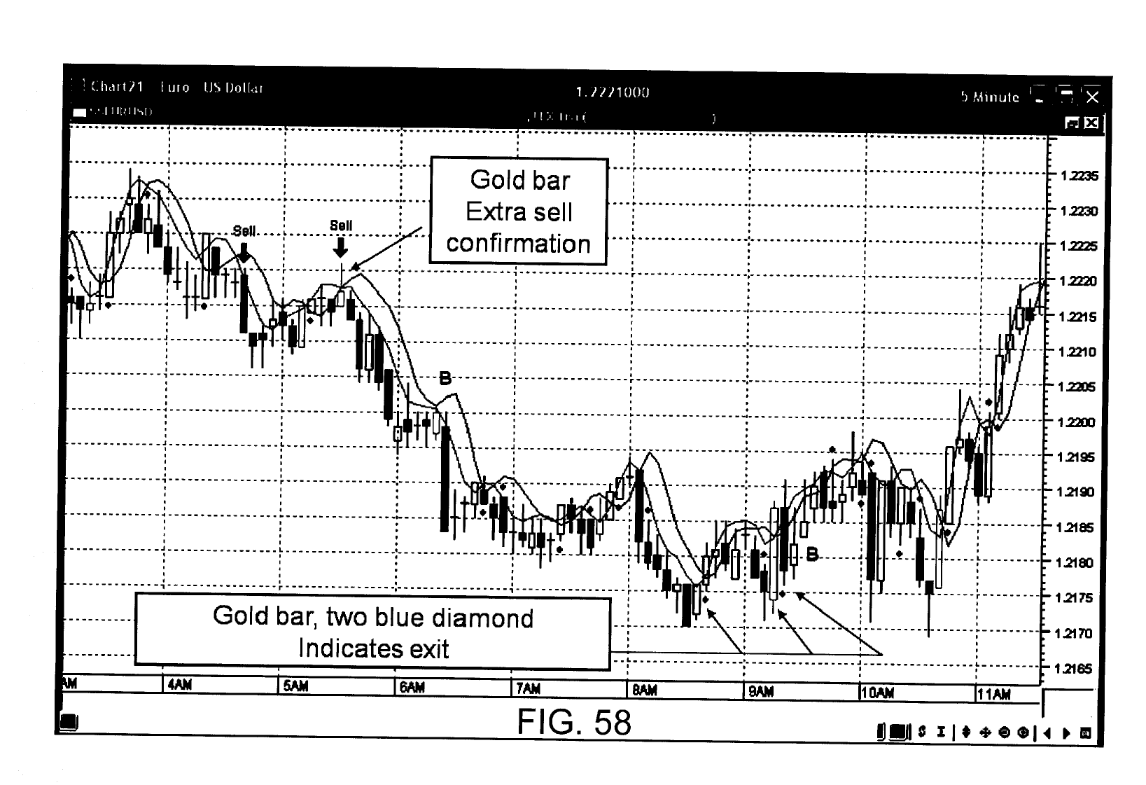

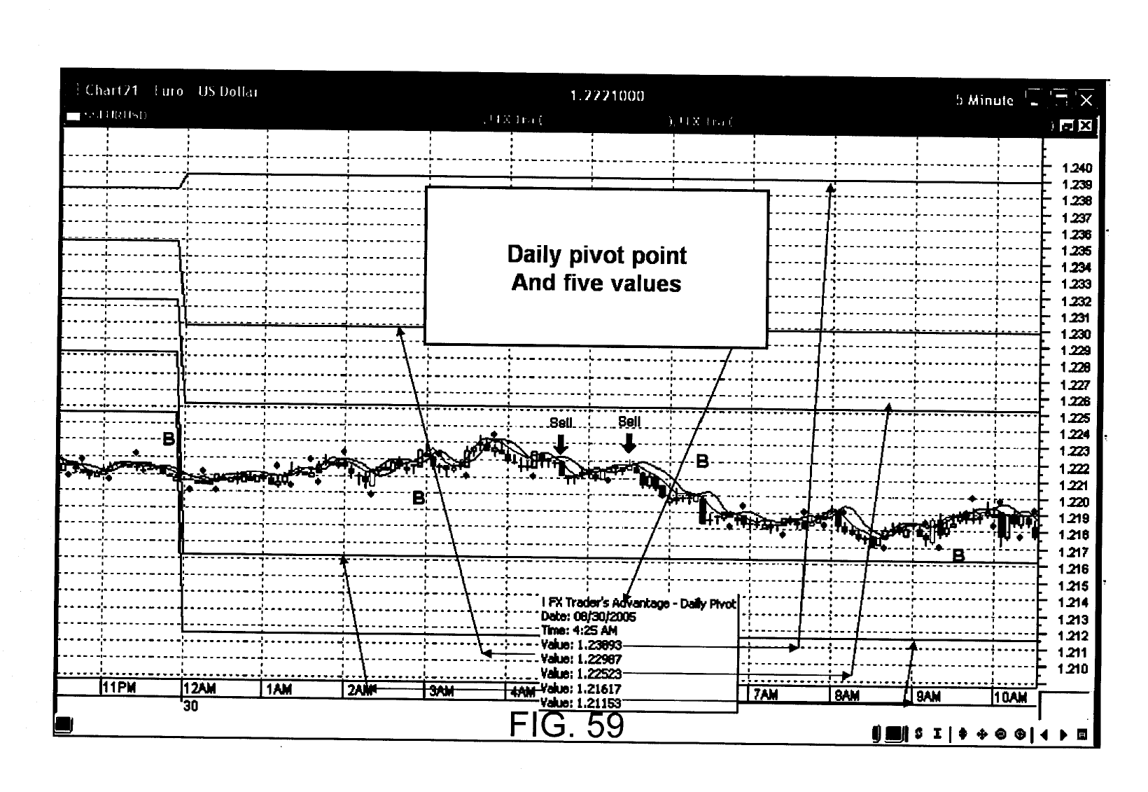

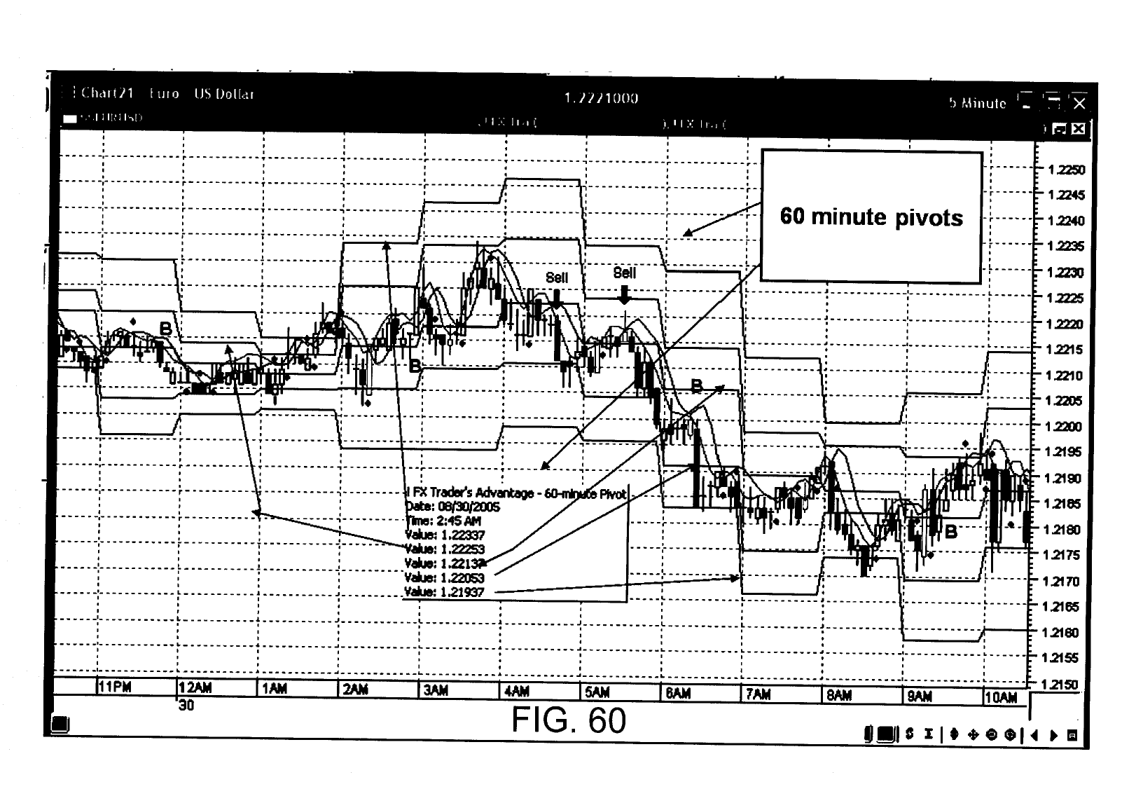

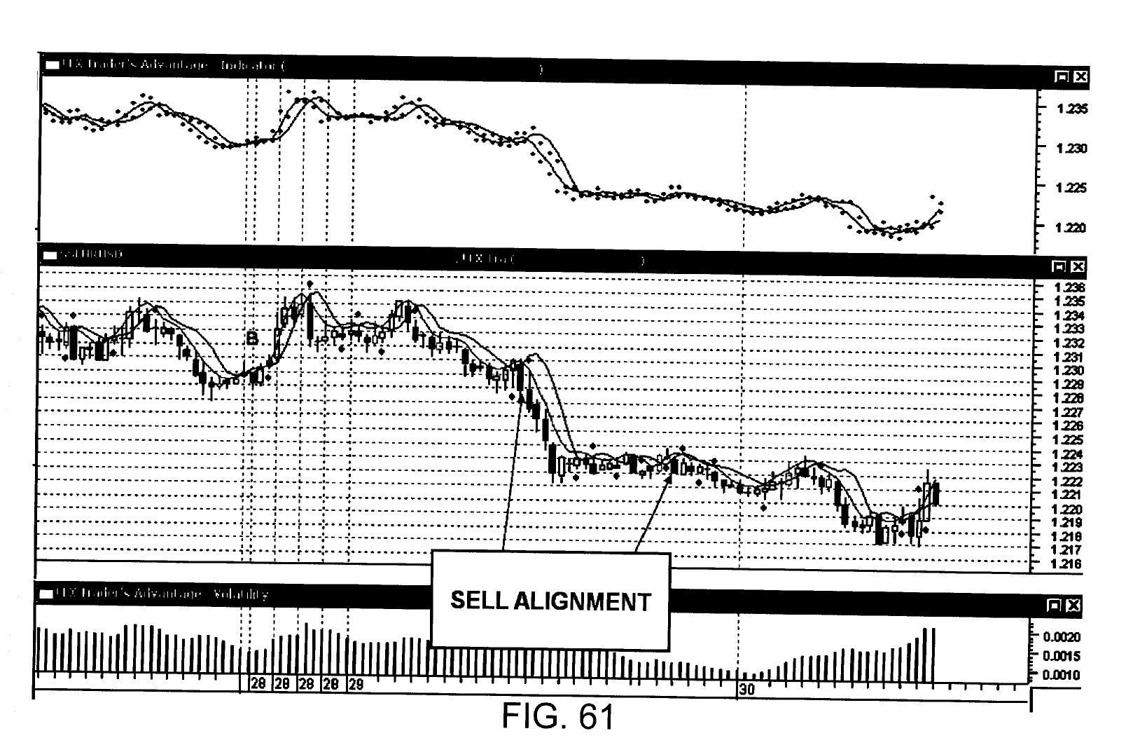

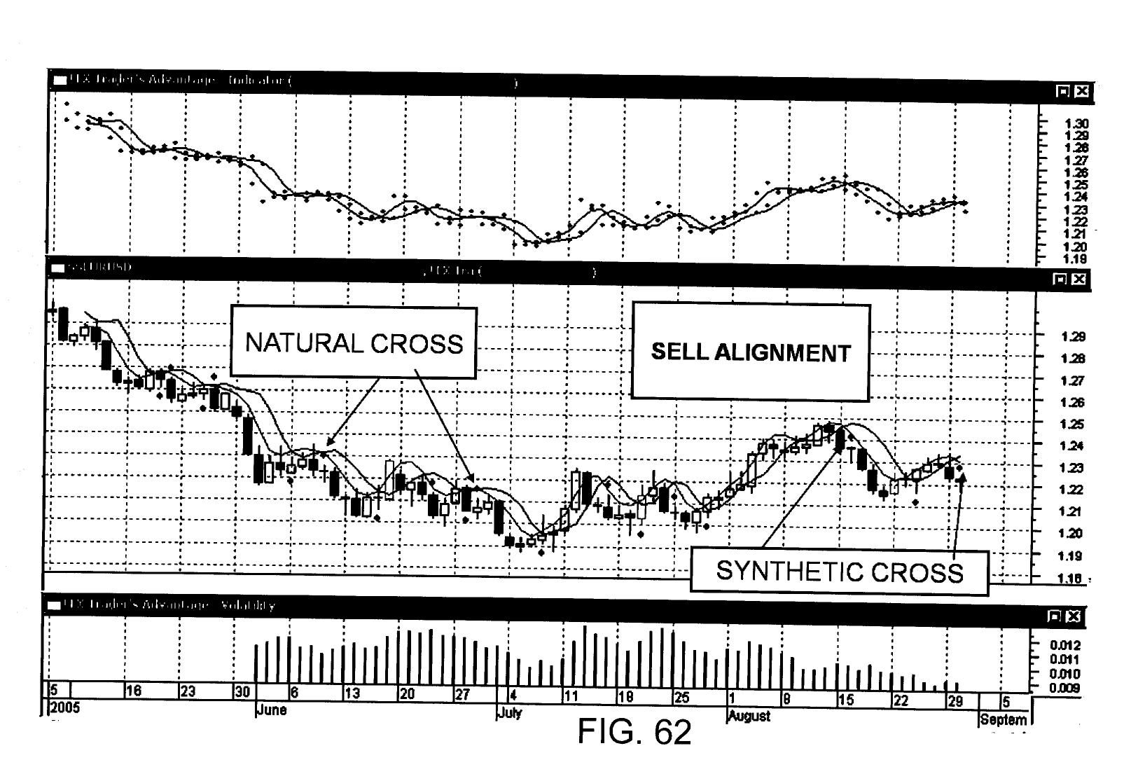

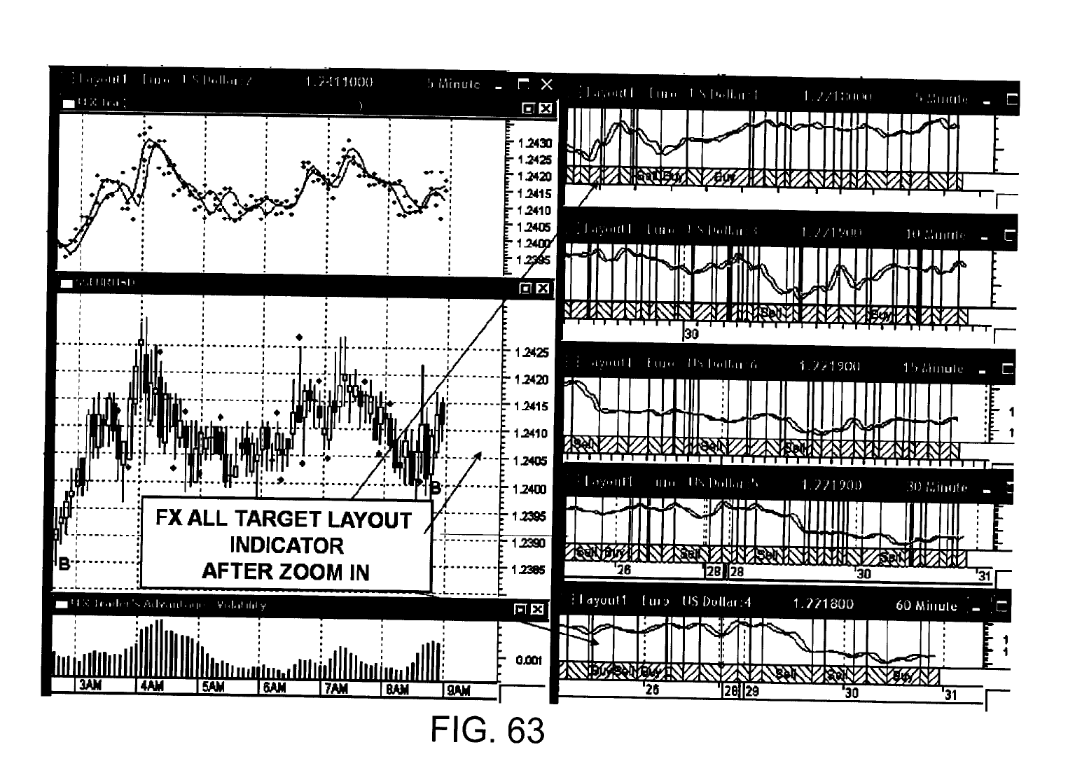

According to a preferred embodiment of the present invention, the preferred instruction method also includes identification and description of the methods of interpreting the market change information identified by the indicators individually and in combination. As shown in FIG. 1, FIG. 2 a single indicator, V-TWO, is used to identify changes in a market and what the changes suggest. As shown in FIG. 42, FIG. 48, FIG. 49, FIG. 50, FIG. 51, FIG. 54, FIG. FIG. 55, FIG. 56, FIG. 57, FIG. 58, FIG. 59, FIG. 60, FIG. 61, FIG. 62 and FIG. 63 multiple indicators can be combined to identify market changes and permit a trader to validate each indicator against other indicators as to what the identified changes suggest. Preferably, the instruction method presents various market change scenarios and combinations of the indicators embodied in the preferred computer real-time analysis system (at least herein embodying providing at least one third teaching aid comprising at least one third explanatory chart relating to interpretation of such at least one indicator signal).

According to a preferred embodiment of the present invention, the preferred instruction method also provides trading-decision guidance based on market changes identified by one or more indicators. As shown in FIG. 19, FIG. 20, FIG. 20A, FIG. 25, FIG. 26, and FIG. 29 instruction preferably provides suggested actions that may be taken by a trader and the related risks. Preferably, for example, as shown in FIG. 25 and FIG. 26 the instruction method provides for the use of multiple indicators such as V-TWO, and Golden Bar to identify market changes, the action suggested by the changes, some indication of expected market direction, suggested actions and related risks (at least herein embodying providing at least one fourth teaching aid comprising at least one fourth explanatory chart relating to directly guiding trading decisions of such at least one trader; and at least herein embodying providing instruction of such at least one trader relating to such directly guiding trading decisions of such at least one trader using such at least one first teaching aid, such at least one second teaching aid, such at least one third teaching aid, and such at least one fourth teaching aid).

Further, according to a preferred embodiment of the present invention, curricula encompassing each of the examples and explanations prepared for each of the concepts embodied in the preferred computer real-time analysis system will preferably be prepared, for use in classroom-based sessions, as Internet-based (on-line) sessions and as off-line sessions provided on at least one type of distributable media for the following teaching formats:
workshop;
seminar;
tutorial;
basic concepts;
advanced concepts; and
interactive hands-on.
Additionally, according to a preferred embodiment of the present invention, preferably conducting live classroom-based sessions and Internet-based sessions for:
at least one workshop;
at least one seminar;
at least one tutorial;
at least one interactive hands-on training;
at least one basic concepts session; and

at least one advanced concepts session.

Preferably, at least one session of at least one of the teaching formats will be recorded for distribution, via the Internet or on distributable media, as at least one recorded training session.

### SUMMARY

The primary concept of V-TWO Indicator and V-FOUR Indicator, Dots, Golden Bar and Critical Path is to preferably improve the ease and accuracy of trading in any tradable instrument. Preferably, the trader can save time evaluating charts and indicators, avoid confusion and produce more favorable results.

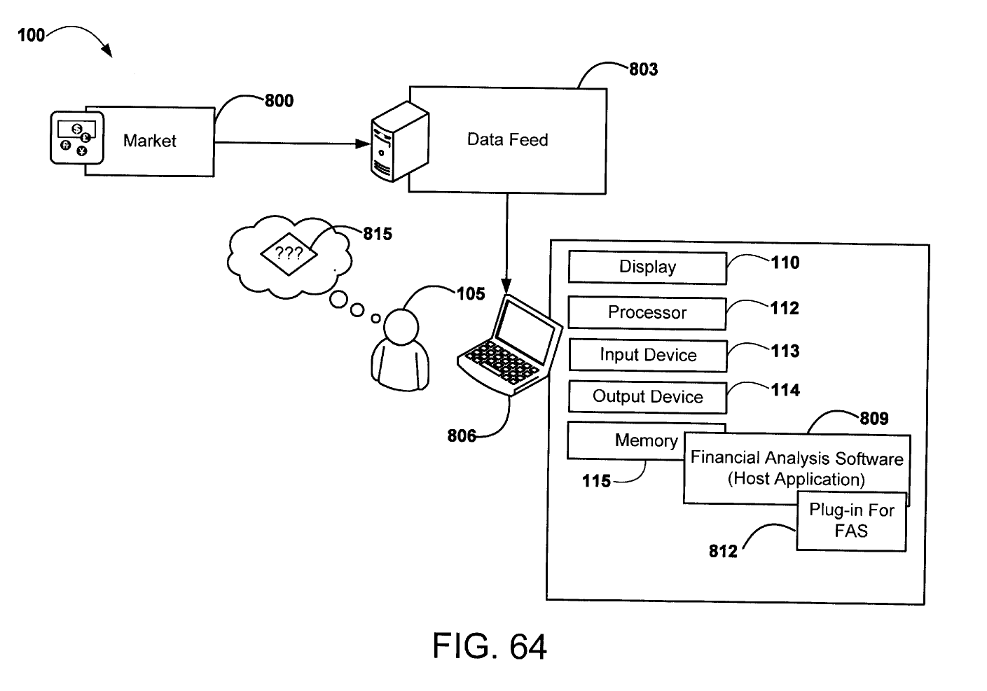

FIG. 64 shows a schematic diagram illustrating an overall arrangement of financial decision system components according to a preferred embodiment of the present invention.

Financial decision system 100 preferably assists trader 105 in making trading decisions 815, as shown. Market data 800, preferably from the currency exchange market (known as the FOREX market) is preferably distributed to traders 105 preferably via at least one network. Preferably data feed 803 is communicatively coupled to computer 806 operated by trader 105, as shown. Computer 806 is preferably at least a business class computer comprising at least one processor 112, at least one memory 115, at least one input device 113 (preferably at least one keyboard and at least one mouse), at least one display 110, and at least one output device 114 (preferably at least one printer or at least one other input device). Preferably computer 806 comprises financial analysis software 809 stored in memory 115 of computer 806, as shown. A preferred brand of financial analysis software 809 preferably comprises the MetaStock® brand of trading analysis software distributed by Equis International of Salt Lake City, Utah, preferably version 9.1 and higher of the MetaStock® brand of trading analysis software.

Preferably, financial analysis software 809 is communicatively coupled with data feed 803, as shown. Data feed 803 is preferably a “real-time” data feed. Real time data feed is a typically provided by a data feed product and service, such as QuoteCenter™ made available by Equis International of Salt Lake City, Utah, or eSignal™ offered by eSignal, a division of Interactive Data Corporation, of Hawyard, Calif.

Financial analysis software 809 preferably comprises plug-in 812 for financial analysis software (“FAS”), as shown. Plug-in 812 preferably interacts with host application, financial analysis software 809, to communicate windows, pivots, indicators, alerts, and set ups (some of which are discussed above) to trader 105 by transforming market data 800 received from data feed 803 and effecting a display of a particular indicator, pivot, alert, etc., on display 110 of computer 806. Such displays of transformed market data by plug-in 812 assist trader 105 with making financial decisions 815, as shown. Plug-in 812 is highly advantageous as it assists in displaying multiple indicators, windows, alerts, etc., to trader 105 without the need for the trader to evaluate, calculate, and analyze the fluctuations in the market data by hand calculation (which would be impossible to do as a purely mental step). It is also important to note that minor changes in the market may lead to large losses of money; assistance with decision making has the potential to not only increase money, but also to mitigate losses. Plug-in 812 assists trader 105 in making financial decisions by distinguishing among market events that are otherwise indistinguishable without use of plug-in 812 and computer 806. Also, plug-in 812 assists trader 105 in managing market entry and exit.

Plug-in 812 is preferably a set of instructions that instruct financial analysis software 809 and computer 806 to perform the functions described herein. Preferably, plug-in 812 is installed on computer 806 by ways known in the art (e.g., a .exe installer file stored on a CD-ROM or a .exe installer file downloaded from the Internet). After installation of plug-in 812, preferably, financial analysis software 809 comprising plug-in 812 is loaded into memory 115 of computer 806. At this point, trader 105 may access the functions of plug-in 812.

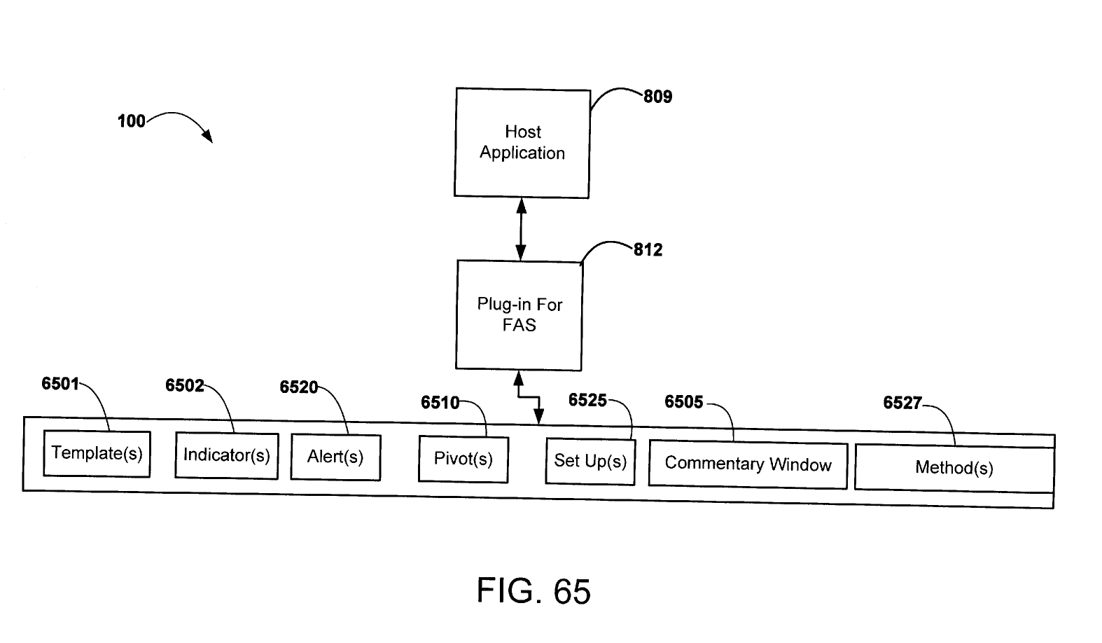

FIG. 65 shows a schematic diagram illustrating some of the express functions of plug-in 812. As stated above, plug-in 812 preferably modifies the host application, financial analysis software 809, thereby creating a new financial analysis software product, and a new piece of computer hardware. Preferably, plug-in 812 generally provides computation and calculation with specific algorithms that transform market data into visual cues trader 105. Preferably, plug-in provides many functions including ability to use templates 6501 (pre-configured indicators and chart set ups with configured colors and styles), display indicators 6502, set and view alerts 6520, plot pivots 6510, use set ups 6525, display commentary window 6505, and use methods 6527 (e.g. super long term trade), as shown.

Trader 105 preferably first uses financial analysis software 809 comprising plug-in 812 to select currency to trade (when financial analysis software 809 comprising plug-in 812 is used to assist trading in the FOREX market). As stated above, plug-in 812 may be used with all market vehicles. Trader 105 then preferably selects a particular template (a particular type of display arrangement to assist trader 105 in navigating the market) and subsequently preferably loads the template into memory 115 of computer preferably using the standard menu functions of financial analysis software 809. Preferably, trader 105 uses the commentary window (described below) and the layout of market charts to make trading decisions. Such decisions are preferably carried out in the real world via a financial broker. Preferably, in some trading instances, the following are displayed on display 110 of computer 806: indicator, commentary window, price plot (preferably in “candlestick” form), and market volatility. Commentary Window

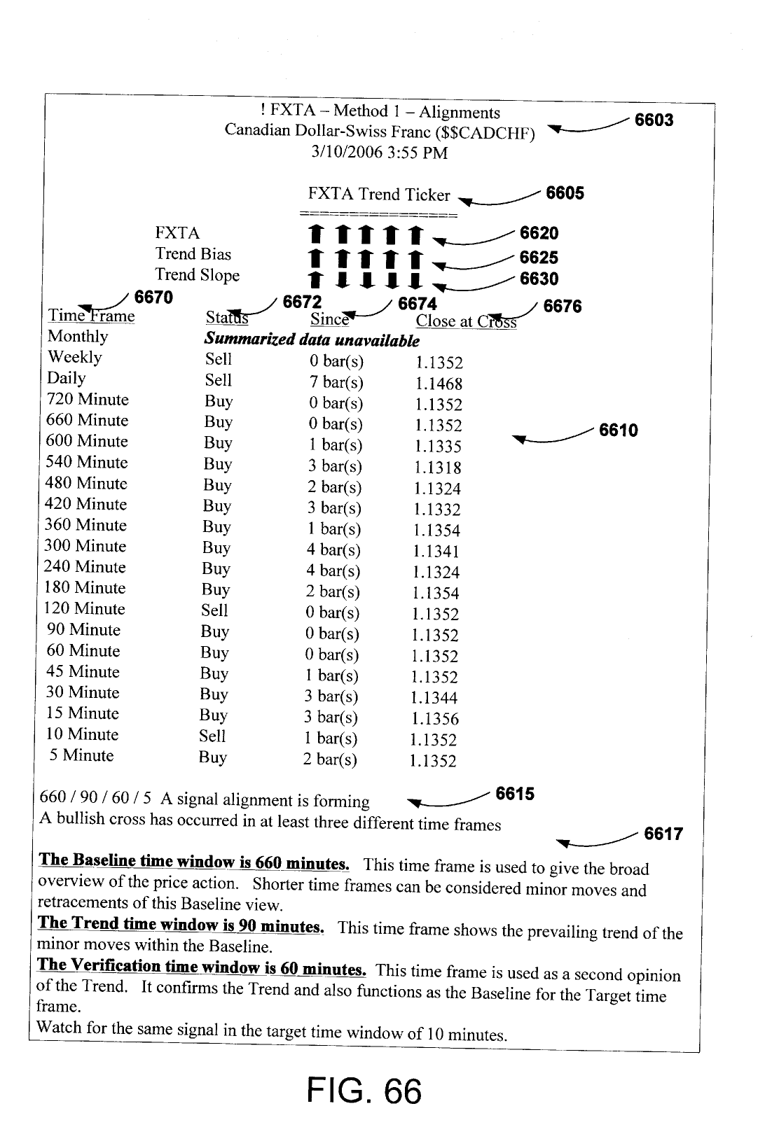

FIG. 66 shows a schematic diagram illustrating the commentary window of the financial decision system according to a preferred embodiment of the present invention.

Commentary window 6600 preferably compiles and arranges several indicators and calculated data for the benefit of trader 105, as shown. More particularly, commentary window 6600 preferably displays market alignment information, as shown.

Commentary window 6600 is preferably displayed on display 110 of computer 806. Commentary window preferably displays the following components, as shown: General Information 6603, FXTA Trend Ticker 6605, Table 6610, Summary 6615, and Commentary 6617. FXTA Trend Ticker 6605 preferably comprises FXTA signal 6620, Trend Bias 6625, and Trend Slope 6630, as shown.

General Information 6603 preferably displays any particular method used (loaded into computer memory) by trader 105, the market vehicle (e.g., Canadian Dollar-Swiss Franc), and preferably the current date and the current time.

As stated above, commentary window 6600 preferably comprises FXTA Trend Ticker 6605. FXTA Trend Ticker 6605 displays, for the benefit of trader 105, the trends over the last few time intervals so that trader 105 may visually see signals which may lead the trader into a specific course of action with increased likelihood of positive effects from the resulting financial decisions of trader 105. Preferably, arrows are used to symbolize a market trend, as shown. Preferably, “up” arrows symbolize a bullish market. Preferably, “down” arrows symbolize a bearish market. These arrows are used by trader 105 to visualize the immediate short term picture of a particular market vehicle (instead of analyzing all the smaller time frames up to 120 minutes). With respect to FXTA Trend Ticker 6605, a preferred placement of FXTA Trend Ticker 6605 is shown in FIG. 66, preferably above Table 6610.

Preferably colors are also used to indicate trends and coupled with arrows. Generally, the color green preferably symbolizes a bullish condition, the color green preferably indicates a bullish trend, the color maroon preferably indicates a bearish trend, and the color red preferably indicates a bullish condition. These at least two symbols (preferably arrow direction and color) assist trader 105 in making financial decisions.

FXTA signal 6620 is preferably a buy or sell signal that is preferably displayed when an alignment is experienced in the last five time frames. Preferably at least one arrow, preferably at least five arrows, is/are displayed. Preferably the “Sell” arrow is preferably colored red and preferably points down. Preferably the “Buy” arrow is preferably green and preferably points up.

Trend Bias 6625 is an indicator related to the buy/sell ribbon discussed below. Preferably, at least one arrow, preferably at least five arrows, is/are displayed (representative of the last number of time frames). A red-colored, down-pointed arrow preferably indicates a bearish bias. A blue-colored, up-pointed arrow preferably indicates a bullish bias.

Trend Slope 6630 preferably comprises at least one arrow, preferably at least five arrows. A sell arrow is preferably colored red and preferably pointing down. A buy arrow is preferably colored blue and preferably pointing up.

In use, trader 105 preferably looks first to Trend Slope 6630 to give early predictability about possible future market trends. Trader 105 preferably looks to the other signals (FXTA signal 6620 and Trend Bias 6625) for confirming purposes. FXTA Trend Ticker 6605 is a means for trader 105 to quickly get a glimpse of the market at the close of the last five time intervals. Preferably, each item (FXTA signal 6620, Trend Bias 6625, and Trend Slope 6630) is updated per the time interval (e.g., five minutes) and “moves” from right to left (i.e., the left-most arrow “disappears” as the time interval progresses and the right-most arrow “appears” as the time interval progresses thereby showing the current market status for the latest time interval in the right-most arrow position and the prior four historical market statuses to the left of the right-most arrow).

As stated above, commentary window 6600 preferably comprises Table 6610, as shown. Table 6610 preferably comprises market trend data from multiple time frames, as shown. Preferably, the following columns are displayed: Time Frame 6670, Status 6672, Since 6674, and Close at Cross 6676, as shown. Time Frame 6670 column is self-explanatory (shown in FIG. 66 are the following time frames: Monthly, Weekly, Daily 720 minute, 660 minute, 600 minute, 540 minute, 480 minute, 420 minute, 360 minute, 300 minute, 240 minute, 180 minute, 120 minute, 90 minute, 60 minute, 45 minute, 30 minute, 15 minute, 10 minute, and 5 minute). Status 6672 preferably displays the trend at that time frame (Buy or Sell). Preferably, the displayed status trend may be colored green in a bearish condition and red in a bullish condition. Since 6674 preferably displays the number of bars that were observed since the last trend occurred. Close at Cross 6676 preferably displays the price of the close when the trend occurred.

As stated above, commentary window 6600 also preferably comprises Summary 6615 which enhances identification of certain market qualities, such as identifying that a bearish cross alignment has occurred. Summary 6615 is preferably a concise sentence of at least one market condition. Summary 6615 is preferably one line. Being concise and being one line gives trader 105 added advantages in making financial decisions.

Summary 6615 is preferably displayed near the bottom of Commentary Window 6600. An illustration of the content of Summary 6615 follows:

“660/90/60/5 A signal alignment is forming

A bullish cross [preferably displayed in a green colored font] has occurred in at least three different time frames.”

Alignment details preferably for at least one time frame, preferably at least four time frames (such as 660/90/60/5), are preferably provided so that a trader may see four time frames in a “fast” moving market. Summary 6615 is preferably placed at the bottom of the last time frame (the five minute time frame) and preferably above Commentary 6617, as shown.

Preferably, Commentary Window 6600 comprises Commentary 6617 which comprises further explanation of Summary 6615 and also indicates to trader 105 what time frame is the target time frame. In FIG. 66, the target time frame is 10 minutes.

Upon reading the teachings of this specification, those of ordinary skill in the art will now understand that, under appropriate circumstances, considering such issues as market vehicle to be traded, trader preferences, breakthroughs in trading algorithms, other commentary window elements, either alone or in combination, such as time, price, date, floating pivot target, high at cross, low at cross, open at cross, weekly high, monthly high, weekly low, weekly high, daily high, yearly high, quarterly high, annual high, key levels, previous day open, previous day high, previous day low, previous day close, previous day swing high, previous day swing low, previous week swing, previous week swing high, previous week swing low, previous week close, previous month swing high, previous month swing low, previous month close, daily double bottoms, daily double tops, weekly double bottoms, weekly double tops, market psychological labels (such as the DOW at 10,000 points), current year high, current year low, all time high, all time low, Fibonacci levels, etc., may suffice.

Preferably, once a target time frame is identified, a template is preferably selected by trader 105 and loaded into memory 115 of computer to view the market. One screen arrangement is shown in FIG. 63 which preferably comprises the FX Trader's Advantage chart 6300 (upper left panel of FIG. 63), the candlestick price plot (middle left panel of FIG. 63), the market volatility chart (bottom left panel of FIG. 63), a 5 minute chart (upper right panel of FIG. 63), a 10 minute chart (panel below the 5 minute chart of FIG. 63), a 15 minute chart (center panel of FIG. 63), a 30 minute chart (panel below the 15 minute chart of FIG. 63), and a 60 minute chart (bottom right panel of FIG. 63).

### Indicators

Plug-in 812 preferably displays indicators 6515 (see FIG. 65) which assist trader 105 in trading. Indicators preferably comprise weekly pivot, 60-minute pivot, Daily pivot, FXTA indicator, simplified FXTA indicator, Trend Bias, Trend Slope, market volatility, 5, 10, 15, 30, 45, 60-minute Buy signals, and 5, 10, 15, 30, 45, 60-minute Sell signals, among others discussed herein. Generally speaking, alignments occur when the same signal occurs in at least three timeframes and there is some confirmation that the signal may occur in a next timeframe shorter than the previous three timeframes.

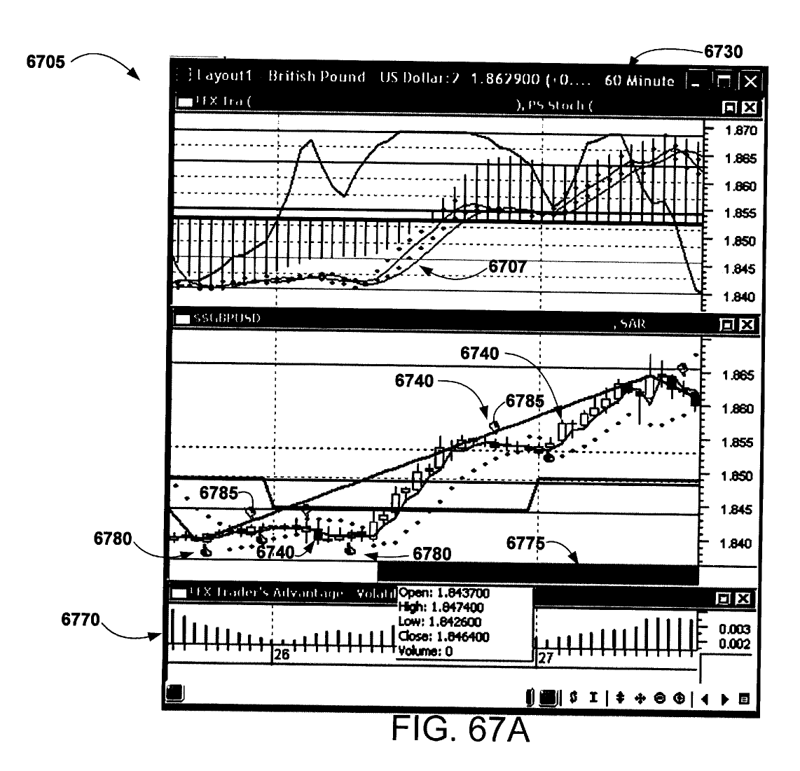

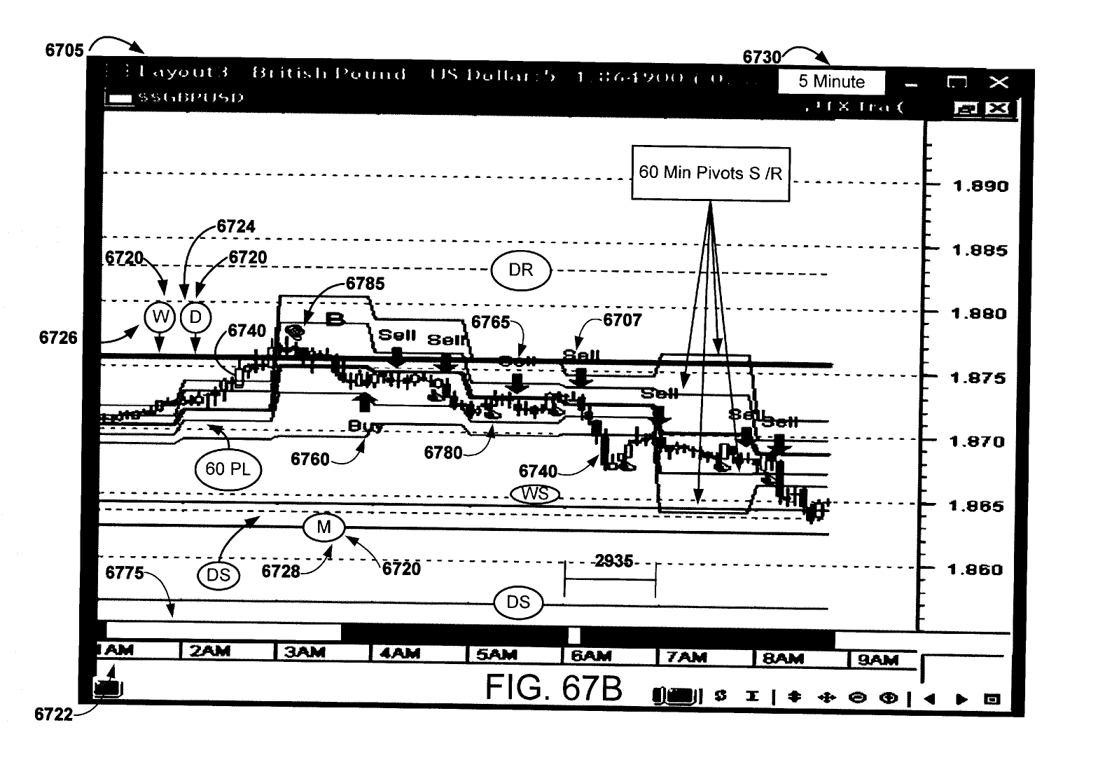

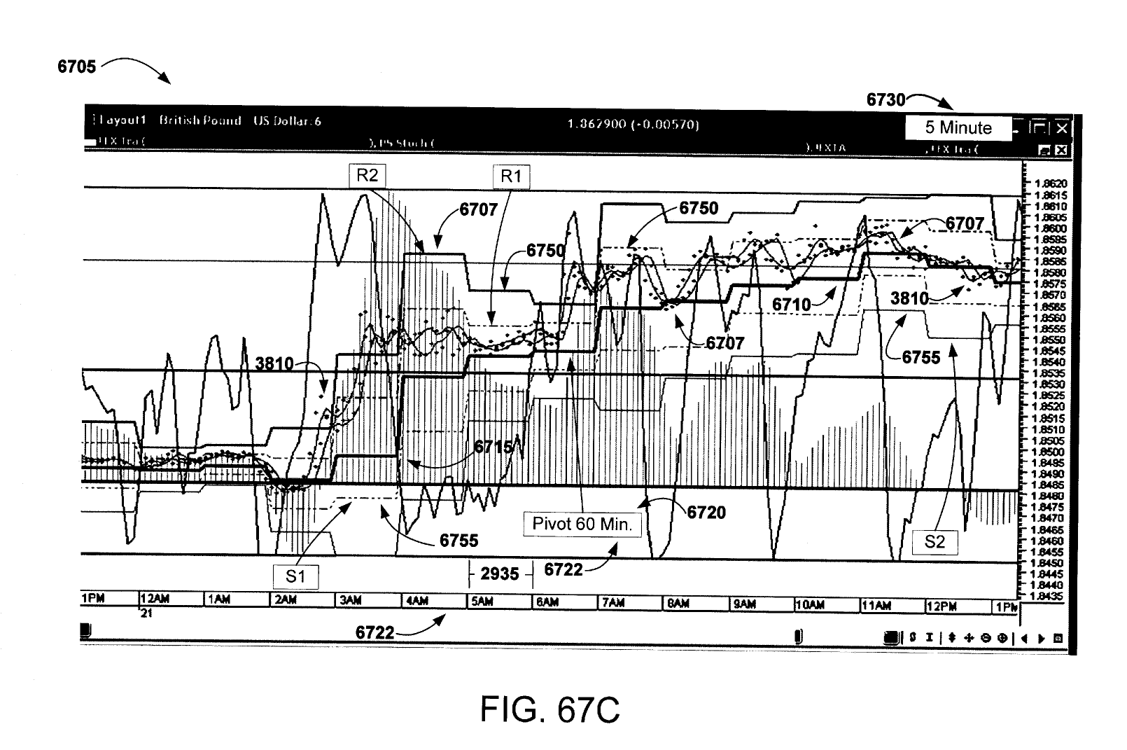

FIGS. 67A, 67B, and 67C show diagrammatic screenshots, illustrating at least one market chart 6705, according to the preferred embodiment of FIG. 1.

Market chart 6705 preferably comprises at least one market indicator 6707, as shown, preferably pivot line 6710, alternately preferably at least one FXTA indicator 6710, alternately preferably at least one candle 6740, alternately preferably at least one buy arrow 6760, alternately preferably at least one sell arrow 6765, alternately preferably at least one volatility indicator 6770, alternately preferably thumbs-up indicator 6780, alternately preferably at least one thumbs-down indicator 6785, alternately preferably at least one buy/sell ribbon 6775 (trend bias). Upon reading this specification, those skilled in the art will now appreciate that, under appropriate circumstances, considering such issues as market, user preferences, future predictors, other market indicators, such as, for example, supply and demand indicators, PSTOCH indicators, colored market indicators, etc., may suffice.

Volatility indicator 6770 preferably indicates when prices in the market undergo greater than normal swings and are preferably displayed in histogram-like format (see bottom panel of FIG. 67A). A longer bar indicates higher volatility. Likewise, a shorter bar indicates lower volatility. Preferably market volatility is used to confirm price trends.

Thumbs-up indicator 6780 and thumbs-down indicator 6785 preferably are buy and sell indicators, respectively, preferably within timeframe 6720 of market chart 6705. When market conditions conform to indicate an entry point (buy conditions) or an exit point (sell conditions), market chart 6705 preferably displays thumbs-up indicator 6780 or thumbs-down indicator 6785, respectively. Upon reading this specification, those skilled in the art will now appreciate that, under appropriate circumstances, considering such issues as user preference, cost, market accepted indicators, etc., other buy/sell indicators for single-timeframe buy/sell conditions, such as, for example, colored arrows, vertical lines, go/stop signs, etc., may suffice.

Buy arrow 6760 and sell arrow 6765 preferably are also buy and sell indicators, respectively. However, buy arrow 6760 and sell arrow 6765 preferably display when market conditions conform to indicate an entry point or an exit point, respectively, preferably in a plurality of timeframes 6720, preferably including timeframe 6720 of market chart 6705. Thus, buy arrow 6760 and sell arrow 6765 preferably are real-time indicators of multi-timeframe market trends, which tend to be stronger than single-timeframe market trends as indicated by thumbs-up indicator 6780 or thumbs-down indicator 6785. Upon reading this specification, those skilled in the art will now appreciate that, under appropriate circumstances, considering such issues as user preference, cost, market accepted indicators, etc., other buy/sell indicators for multi-timeframe buy/sell conditions, such as, for example, colored arrows, vertical lines, go/stop signs, etc., may suffice.

Market chart 6705 preferably comprises at least one chart timeframe 6730, preferably comprising 5-minute timeframe 6735, as shown in FIGS. 67B and 67C, alternately preferably 60-minute timeframe, as shown in FIG. 67A, alternately preferably 1-day timeframe. Chart timeframe 6730 preferably determines the rate at which market chart 6705 is updated (i.e., a 5-minute timeframe updates every 5 minutes). Upon reading this specification, those skilled in the art will now appreciate that, under appropriate circumstances, considering such issues as available market data, user preference, etc., other chart timeframes, such as, for example, 1-tick timeframe, 1-minute timeframe, 10-minute timeframe, etc., may suffice.

Pivot line 6710 is preferably derived from at least one pivot point 6715. Pivot line 6710 comprises one timeframe 6720, as shown, preferably comprising 60-minute timeframe 6722, alternately preferably 1-day timeframe 6724, alternately preferably 1-week timeframe 6726, alternately preferably 1-month timeframe 6728. Timeframe 6720 is preferably greater than chart timeframe 6730. Market chart 6705 preferably graphs at least one portion of at least one time duration 2935 of timeframe 6720, preferably at least one time duration 6735, preferably a plurality of time durations 2935 of timeframe 6720, as shown. Pivot line 6710 preferably represents pivot point 6715 over one time duration 6735 of timeframe 6720, as shown. Pivot line 6710 preferably is calculated for each time duration 2935 of timeframe 6720. Upon reading this specification, those skilled in the art will now appreciate that, under appropriate circumstances, considering such issues as chart timeframes, available data, user preferences, etc., other timeframes, such as, for example, one year, 30 minutes, two hours, etc., may suffice.

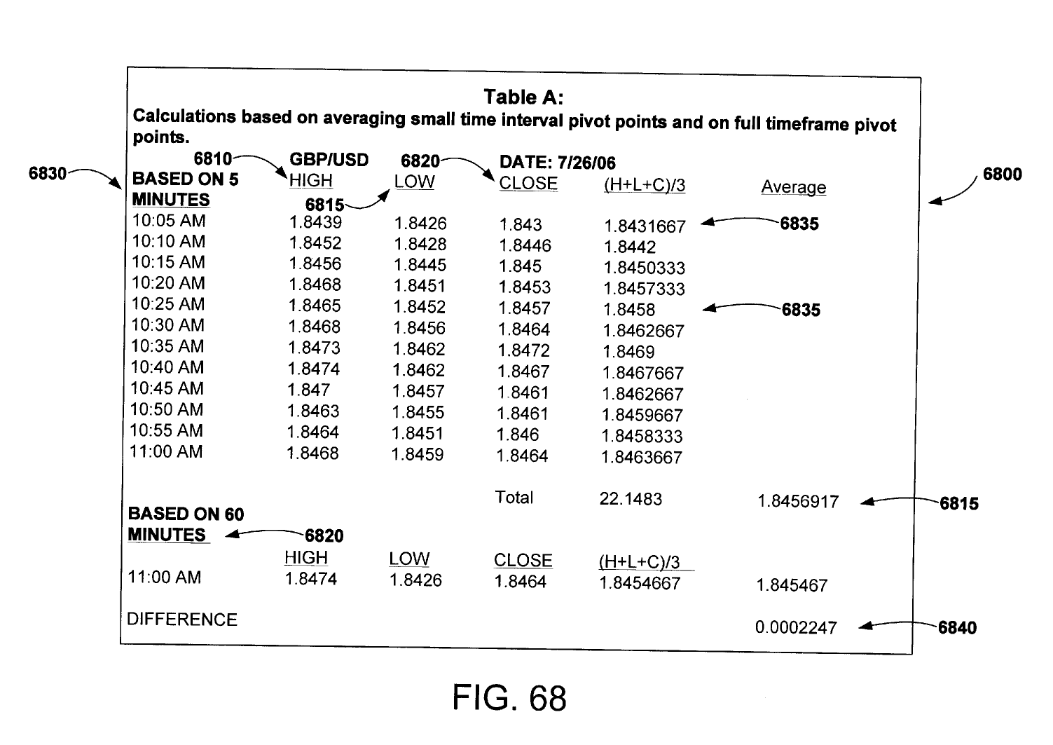

FIG. 68 shows a calculation chart, illustrating a preferred calculation method 6800 of pivot point 6815, according to the preferred embodiment of FIG. 1. Pivot point 6815 is preferably calculated using an average of at least one pivot point 6835, comprising at least one timeframe interval 6830, preferably all pivot points 6835 within timeframe 6820, as shown. Time interval 6830 preferably comprises less time than timeframe 6820, preferably between timeframe 6820 and 1 tick, as shown. Additionally, timeframe 6820 preferably is evenly divisible by time interval 6830. Applicant has determined that pivot line 6810 becomes more accurate, for indicating future market conditions, with smaller time intervals 6830. Preferably, the time frame selected for the calculation is settable by trader. Applicant prefers a three minute time frame for trading futures. FIG. 68 shows a preferred five minute time frame for trading currency.

Pivot point 6835 is preferably calculated using equation 1.0 below:

(H+L+C)/3 1.0

where H is the highest price 6810 during timeframe interval 6830; L is the lowest price 6815 during timeframe interval 6830; and C is the closing price 6820 of timeframe interval 6830, as shown.

As shown, comparing calculation method 6800 to calculating a pivot point using equation 1.0 for all of timeframe 6820 reveals difference 6840. Applicant has found difference 6840 to be significant when forecasting market prices particularly when using pivot line 6810 in conjunction with other market indicators 6807.

It is noted that as the timeframe shifts, the pivot calculation will also shift. The pivot point at the latest time frame is dropped and the pivot point at the most recent time frame is added. The average values are computed at each time interval and a new average is determined. This “new point in-last point out” system allows the data to shift as time progresses so that the display is most current.

In addition to pivot line 6710, at least one resistance line 3850 and at least one support line 3855 are preferably also plotted (as shown in FIG. 67C) preferably using resistance points (R1, R2, R3, etc.) and preferably support points (S1, S2, S3, etc.) respectively. Resistant points and support points are preferably calculated using pivot point 3815.

Equations 2.1, 2.2, and 2.3 below show resistant point calculations.

R1=(2*Pivot)−L (2.1)

R2=(Pivot−S1)+R1 (2.2)

R3=(Pivot−S1)+R2 (2.3)
Equations 3.1, 3.2, and 3.3 below show support point calculations.

S1=(2*Pivot)−H (3.1)

S2=Pivot−(R2−S1) (3.2)

S3=Pivot−(R1−S2) (3.3)

Resistance line 3850 preferably indicates at least one point at which an upward market swing may encounter resistance to continuing and may reverse direction. Support line 3855, like resistance line 3850, indicates at least one point at which a reversal may occur, however, support line 3855 is indicative of support of the market to reverse a downward market swing.

Some traders may prefer to smooth out pivot line 3810, as well as resistance line 3850 and support line 3855. Smoothing may preferably be applied to pivot line 3810, resistance line 3850, and support line 3855. Smoothing preferably takes a moving average using at least one previous pivot point 3815, preferably a plurality of pivot points 3815. Due to the more accurate nature of pivot point 3815 using calculation method 6800, smoothing is preferably also more accurate.

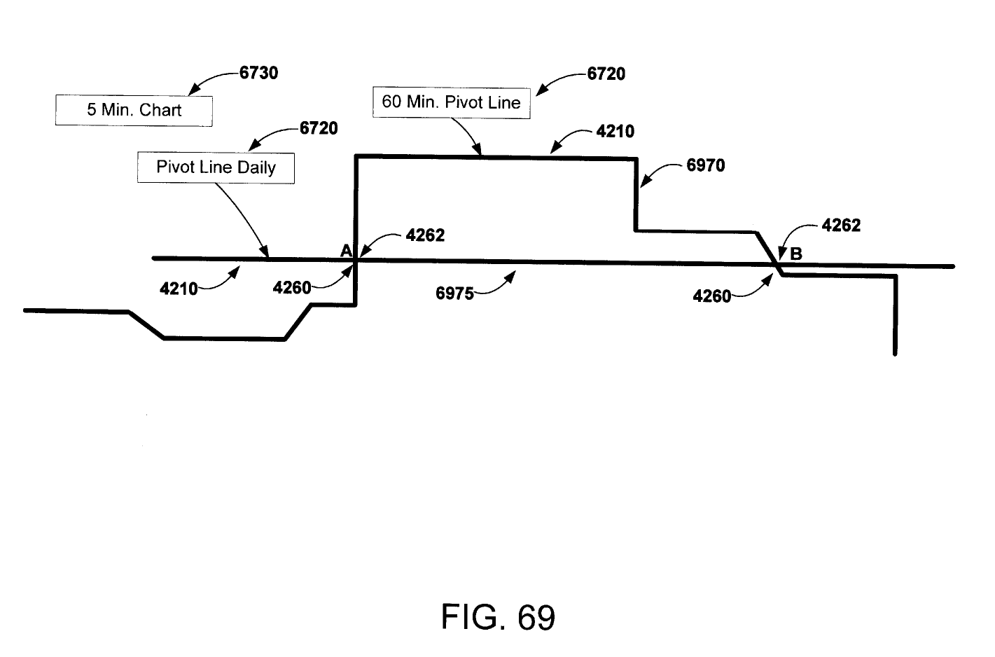

FIG. 69 shows a pivot line interaction graph, illustrating pivot line to pivot line interactions, according to the preferred embodiment of FIG. 1.

At least one pivot line to pivot line interaction 4260 may preferably be used as a leading indicator. Pivot line to pivot line interaction 4260 comprises at least one intersection 4262 of pivot lines 4210, preferably comprising at least two different timeframes 6720 (60-minute pivot line and daily pivot line in FIG. 69), as shown. Pivot line to pivot line interaction 4260 may preferably be applicable with any chart timeframe 6730 (five minute, thirty minute, sixty minute, etc.).

Pivot line to pivot line interaction 4260 preferably comprises at least one lesser-timeframe pivot line 6970 and at least one greater-timeframe pivot line 6975, as shown. Timeframe 6720 of lesser-timeframe pivot line 6970 is less than timeframe 6720 of greater-timeframe pivot line 6975, as shown.

When lesser-timeframe pivot line 6970 crosses greater-timeframe pivot line 6975 in a more positive direction, as shown at point A, it indicates stronger upward movement. When lesser-timeframe pivot line 6970 crosses greater-timeframe pivot line 6975 in a more negative direction, as shown at point B, it indicates stronger downward movement. This applies to any pair of timeframes 6720 of two different pivot lines 4210. Lesser-timeframe pivot line 6970 will always indicate the direction, when crossing greater-timeframe pivot line 6975.

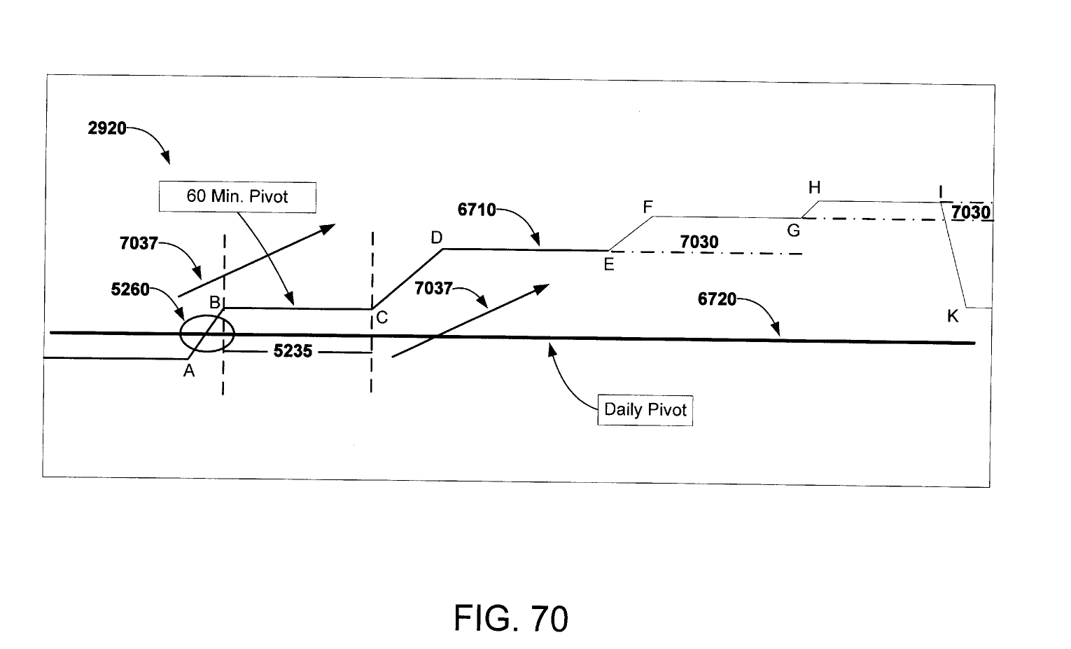

FIG. 70 shows a diagram, illustrating at least one sequential time duration indicator 2920, according to the preferred embodiment of FIG. 1. Pivot line 6710 preferably graphs pivot point 6715 across time duration 5235. Consequently, pivot line 6710 preferably graphically shows each difference 5230 between pivot points 6715 of adjacent time durations 5235.

In FIG. 70, it may be noted that pivot line 6710 crosses another pivot line 6710 of greater timeframe 6720 between point A and B. As noted in the discussion of FIG. 69, this indicates a movement 7037 strongly upward. As time progresses, differences 7030 between points C and D, E and F, and G and H become smaller and smaller, as shown. This decrease in differences 7030, over sequential time durations 5235, preferably indicates a weakening of movement 7037. And the difference between points I and K, being negative, shows the result of this weakening. Therefore, variations of differences 7030 in sequential time durations 5235 preferably indicate changes in the strength of movements 7037, as shown. This interaction is applicable for both strengthening (increases in differences 7030) and weakening of movement 7037. Additionally, this interaction is applicable for upward movements and downward movements.

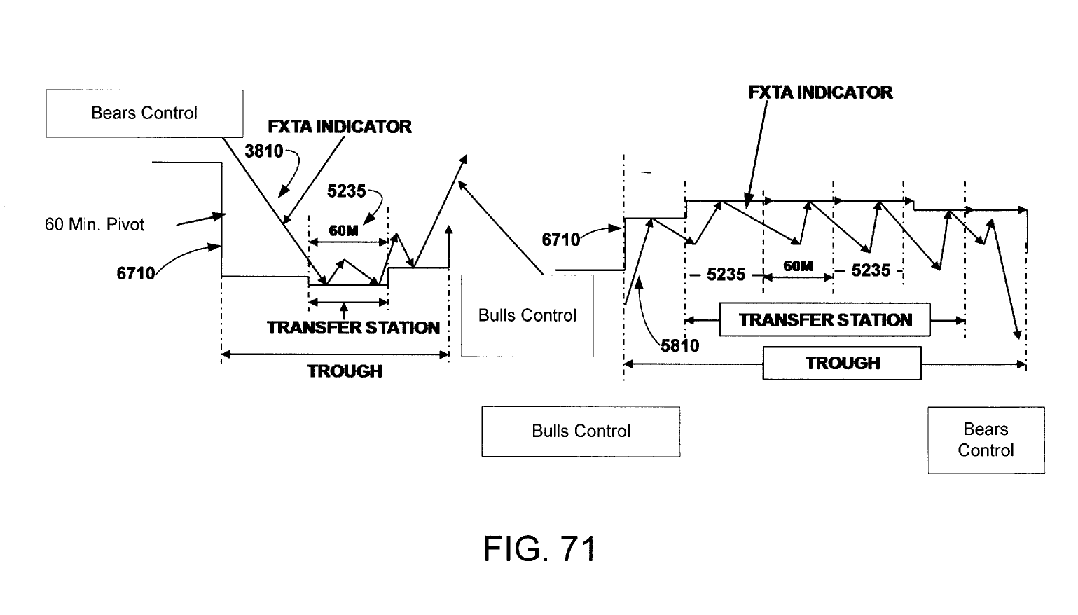

FIG. 71 shows a diagram, illustrating FXTA Indicator 3810 interacting with pivot line 6710, according to the preferred embodiment of FIG. 1.

When plotting pivot line 6710, sequential time durations 5235 may comprise nearly equal values. When this happens, FXTA indicator 3810 may rest on or fall under pivot line 6710, creating strong support or resistance respectively. This preferably indicates a situation for transferring the market vehicle control from either bear to bull, with FXTA indicator 3810 above, as shown, or bull to bear, with FXTA indicator 3810 below. Effectively, this situation preferably indicates a reversal of the market. The bottoming out (or “trough”) of the pivot line is coined by the term “transfer station” intending to mean that a shift in the market from bull to bear, or vice versa, is coming. Essentially, there must be a significant drop in the pivot line and an essentially horizontal portion for at least two time frames 5235 to observe a “transfer station”. Summarizing the above, when a drop in the pivot line is experienced followed by a essentially horizontal portion (a flattening out), one can expect a change from bull to bear or vice versa. Plug-in 812 preferably scans the pivot line plot for a horizontal area. If the trader is in a short position, the trader will preferably get out of the short position and reverse the position. Using this method, trader 105 may essentially predict the transfer of bullish or bearish market or vice versa.

### Modified Parabolic SAR

Parabolic SAR, referred to as the stop-and-reversal indicator, is an indicator that sets trailing price stops for long or short positions. Typically, a trader establishes a trend and then trades with Parabolic SAR in the direction of the trend. When Parabolic SAR is plotted as dotted lines, the dotted lines below the price establish the trailing stop for a long position and the lines above the price establish the trailing stop for a short position. At the start of a move, Parabolic SAR will provide a greater cushion between the price and the trailing stop. As the move progresses, the distance between the price and the indicator shrinks allowing tighter stop-loss as the price moves in a favorable direction. There are two variables importantly considered by SAR, the “step” and the “maximum step”. The higher the step is set, the more sensitive the indicator will be to price changes. If the step is set too high, the indicator will fluctuate above and below the price too often and make interpretation difficult. The maximum step controls the adjustment of the SAR as the price moves. The lower the maximum step is set, the further the trailing stop will be from the price. A typical step setting is at 0.02. A typical maximum step is at 0.20.

Applicant has found it significant to modify the step value to a custom value based on the market vehicle of interest to trader 105. For example, applicant has determined, using the below method, that the step for Great Britain Pounds is most effective at 0.75, not 0.20. This method comprises the following steps: first a market vehicle to be traded is selected; next a time frame in which to observe the behavior of the selected market vehicle is selected; next a step value for SAR is selected which resembles a confirmation of a confirmed move (e.g., a cross at an FXTA indicator). Using this preferred method a more accurate value for SAR may be established for the particular market vehicle. Upon reading the teachings of this specification, those of ordinary skill in the art will now understand that, under appropriate circumstances, considering such issues as popularity of market vehicles, ability to acquire data relating to market vehicles, etc., other methods of establishing a SAR value, such as establishing charts of preferred step values, modifying the step value based on past performance algorithmically, etc., may suffice.

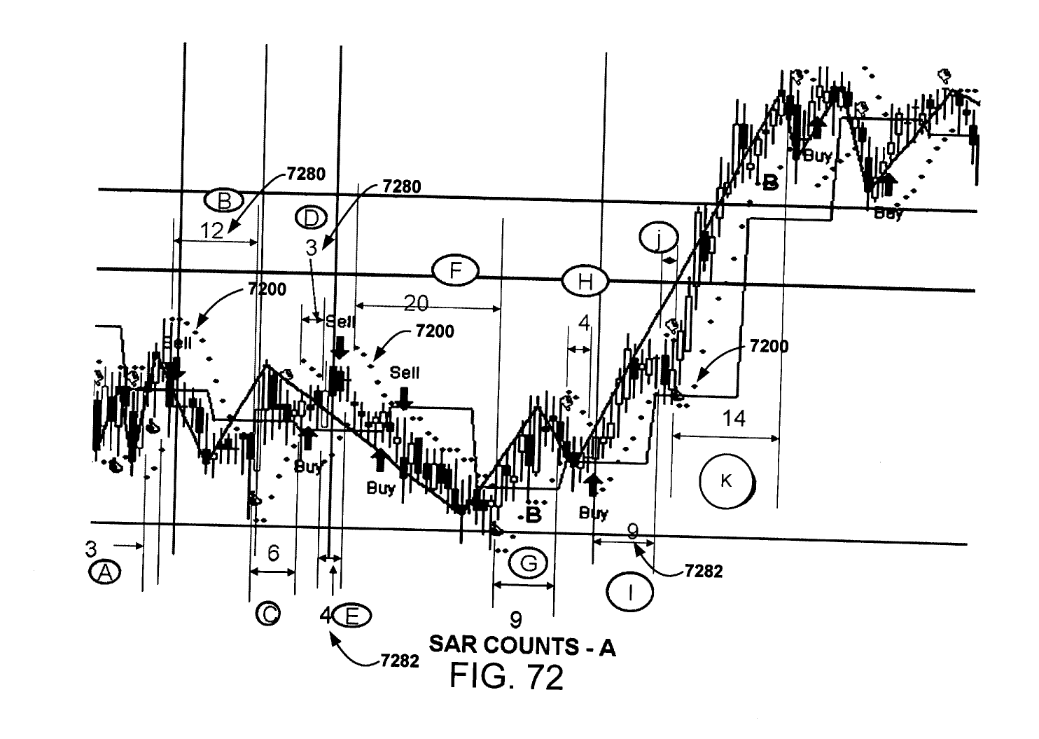

FIG. 72 shows a screenshot illustrating a market chart illustrating the applicant's SAR count method. Financial decision system 100 and plug-in 812 preferably plots modified parabolic SAR on display 110 of computer 186. The SAR plot is displayed as individual dots 7200 on a market chart. The Parabolic SAR plot is preferably displayed in a color that is noticeable to trader 105. Using the below SAR Count method and indicator, a prediction of short term market direction may be performed based on the number of SAR points within a particular time frame and by comparing the upper SAR Counts 7280 with the lower SAR counts 7282 in preferably consecutive cycles. By comparing upper SAR Count 7280 with lower SAR Count 7282, preferably computed with plug-in 812 and computer 806, the upcoming predicted strength of the trend direction for an opposite or counter cycle is preferably displayed on computer 806 for use by trader 105. In a preferred method, the number of SAR points are counted for a particular time frame. To illustrate the above, and as shown in FIG. 72, the following were observed:

| Time Frame | Number of SAR Point | Position |
|---|---|---|
| A | 3 | Lower |
| B | 12 | Upper |
| C | 6 | Lower |
| D | 3 | Upper |
| E | 4 | Lower |
| F | 20 | Upper |
| G | 9 | Lower |
| H | 4 | Upper |
| I | 9 | Lower |
| J | 2 | Upper |
| K | 14 | Lower |

Next, in a preferred SAR Count method, the top and bottom SAR point values are compared. Preferably, plug-in 812 comprises instructions to instruct computer 806 to process this information. Preferably, two consecutive lower SAR counts 7282 are preferably compared. In FIG. 72, lower SAR count at point A was three and lower SAR count at point C was six, an increase by three SAR counts. This increase is indicative of an increase in the buying trend. Further the upper SAR Count at point B was 12. Using applicant's method, the prediction is that the upper SAR Count at point D will be lower than 12, it is three. Initially at least three points are needed, at least two upper SAR points and at least one lower SAR points (or two lower SAR points and at least one upper SAR point). It is noted that this analysis may be initiated at any place where these points are found. After this initial determination is made, the trend between the last two upper SAR points is preferably compared with the trend between the last two lower SAR points.

From point C to point D, the buying trend decreases (six lower SAR counts decreases to four lower SAR counts). Since we observe a decreasing buying trend, we expect a higher upper SAR count. At point F, we observe an upper SAR count of 20 (increased from three at point D. In situations in which both the selling trend decreases and the buying trend decreases, a stabilization of the market at equilibrium is predicted.

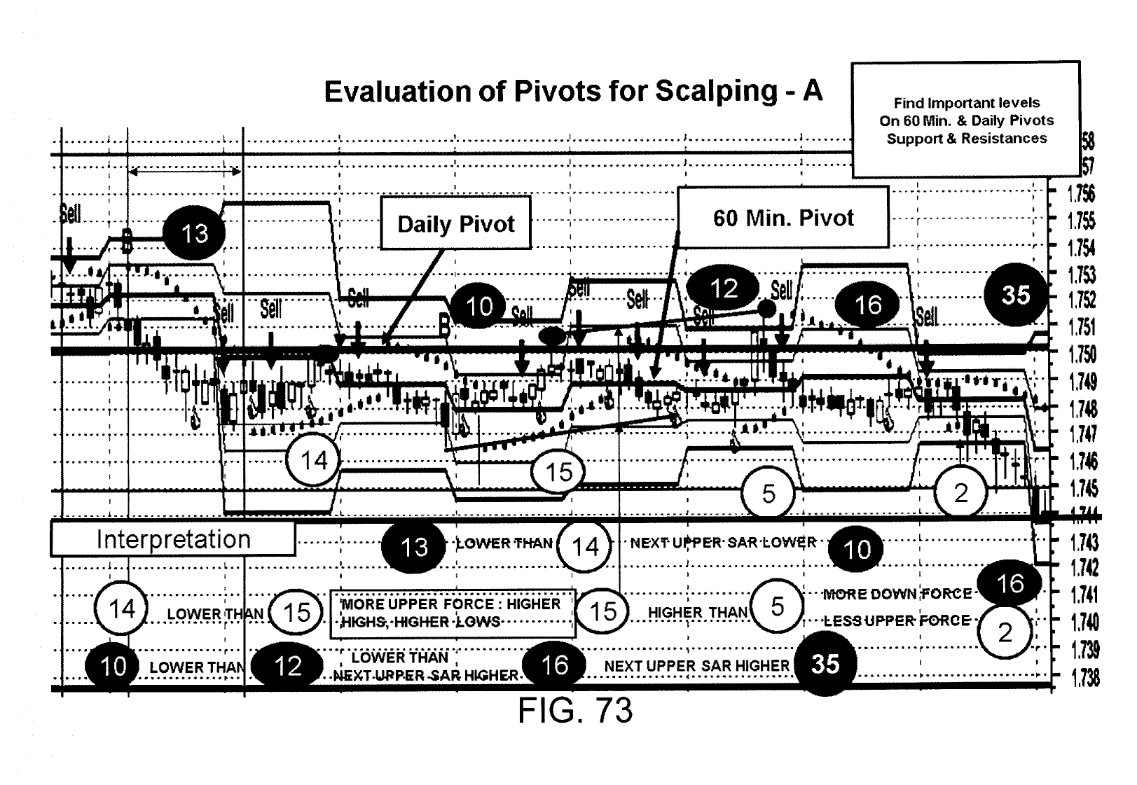

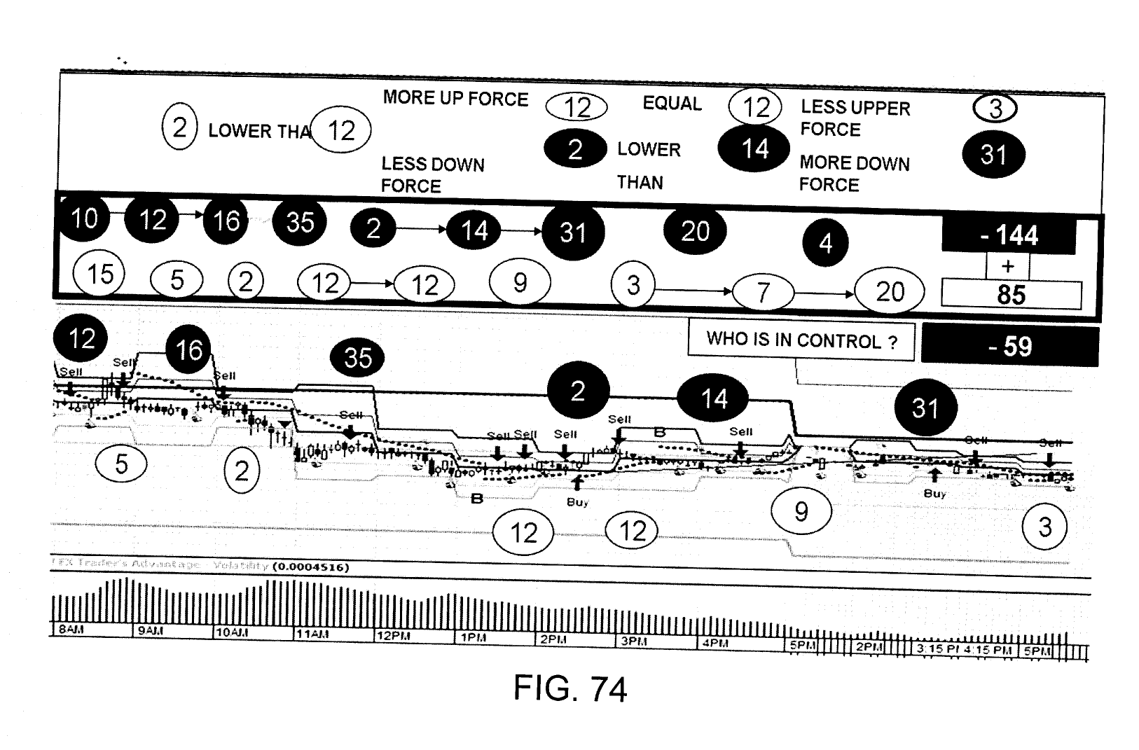

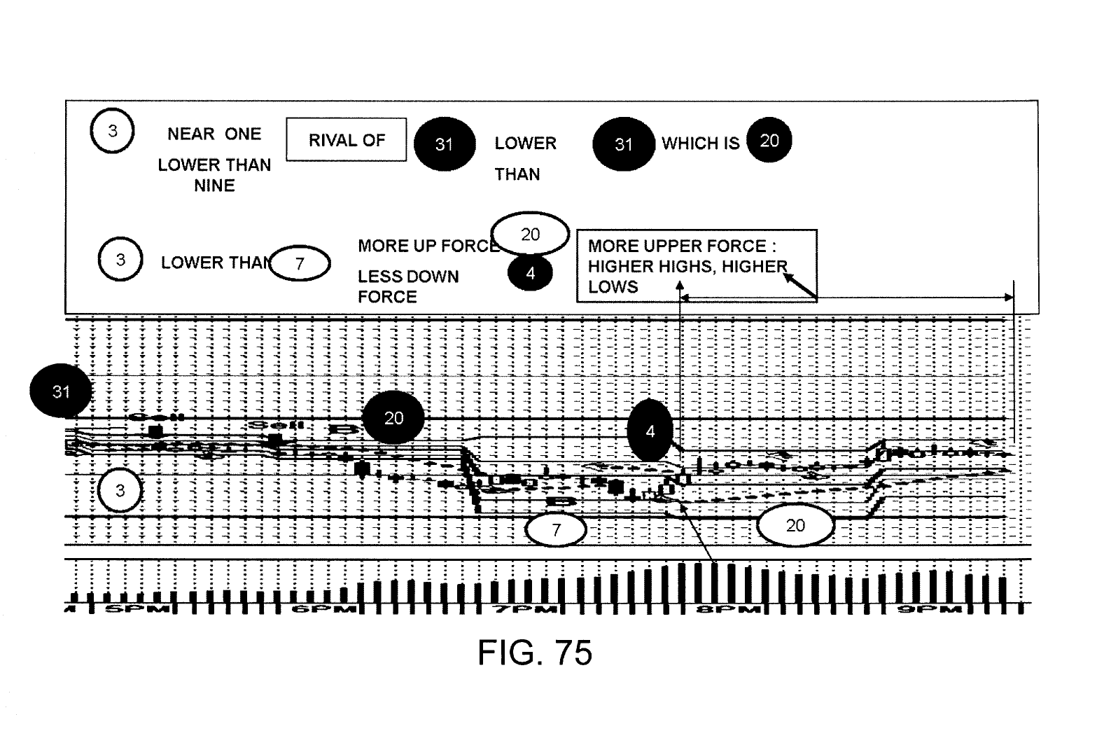

In the event that an upper SAR count or lower SAR count penetrates a pivot line, one can make better predictions and avoid losing money on trades. Essentially, applicant has determined and demonstrated that when there is a substantial reduction in SAR count downward force there is also an increase in SAR count upward count. FIG. 73, FIG. 74, and FIG. 75 show screenshots and interpretations of modified SAR Parabolics and SAR counts.

FIG. 74 shows an additional calculation preferably displayed on computer 806 for trader 105. Preferably the upper SAR Count values are summed for a particular time frame and expressed as a negative number. Preferably the lower SAR count values are summed and expressed as a positive number, as shown. The products of those summations are then summed. A positive or negative number is the result. If the net result is negative, then it is predicted that the market is controlled by sellers. If the net result is positive, then it is predicted that the market is controlled by buyers. Preferably, the changes over time may be compared to determine if there are trends in control that are remaining or shifting.

### Vertical Line Indicator

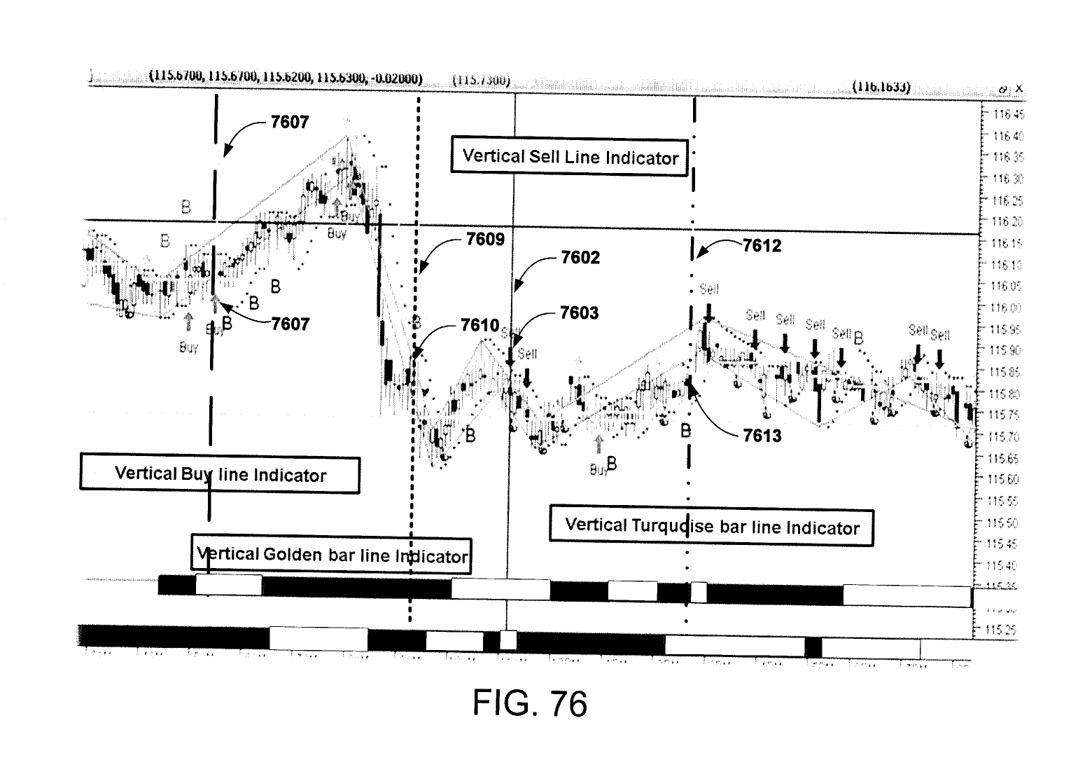

FIGS. 76, 77, and 78 show screenshots illustrating the vertical line indicator according to a preferred embodiment of the present invention. Preferably, when an indicator is computed, preferably plug-in 812 instructs computer 806—or alternately preferably financial analysis software instructs computer 806—to graphically display on display 110 a preferably vertical line from about the top of the market chart to about the bottom of the market chart upon a condition being met in the market.

FIG. 76 shows vertical sell line indicator 7602 (solid black line, but preferably colored, preferably red) displayed at sell point 7603. FIG. 76 also shows vertical buy line indicator 7606 at buy point 7607 (dashed line, but preferably colored, preferably green). FIG. 76 also shows vertical golden bar line indicator 7609 at buy point 7610 (dotted line, but preferably colored, preferably gold). FIG. 76 also shows turquoise bar line indicator 7612 at buy point 7613 (dash-dot-dot line, but preferably colored, preferably turquoise). Preferably, settings for display of vertical lines are trader settable, alternately preferably pre-configured settings are provided to traders 105.

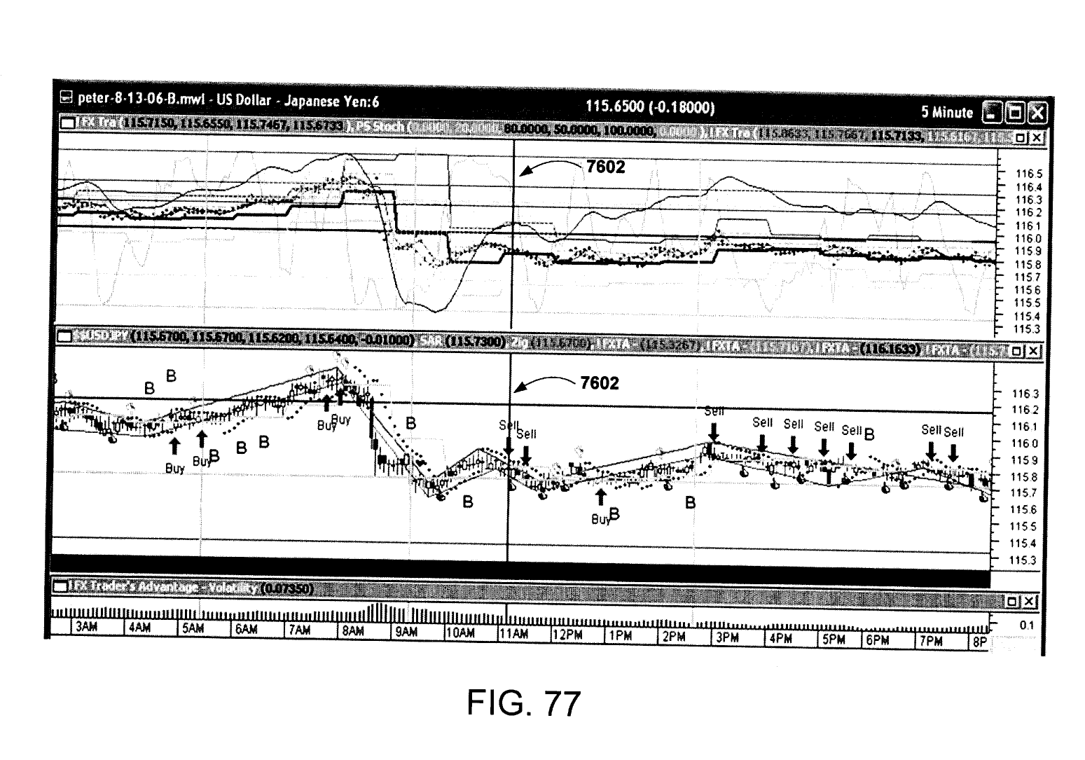

FIG. 77 shows sell line indicator 7602 on a market candlestick chart (lower panel of screen shot) and on FXTA Trader's Advantage Chart (upper panel of screen shot).

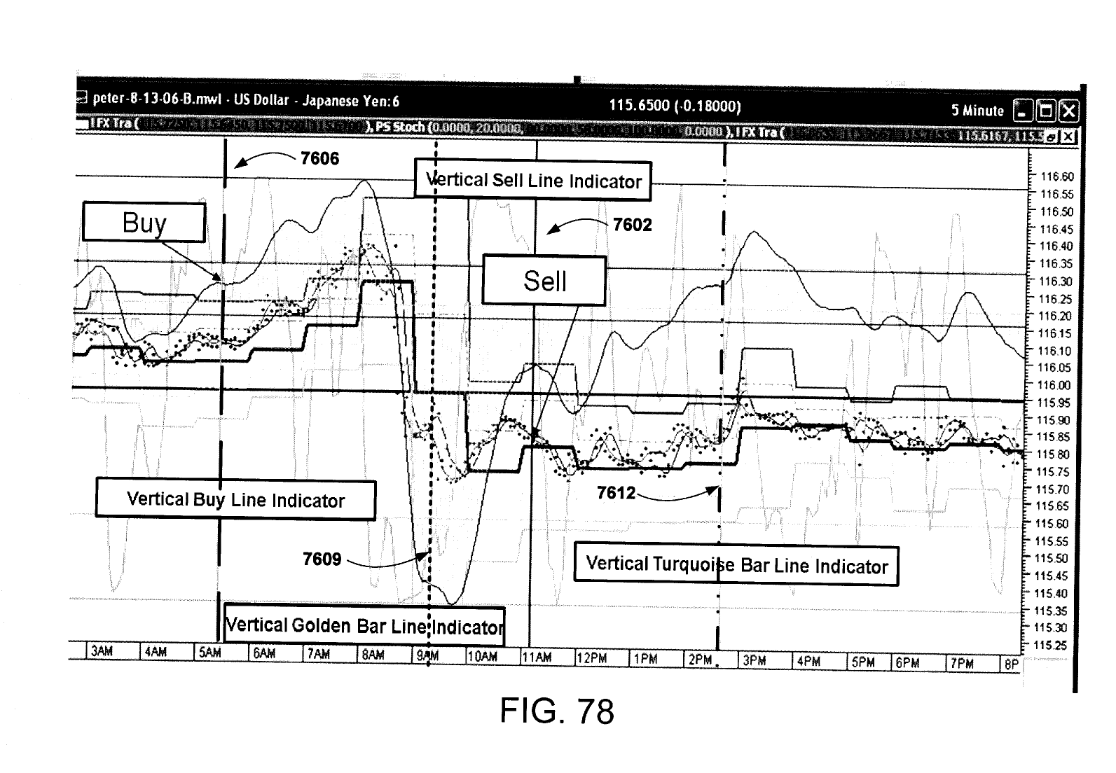

FIG. 78 shows sell line indicator 7602, buy line indicator 7606, golden bar line indicator 7609, and turquoise bar line indicator 7612 on FXTA Trader's Advantage Chart.

### Super Long Term Trade

Preferably, plug-in 812 comprises a recognition indicator to assist a trader in establishing whether or not there is a trend in the market place for a particular market vehicle, preferably for a super long term trade. An associated method is also described herein. Preferably, such indicator and associated method is also usable with long term trade, swing trade, and active trade methods. This super long term trade indicator will preferably be most useful for decisions by entities dealing in large money amounts (e.g., the amount of money that a bank would deal with). Preferably, currency (or the market vehicle) will be scanned on a monthly time frame basis (alternately preferably quarterly or yearly).

To carry out the super long term trade method, financial analysis software 809 comprising plug-in 812 preferably scans all currency, preferably using monthly data, preferably using about thirty-six months of data. Financial analysis software 809 comprising plug-in 812 for financial analysis software preferably finds the highest point and then “looks back” preferably thirty-six months to find the high of that month and preferably computationally compares it with the high of the current month. The criteria for a super long term trade are as follows:
Current Month High>Previous Month High (e.g., the prior 36^{th} Month);
Current Month High>Previous Month Low (e.g., the prior 36^{th} Month);
Current Month Three-Bar Simple Moving Average>Previous Month (e.g., the prior 36^{th} Month) Three-Bar Simple Moving Average; and
Current Month High either at least 4% higher than the previous year or at least 12% higher than Previous Month Low (e.g., the prior 36^{th} Month).

If the above preferred conditions are met, trader 105 may make a super long term trade with increased confidence. Preferably, the percentages in the fourth listed condition are trader/user definable.

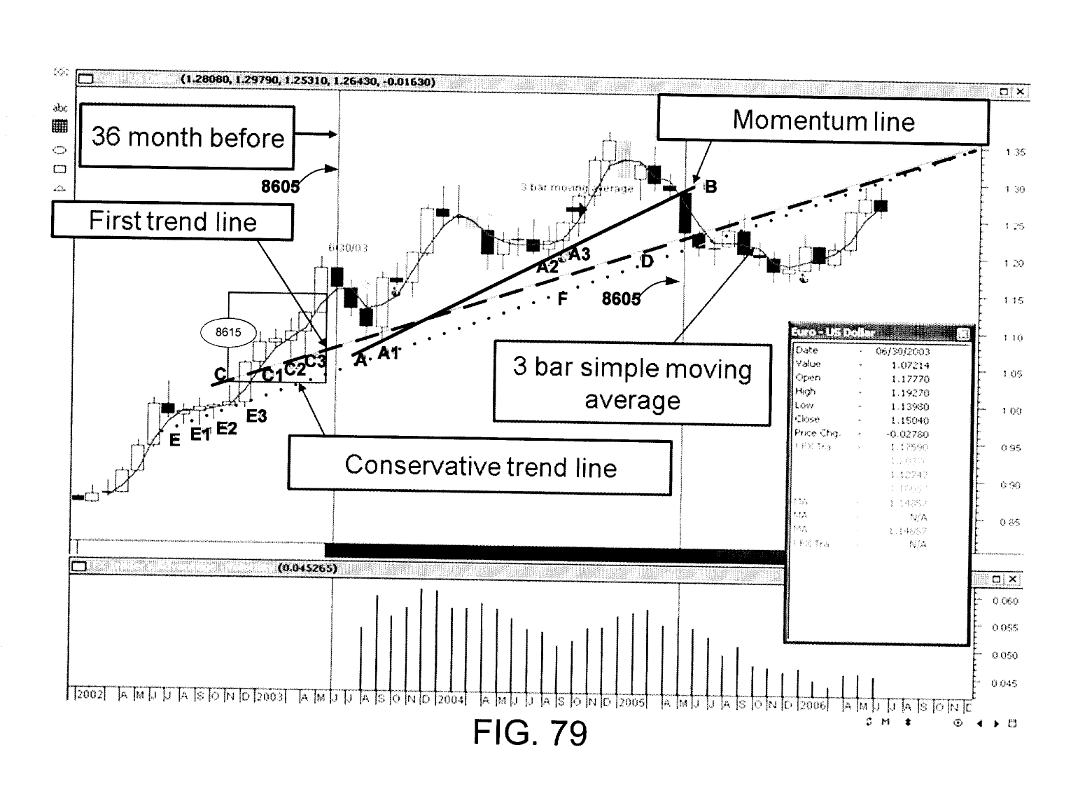

FIG. 79 shows a screen shot illustrating the super long term trade method according to a preferred embodiment of the present invention. Preferably, market chart is a monthly market chart. Preferably current month 8605 and previous month 8610 are indicated, preferably with a vertical line, as shown. At this point, the financial analysis software 809 comprising plug-in 812 establishes a trend line. As shown in FIG. 79, financial analysis software 809 comprising plug-in 812 finds conditions (either consecutive or non consecutive), where the lows are increasing (i.e., higher lows) and can be connected to the current low by trend line C-D (trend line C-D is the dashed line in FIG. 79; the lows are indicated as C1, C2, C3). The trend line is plotted using ways known in the art. Now, trader 105 may visually compare the current status to the trend. If the current status is above the trend line, the currency close price must be more than or equal to the value of trend line C-D in the month under observation. If the current status is below the trend line, the currency close price must be lower than the value of trend line C-D in the month under observation. Applicant notes that the close price of the month must be considered. However, during the month, if the trend line is violated by the close of a day, trader 105 is preferably alerted that the current day close prices have penetrated the trend line value and, preferably, stops must be put under the lower of the value of trend line or the low of the current month.

If there is no condition where the lows are increasing, then the following is preferably performed: financial analysis software 809 comprising plug-in 812 preferably finds the month which had the lowest low (for example A1) and also finds two additional months (for example A2 and A3) which may be connected through a trend line (shown as trend line A-B, also referred to as “momentum line”).

A preferred entry procedure, based on a trend line, into a market with respect to a particular market vehicle follows once the “first trend line” is established (trend line C-D in FIG. 79): the prices are preferably above this trend line; the close of the five minute time frame is preferably above this trend line; preferably, there is at least one “Buy” signal based on FXTA alignment (several prior “Buy” signals are more preferred); at the end of the day of entry, the closing price of the day preferably closes above the trend line; at the end of the day of entry, the stop is preferably below the trend line during the day of the entry; and at entry, the closing price is preferably higher than the open price and preferably has increasing FXTA Volatility (see lower panel of FIG. 79).

A preferred entry procedure, based on current status, into a market with respect to a particular market vehicle follows: at the entry, the prices are preferably above FXTA Daily Pivot or above the supports of the Pivot plot (refer to FIG. 67C); and in the FXTA commentary window, the momentum is preferably increasing (alternately preferably, if going long, the Turquoise bar indicator is preferably used; alternately preferably, if going short, the Golden bar indicator is preferably used; and alternately preferably pivots, Fibonacci indicators, clusters, reverse candle formation, FXTA mid pivot line, diamond (dot) theory may be used).

A preferred entry procedure, based on the momentum line (trend line A-B, a solid line), into a market with respect to a particular market vehicle follows: the prices are preferably above this momentum line; the close of the five minute time frame is preferably above this momentum line; preferably, there is at least one “Buy” signal based on FXTA alignment (several prior “Buy” signals are more preferred); at the end of the day of entry, the close of the day preferably closes above the momentum line; at the end of the day of entry, the stop is preferably below the momentum line during the day of the entry; and at entry, the close price is preferably higher than the open and preferably has increasing FXTA Volatility (see lower panel of FIG. 79). This momentum line entry method preferably gives earlier warning and more exit signals than “First Trend Line” method and it is, in applicant's opinion, the more efficient method.

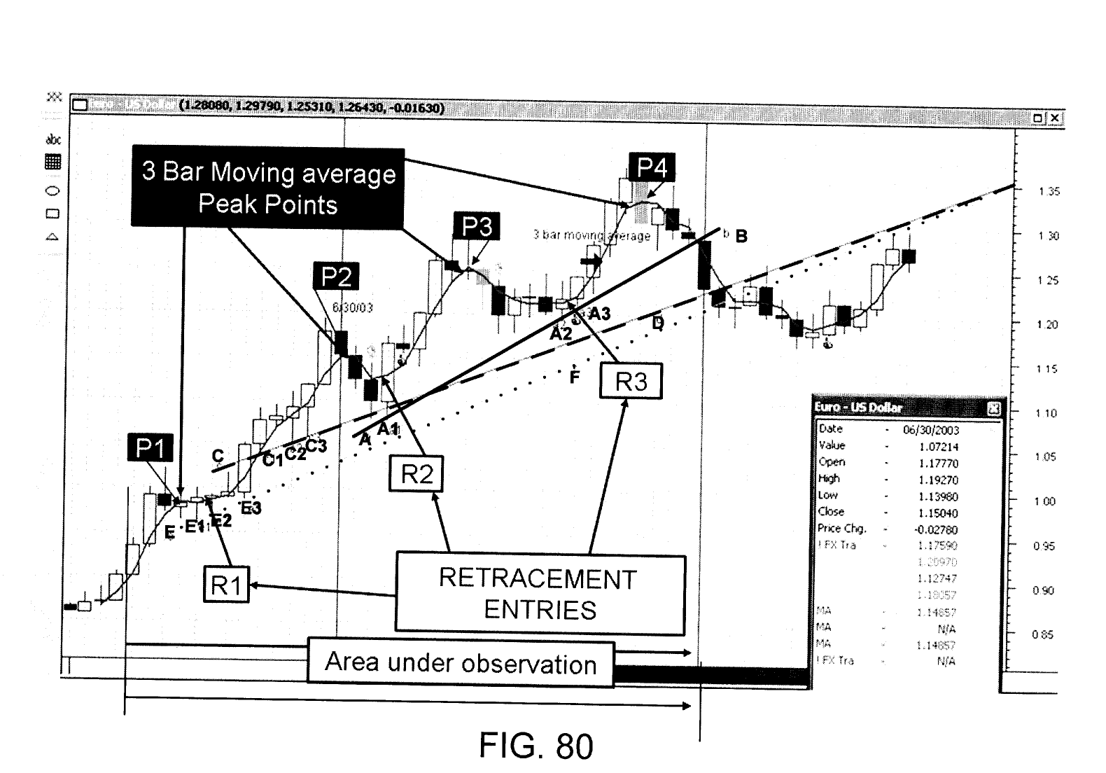

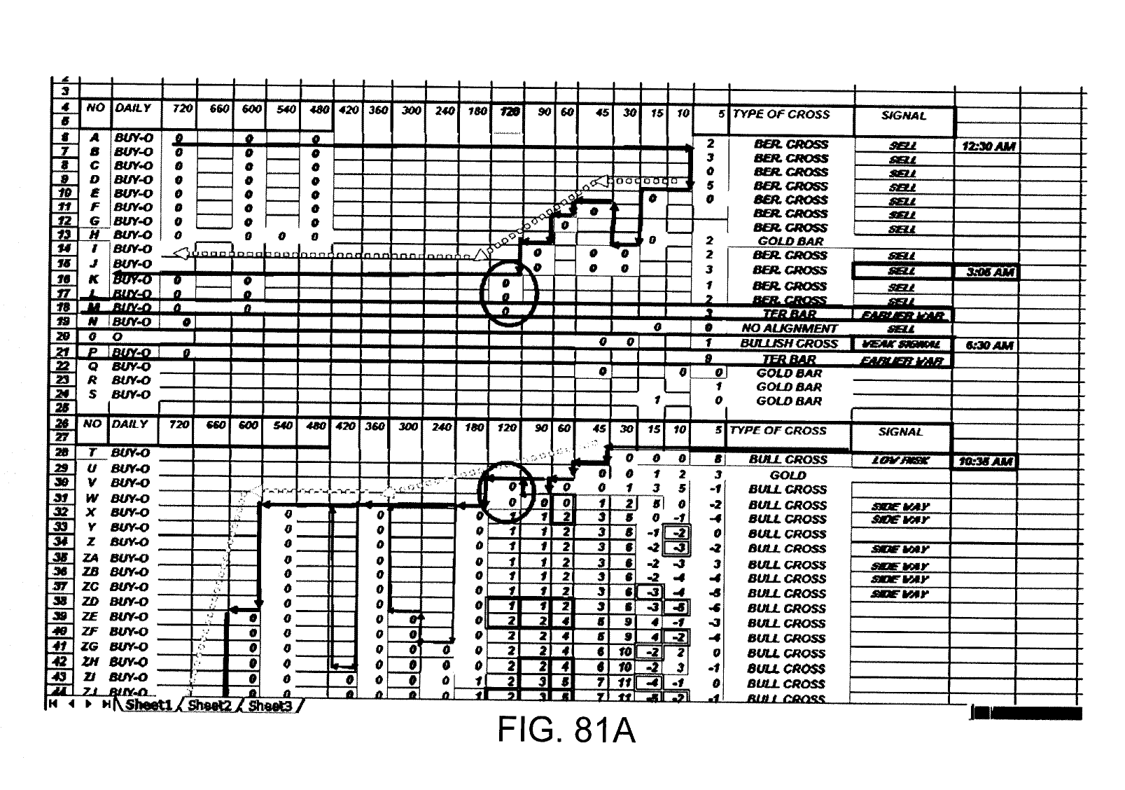

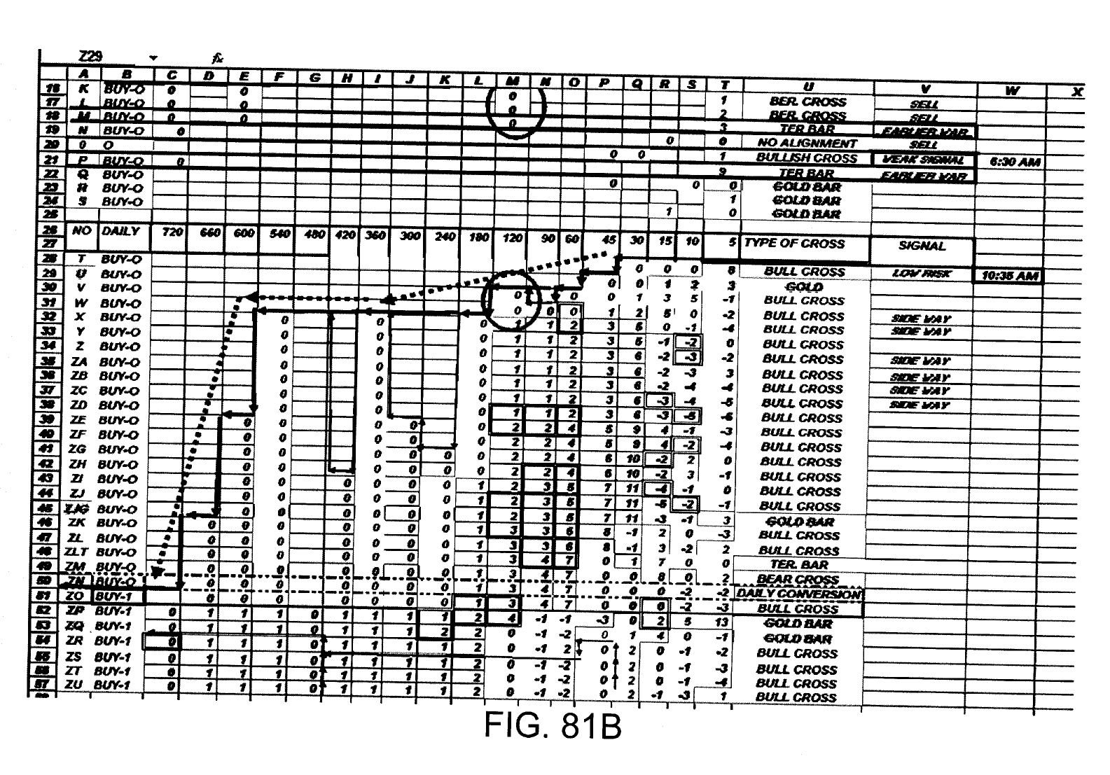

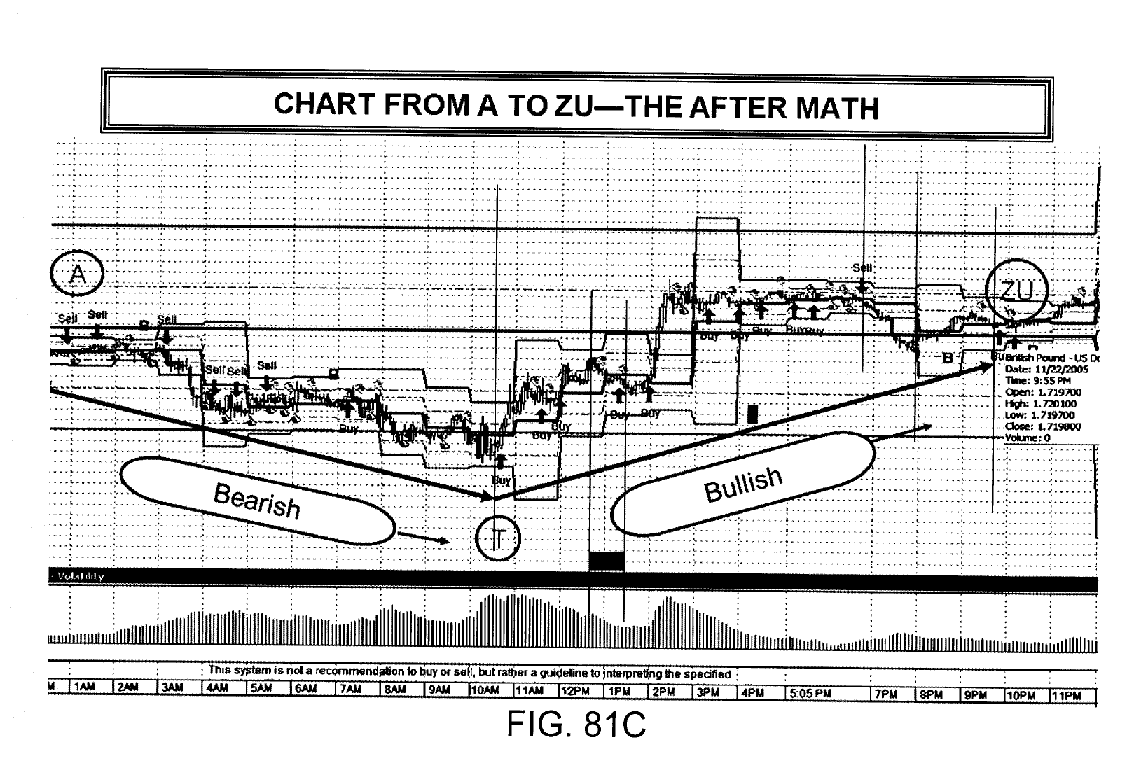

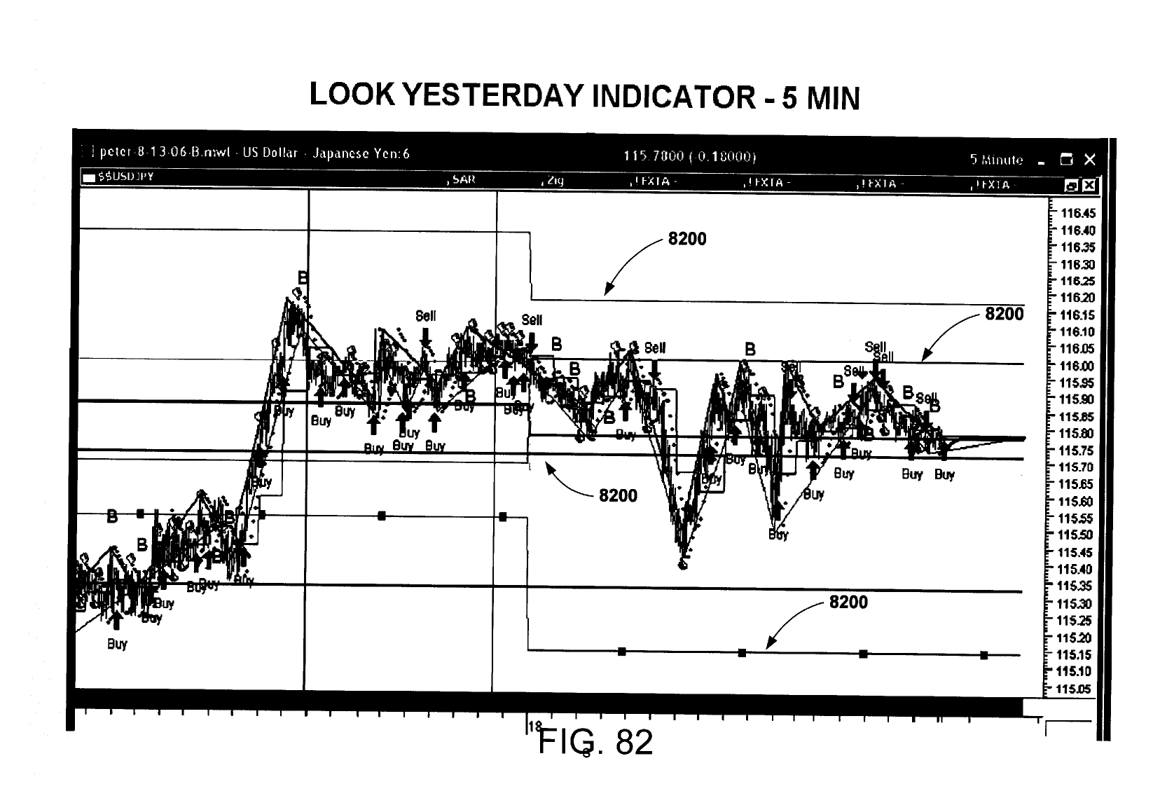

FIG. 80 shows a screenshot illustrating Peak Points and Retracement Entries according to a preferred embodiment of the present invention. The method described with respect to FIG. 81 may also be usable for super long term traders. In this method, preferably, a reference point of three years is preferably established. Financial analysis software 809 comprising plug-in 812 then looks for the nearest three lows ([higher lows, C1, C2, and C3). Subsequently, financial analysis software 809 comprising plug-in 812 for financial analysis software looks for additional higher lows earlier than C1, C2 & C3]. As shown in FIG. 82, financial analysis software 809 comprising plug-in 812 for financial analysis software found higher lows E1, E2, and E3. Next, financial analysis software 809 comprising plug-in 812 for financial analysis software established a trend line (shown as trend line E-F in FIG. 82). The peak points, P1, P2, P3, P4, are preferably exit points.

From the three bar moving average, financial analysis software 809 comprising plug-in 812 for financial analysis software preferably finds the peaks in the area of observation. Preferably, a table comprising the following preferred columns are established and displayed for the benefit of trader 105 as follows:
Column 1 Value of current peak point, P4;
Column 2 Peak point value P3;
Column 3 Peak point value P2;
Column 4 Indicates whether P4>P3>P2 in a YES or NO format;
Column 5 Indicates how far is peak point from trend line A-B (in the month where the peak point is established); Preferably only P4 should be considered;
Column 6 Indicates how far peak point P4 is from trend line C-D;
Column 7 Indicates how far peak point P4 is from conservative trend line E-F; and
Column 8 Indicates current Bias (Blue or Red).

With respect to retracement entries, from the three bar moving average, financial analysis software 809 comprising plug-in 812 finds the low retracement in the area of observation. The following columns are preferably established for viewing by the trader:
Column 1 Value of current retracement point, R3;
Column 2 Retracement point value R1;
Column 3 Retracement point value R2;
Column 4 Indicates whether R3>R2>R1 in a YES or NO format;
Column 5 Indicates how far the RETRACEMENT point is from Momentum Line A-B (in the month where Retracement Point is established; preferably only R3 should be considered);
Column 6 Indicates how far Retracement Point R3 is from Trend line C-D;
Column 7 Indicates how far Retracement point R3 is from Conservative Trend Line E-F;
Column 8 Indicates how far Retracement point R3 is from Momentum Line A-B; and
Column 9 Indicates current Bias (Blue or Red).

An exit signal is preferably established under the following conditions: if the three bar moving average penetrates trend line C-D (or trend line E-F) at any given time. An exit signal is also preferably established at a momentum line break. To determine such an exit signal, financial analysis software 809 comprising plug-in 812 preferably finds three months (either consecutive or non consecutive) where the lows (for example A1, A2, & A3) are increasing (i.e., higher lows) and can be connected by trend line A-B, as shown. The value of the trend line is preferably calculated. The value of trend line A-B (momentum line) is shown in FIG. 79 as increasing and will vary from month to month. An exit signal is established when the three bar moving average penetrates trend line A-B at any time, and/or when the close of the current month closes below trend line A-B, or when the open of the month opens below trend line A-B.

With respect to FIG. 79, a more conservative method to establish a trend for a super long term trade, a reference point of three years is preferably established. Plug-in 812 preferably looks for the three nearest increasing lows (e.g., C1, C2, C3 in FIG. 79). Subsequently, plug-in 812 directs the computer 806 to look for additional higher lows that occurred prior to the lows at points C1, C2, C3 (e.g., E1, E2, and E3). Trend line E-F is preferably plotted. It is noted that the draw downs may be higher. The exits and entry procedures and processes above are preferably used with this conservative method.

### Alert Record

Preferably financial analysis software 809 comprising plug-in 812 comprises an alert system. Preferably, financial analysis software 809 comprising plug-in 812 creates a log file for all alerts. The created log file is preferably available as an option in the “File” section of a market chart and gives a user a choice of selecting currency from all common currency. The log file for alerts preferably comprises all alerts that have arisen within the latest twenty-four hour period. Preferably, the log file is in comma delimited format. Further, preferably a user may view the alerts that occurred in at least the last six months and preferably for the prior year. Preferably, a user may define the dates for which the user wishes to see alerts. The details for the log preferably include the Type of Alert, the Time of Alert, the Alert message, the Name of currency, the Type of alignment: Bullish or Bearish, the Detail of Alignment (such as 660/480/120/5 colored red or green). Note that even if an alignment expires, the log preferably should not change.

Preferably the following alerts are added to and defined by financial analysis software 809 comprising plug-in 812 for financial analysis software.

### Look Yesterday Indicator

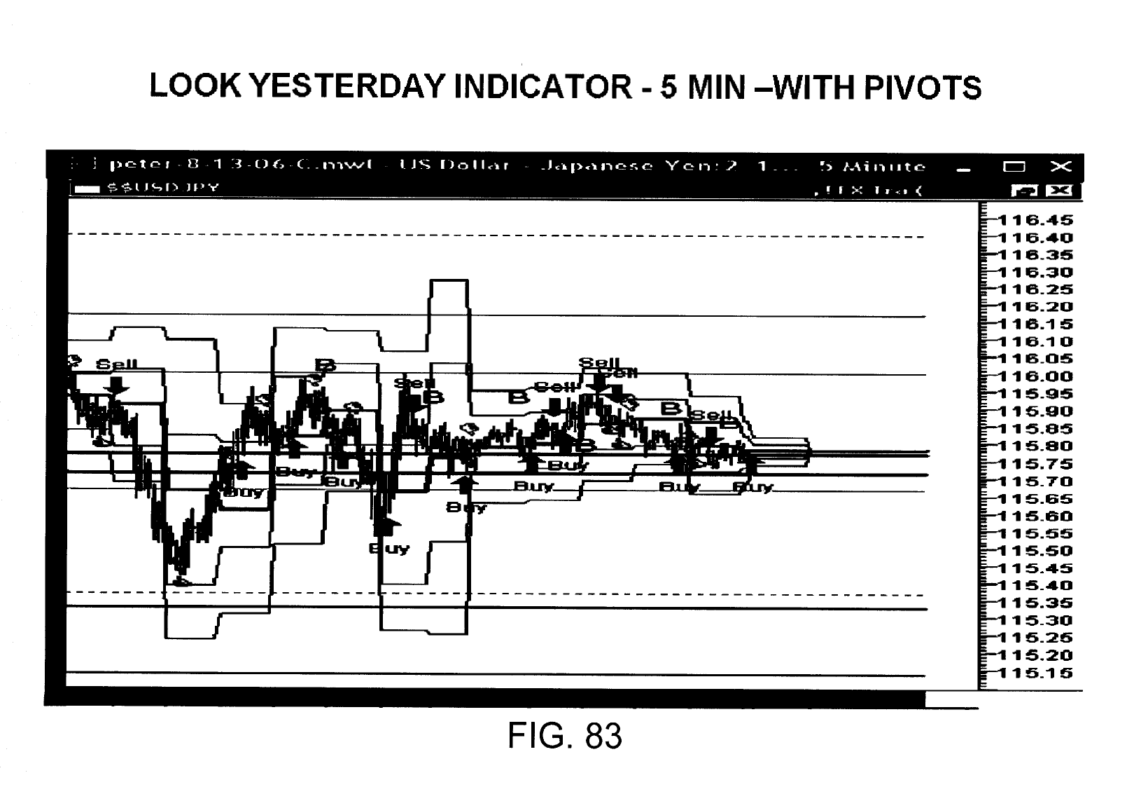

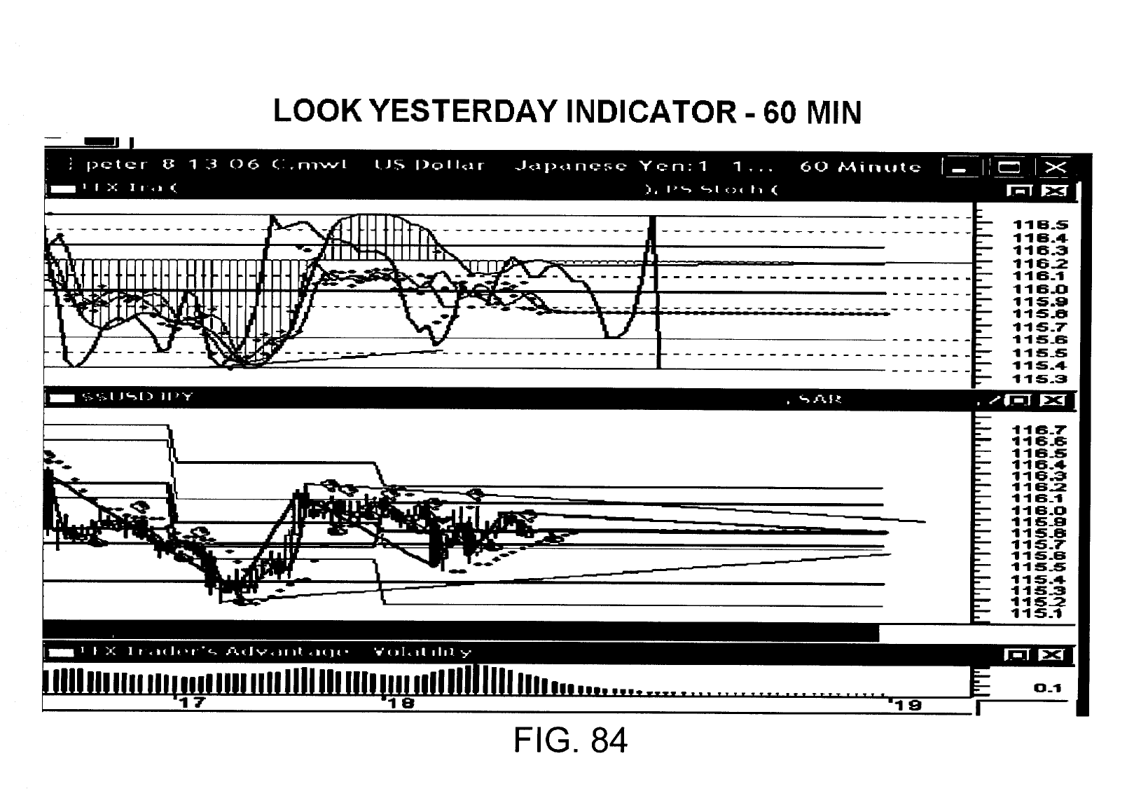

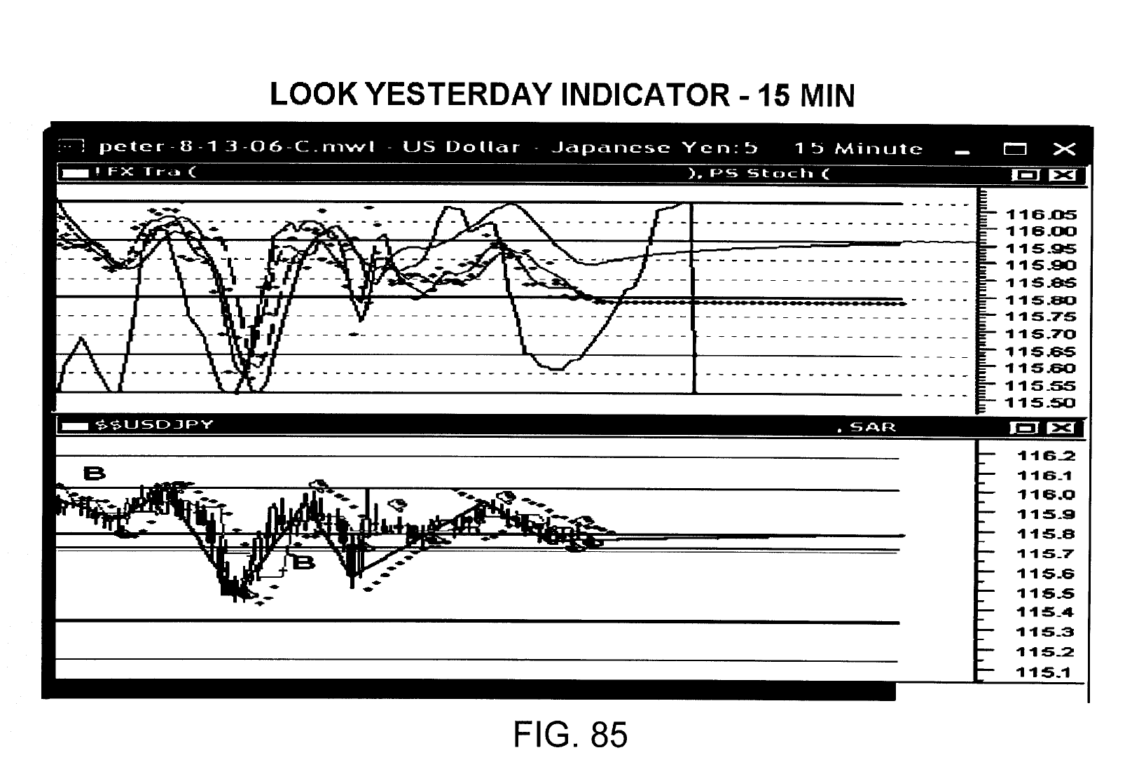

FIGS. 82, 83, 84, and 85 show screenshots, illustrating the look yesterday indicator, according to a preferred embodiment of the present invention. FIG. 82 shows a five minute chart with a look yesterday indicator 8200. A 60 minute chart with a look yesterday indicator is shown in FIG. 84. A 15 minute chart with a look yesterday indicator is shown in FIG. 85. The look yesterday indicator may preferably be combined with pivots as shown in FIG. 83. The open, high, low and close prices of any market vehicle is important standing on its own as well as when it is compared to historical occurrences. Financial analysis software 809 comprising plug-in 812 preferably comprises an indicator which will calculate and automatically draw indicator lines for display to the user, the lines indicating the prior day's open, high, low, and close prices. These lines are preferably automatically plotted on intra-day market charts (preferably on five minute charts to daily charts). Under appropriate circumstances, this indicator may be used on any desired time frame such as on a one-minute chart or even on tick charts. The following formula is preferably used for this indicator:

A=Last Value(Highest(Sum(DayOfWeek( )< >ValueWhen(2,1,DayOfWeek( )),5)=5 (4.1)

X=DayOfMonth( )< >ValueWhen(2−A,1,DayOfMonth( ))OR A (4.2)

Do=ValueWhen(2−A,X,O) (4.3)

Dh=ValueWhen(1,X,ValueWhen(2A,1,HighestSince(1,X,H))) (4.4)

Dh=ValueWhen(1,Dh>0,Dh) (4.5)

Dl:=ValueWhen(1,X,ValueWhen(2−A,1,LowestSince(1,X,L))) (4.6)

Dl:=ValueWhen(1,Dl>0,Dl) (4.7)

Dc:=ValueWhen(1,X,ValueWhen(2−A,1,C)) (4.8)

Do; {Daily OPEN} (4.9)

Dh; {Daily HIGH} (4.10)

Dl; {Daily LOW} (4.11)

Dc; {Daily CLOSE} (4.12)

The above formula may preferably be changed for calendar days, contract expiration days for commodities, and/or for Sunday open to Friday close at 4:46 PM EST.

The outcome of the above formula is preferably plotted on a five-minute chart. A preferred colors scheme for this indicator comprises the High of yesterday in Light Blue, the Close of Yesterday in Plum, the Open of yesterday in Gold, and the Low of yesterday in Sea green. The weight and style of each of the above preferably has a value of one.

In addition to the above indicator, the following alerts are preferably established:

Alert 1. Alert when the currency or market vehicle prices penetrates Yesterday's close;

Alert 2. Alert, when price penetrates yesterday's high and it comes within 10 pips (Bullish);

Alert 3. Alert, when today's prices penetrates Yesterday's low prices and it comes within 10 pips (Bearish);

Alert 4. Alert when, today's prices falls below yesterday's open;

Alert 5. Alert when, sell arrow is generated below yesterday close within 20 pips on both side of yesterday close price;

Alert 6. Alert when buy arrow generates within 20 pips of yesterday's open price;

Alert 7. Alert when, Buy arrow comes within 20 pips of yesterday's close price;

Alert 8. Alert when, Buy arrow comes within 20 pips of yesterday's low price;

Alert 9. Alert when, Buy arrow comes within 20 pips of yesterday open price; and

Alert 10. Alert when sell arrow comes within 20 pips of yesterday's high price;

Further, the following explorers are preferably established within financial analysis software 809 comprising plug-in 812 for financial analysis software:

Explorer-1. Find all currencies when close prices on five minute are penetrating yesterday's close prices;

Explorer-2. Find all currencies when close prices of currencies penetrates yesterday's high and comes within 10 pips range;

Explorer-3. Find all currencies, when current close prices on Five minute penetrates yesterday's low prices within 10 pips;

Explorer-4. Find currencies, when current prices in five minutes chart falls below yesterday's open prices;

Explorer-5. Find currencies, when sell arrow on five minutes is below yesterday's close within 20 pips on both sides of yesterday's close price;

Explorer-6. Find currencies, when buy arrow is generated on five minutes within 20 pips of yesterday's open price;

Explorer-7. Find currencies, when Buy arrow comes within 20 pips of yesterday's close price;

Explorer-8. Find currencies when buy arrow comes within 20 pips of yesterday's low price;

Explorer-9 Find currencies when buy arrow comes within 20 pips of yesterday's open price; and

Explorer-10 Find currencies, when sell arrow comes within 20 pips of yesterday's high price.

### Trading Setups

Financial analysis software 809 comprising plug-in 812 for financial analysis preferably comprises at least one trading set up, a file having instructions to configure display 110 of computer 806, with at least one indicator to assist the user in trading. These setups are provided to the trader so that the trader may start trading instead of becoming frustrating with the setup of a particular trading method. Preferably, a plurality of chart types are provided and usable by a trader.

### Alignment Table

FIGS. 81A, 81B, and 81C show screenshots illustrating an alignment table according to a preferred embodiment of the present invention. Preferably, plug-in 812 and financial analysis software 809 displays commentary window information in a table form as shown in FIG. 81A and FIG. 81B. This screen shot is essentially the commentary window described above in table format. This table is preferably in an exportable format (such as a comma delimited format). The zeroes in the cells of the screen shot indicate confirmation of a confirmed move. Using the alignment table of FIGS. 81A and 81B, a trader may visually see how a market vehicle is progressing over a period of time in real time since the data in the tables of FIGS. 81A and 81B will be updated as time progresses. FIG. 81C shows the data from FIGS. 81A and 81B in a market chart format and illustrates the trend change.

Although applicant has described applicant's preferred embodiments of this invention, it will be understood that the broadest scope of this invention includes modifications. Such scope is limited only by the below claims as read in connection with the above specification. Further, many other advantages of applicant's invention will be apparent to those skilled in the art from the above descriptions and the below claims.

What is claimed is:

1) A computing system communicatively coupled with at least one market data feed, said computing system comprising:
a) at least one processor to process such at least one market data feed;
b) at least one set of instructions, responsive to user input, to instruct said at least one processor to output at least one market indicator;
c) at least one storage memory to store said at least one set of instructions;
d) at least one display to display such output;
e) wherein, when said at least one set of instructions instructs said at least one processor, at least one market chart and at least one commentary window are displayed on said at least one display.

2) The computing system according to claim 1 wherein said at least one commentary window comprises at least one concise market trend indication system.

3) The computing system according to claim 2 wherein said at least one commentary window comprises at least one buy or sell indicator.

4) The computing system according to claim 3 wherein said at least one commentary window comprises at least one bullish or bearish bias indicator.

5) The computing system according to claim 4 wherein said at least one commentary window comprises at least one short term market trend indicator.

6) The computing system according to claim 5 wherein said at least one commentary window comprises at least one table of market data comprising time frame, status, number of bars, and close at cross.

7) The computing system according to claim 1 wherein said at least one commentary window comprises at least one concise summary of at least one predicted market trend.

8) The computing system according to claim 7 wherein said at least one concise summary of at least one predicted market trend comprises at least two time frames and notice as to whether or not an alignment is forming.

9) The computing system according to claim 8 wherein said at least one concise summary further comprises at least one confirming or non-confirming indication of a bearish or bullish cross.

10) A computing system communicatively coupled with at least one market data feed, said computing system comprising:
a) at least one processor to process such at least one market data feed;
b) at least one set of instructions, responsive to user input, to instruct said at least one processor to output at least one market indicator;
c) at least one storage memory to store said at least one set of instructions;
d) at least one display to display such output;
e) wherein, when said at least one set of instructions instructs said at least one processor, at least one market indicator displayed on said at least one display.

11) The computing system according to claim 10 wherein said at least one market indicator is at least one pivot line.

12) The computing system according to claim 11 wherein said at least one pivot line is at least one plot of pivot points; wherein said pivot points are calculated using an average of at least one pivot point within at least one timeframe.

13) The computing system according to claim 12 wherein said at least one timeframe is evenly divisible by at least one time interval.

14) The computing system according to claim 13 wherein said at least one time interval is about five minutes.

15) The computing system according to claim 14 wherein, when said at least one set of instructions instructs said at least one processor, at least one resistance point and at least one support point are calculated using at least one pivot point.

16) The computing system according to claim 13 wherein said at least one display comprises display of pivot lines of multiple time intervals.

17) The computing system according to claim 16 wherein said at least one display comprises display of at least one alert when pivot lines interact.

18) The computing system according to claim 10 wherein said at least one set of instructions computes and displays at least one “look yesterday” indicator comprising a plot of the prior day's open, high, low, and close prices.

19) The computing system according to claim 10 wherein said at least one market indicator comprises at least one plot of modified parabolic stop-and-reversal; wherein at least one point for said at least one plot of modified parabolic stop-and-reversal is calculated wherein the “step” of such stop-and-reversal is selected based on the market vehicle being traded.

20) The computing system according to claim 10 wherein said at least one market indicator comprises at least one vertical line extending from an about top portion of at least one market chart to a bottom portion of such a chart; and wherein said at least one vertical line is drawn at a buy indicator or sell indicator.

21) The computing system according to claim 10 further comprising at least one further set of instruction providing instructions to configure said at least display and said at least one indicator.

22) A computing system communicatively coupled with at least one market data feed, said computing system comprising:
a) at least one processor to process such at least one market data feed;
b) at least one set of instructions, responsive to user input, to instruct said at least one processor to output at least one market indicator;
c) at least one storage memory to store said at least one set of instructions;
d) at least one display to display such output;
e) wherein, when said at least one set of instructions instructs said at least one processor, at least exportable file, comprising cells, is available to be exported so that a user may visualize market conditions.

23) The computing system according to claim 22, wherein said at least one exportable file comprises at least one data-filled table of market conditions displaying alignment data.

24) A computing system communicatively coupled with at least one market data feed, said computing system comprising:
a) at least one processor to process such at least one market data feed;
b) at least one set of instructions, responsive to user input, to instruct said at least one processor to output at least one market indicator;
c) at least one storage memory to store said at least one set of instructions;
d) at least one display to display such output;
e) wherein, when said at least one set of instructions instructs said at least one processor, the following occur
i) at least one upper parabolic SAR is calculated and counted for at least one time frame;
ii) at least one lower parabolic SAR is calculated and counted for at least one time frame;
iii) at least one upper parabolic SAR is compared with at least one lower parabolic SAR;
f) wherein, the relationship among the at least one upper parabolic SAR and the at least one lower parabolic SAR is displayed to assist market trend prediction.
